(19) United States
(12) Patent Application Publication
(10) Pub. No.: US 2012/0054379 A1
(43) Pub. Date: Mar. 1, 2012

(54) LOW POWER MULTI-TOUCH SCAN CONTROL SYSTEM

(76) Inventors: Kafai Leung, Austin, TX (US); Brent Wilson, Austin, TX (US); Yonghong Tao, Singapore (SG); Shan Wang, Singapore (SG); Shantonu Bhadury, Singapore (SG); Suby Pellissery, Singapore (SG); Raghavendra Pai Kateel, Singapore (SG); David Welland, Austin, TX (US); David Andreas, Austin, TX (US); Gabriel Vogel, Austin, TX (US)

(21) Appl. No.: 12/870,849

(22) Filed: Aug. 30, 2010

(51) Int. Cl. G06F 13/28

(52) U.S. Cl. 710/23

(57) ABSTRACT

An integrated control circuit is disclosed including a central processing unit operating in a normal full system power mode and in a reduced system low power mode, and a memory. A plurality of peripheral units are provided, at least one of which includes an input/output for interfacing with at least an external system for receiving information therefrom and a process block. The process block processes the received information from the external system and during the processing of the received information, data is stored in the at least one peripheral unit, and data is transferred at least to or at least from the memory. The input/output and process blocks are fully operable in the full system power mode and the reduced system power mode. A direct memory access (DMA) transfers data directly between the at least one peripheral and the memory when such data transfer is required by the peripheral. The DMA operates in a full power DMA mode when data transfer is required and a low power DMA mode when data transfer is not required. The central processing unit is operable, in the normal full system power mode, to interface with the memory and with the at least one peripheral unit to access data stored by the at least one peripheral unit.

### CROSS-REFERENCE TO RELATED APPLICATIONS

This application is related to co-pending U.S. patent application Ser. No. ______, filed ______, entitled ______ (Atty. Dkt. No. 29,770) and U.S. patent application Ser. No. 12/775,447, filed May 6, 2010 entitled METHOD AND APPARATUS FOR SCANNING A TOUCHSCREEN WITH MULTI-TOUCH DETECTING USING MASTER/SLAVE DEVICES (Atty. Dkt. No. 29,953), which is incorporated herein in its entirety.

### TECHNICAL FIELD

The present invention pertains in general to touch screens and, more particularly, to a touch screen with Multi-Touch Resolve (MTR) capabilities.

### BACKGROUND

Capacitive touch screens have been utilized recently to allow a user to provide a user interface with touch capability on such things as Personal Digital Assistants (PDAs), tablet PCs, etc. These touch screens function by detecting a change in capacitance at a particular location as opposed to a physical interaction with the screen, such as is the case with a stylus based system. With capacitance based touch screens, a finger is typically placed onto the screen which will change the capacitance of a region thereon. This region could be a touch pad or it could be a touch screen array which is comprised of an array of column lines and intersecting row lines. By detecting the capacitance of a row line, for example, a difference in capacitance on a particular row line can be detected, as is also the case with respect to the column line. If just the capacitance of a row line or the capacitance of a column line is utilized as the discriminating factor, an ambiguity may exist when merely detecting the static capacitance on these lines in the presence of multiple touches on the screen. The reason for this is that static capacitance measuring devices merely determine that a particular row line was touched and a particular column line was touched. For two touches, all that is known is that two row lines have been touched and two column lines have been touched, but the exact intersection can not be determined. To rectify this, Multi-Touch Resolve (MTR) techniques have been employed to detect a change in capacitance of the row-to-column capacitance (C_{RCF}). These techniques typically utilize some type of signal that is injected into a row line and coupled across C_{RCF} to a column line. A detector on the column line can detect this signal level. By comparing the signal level in the presence of a touch to the signal level in the absence of a touch, a determination can be made as to the presence of the touch due to a change in the signal level.

### SUMMARY

The present invention disclosed and claimed herein, in one aspect thereof, comprises an integrated control circuit including a central processing unit operating in a normal full system power mode and in a reduced system low power mode, and a memory. A plurality of peripheral units are provided, at least one of which includes an input/output for interfacing with at least an external system for receiving information therefrom and a process block. The process block processes the received information from the external system and during the processing of the received information, data is stored in the at least one peripheral unit, and data is transferred at least to or at least from the memory. The input/output and process blocks are fully operable in the full system power mode and the reduced system power mode. A direct memory access (DMA) transfers data directly between the at least one peripheral and the memory when such data transfer is required by the peripheral. The DMA operates in a full power DMA mode when data transfer is required and a low power DMA mode when data transfer is not required. The central processing unit is operable, in the normal full system power mode, to interface with the memory and with the at least one peripheral unit to access data stored by the at least one peripheral unit.

### BRIEF DESCRIPTION OF THE DRAWINGS

For a more complete understanding, reference is now made to the following description taken in conjunction with the accompanying Drawings in which:

FIG. 1 illustrates a diagrammatic view of a scan control IC interfaced with a display;

FIG. 2 illustrates a more detailed diagram of the scan control IC illustrating the two scan interfaces associated therewith;

FIGS. 3a and 3b illustrate a more detailed diagram of the overall scan control IC;

FIG. 4 illustrates a schematic of the I/O pad;

FIG. 5 illustrates a diagrammatic view of a touch panel illustrating the row-to-column capacitance at the interface with the ADCs;

FIG. 6 illustrates a more detailed diagram of the row and column intersections for a touch screen and the capacitance associated therewith;

FIG. 7 illustrates a circuit diagram for the voltage sampling step of the conversion operation;

FIG. 8 illustrates a basic diagram for the ADCs associated with the MTR function;

FIG. 9 illustrates a timing diagram for the MTR operation and the three phases thereof;

FIG. 10 illustrates the auto zero configuration for the ADC and the MTR;

FIG. 11 illustrates the transfer mode for the ADC and the MTR;

FIG. 11a illustrates an alternate view of the embodiment of FIG. 10;

FIG. 12 illustrates the conversion phase for the ADC of the MTR block;

FIG. 13 illustrates a detail of the SAR conversion operation;

FIG. 14 illustrates a diagrammatic view of the top level power domain architecture;

FIG. 15 illustrates a diagrammatic view of the decision process for determining touch and no touch;

FIG. 16 illustrates a simplified diagram of the hardware controller interfacing with the memory;

FIG. 17 illustrates a more detailed diagram of the hardware controller;

FIG. 18a illustrates a block diagram of the interface between the MTR module 114 and the DMA 354;

FIG. 18b illustrates a diagrammatic view of the relationship between the DMA state machine and the associated peripherals or clients;

FIG. 18c illustrates a block diagram on the operation of the DMA and CPU in the various domains in the arbitration thereof with respect to the memory and SFR data storage areas;

FIG. 18d illustrates a diagrammatic view of the DMA channel operation;

FIG. 18e illustrates a diagrammatic view of the channel specific SFRs;

FIG. 18f illustrates a diagrammatic view of a common control/status SFRs;

FIG. 19 illustrates the clock generator;

FIG. 20 illustrates the control flow between the two clock mains of the MTR and the SYSCLK;

FIG. 21 illustrates the synchronization circuitry between two clocks;

FIGS. 22a and 22b illustrate the data transfer operation between the MTR and the DMA;

FIG. 22c illustrates the interface protocol for the DMA two peripherals;

FIG. 22d illustrates the interface protocol for the transfer of data from the SFR to XRAM;

FIG. 22e illustrates the interface protocol for transfer of data from the XRAM to the SFR;

FIG. 22f illustrates the interface protocol for the XRAM interface;

FIG. 22g illustrates the operation of the SFR interface;

FIGS. 23-26 illustrate flow diagrams for the various data transfer modes between the MTR and the DMA/CPU;

FIGS. 27a-27m illustrate the MTR SFRs;

FIGS. 28 and 29 illustrate diagrammatic views of two different scanning operations, the single strobe operation and the panel scanning operation;

FIG. 30 illustrates a flow chart for the DMA setup for the panel scan mode;

FIGS. 31a-31b illustrate a flow chart for the MTR setup or the panel scan mode;

FIGS. 32a and 32b illustrate power budgets as a function of the scanning operation;

FIG. 33 illustrates a memory map;

FIGS. 34-36 illustrate three different embodiments of the touch panel that requires multiple devices to operate a master/slave mode;

FIGS. 37a and 37b illustrate two different methods for shifting the master functionality between devices;

FIG. 38 illustrates one embodiment of the global scan operation; and

FIG. 39 illustrates a second embodiment of the global scan operation during the master/slave triggering.

### DETAILED DESCRIPTION

Referring now to the drawings, wherein like reference numbers are used herein to designate like elements throughout, the various views and embodiments of a touch screen scanning architecture are illustrated and described, and other possible embodiments are described. The figures are not necessarily drawn to scale, and in some instances the drawings have been exaggerated and/or simplified in places for illustrative purposes. One of ordinary skill in the art will appreciate the many possible applications and variations based on the following examples of possible embodiments.

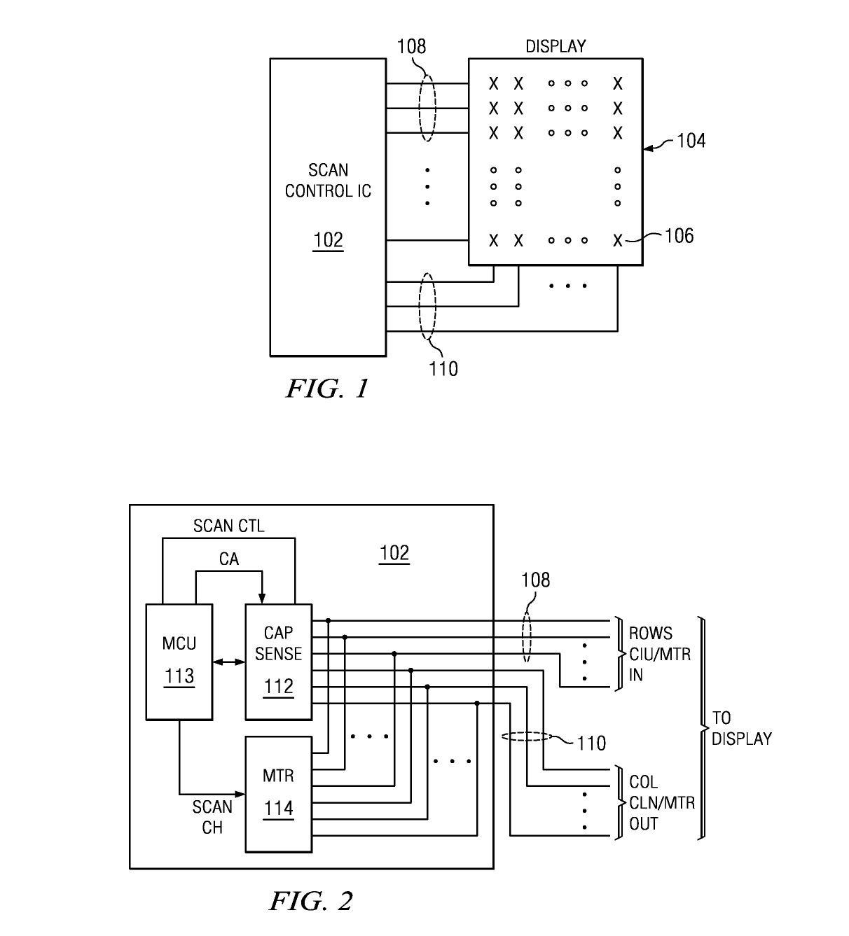

Referring now to FIG. 1, there is illustrated a diagrammatic view of a scan control IC 102 that is interfaced with a touch screen 104 that can be used by itself or in conjunction with a display as an overlay. The touch screen 104 is a touch screen having a plurality of distributed capacitors 106 disposed at intersections of columns and rows. There are a plurality of rows 108 and a plurality of columns 110 interfaced with the scan control IC. Thus, a row line will be disposed across each row which intersects with a column line on the touch screen surface and these are interfaced with the scan control IC 102. It should be understood that a capacitive touch pad or detection area refers to an area on the touch screen, but will be used to refer to an intersection between a row line and a column line. The term “touch pad” and “intersection” shall be used interchangeably throughout.

Referring now to FIG. 2, there is illustrated a more detailed diagrammatic view of the scan control IC 102. In determining a change in capacitance for a particular row or column line, there can be multiple techniques utilized. The first technique is to merely sense the value of the self capacitance for all or a select one or ones of the row or column lines and then utilize some type of algorithm to determine if the capacitance value has changed and then where that change occurred, i.e., at what intersection of row and column lines. The scan control IC 102 provides this functionality with a capacitive sense block 112. This block 112 functions to determine if a change has occurred in the self capacitance value of the particular row or column line to ground. Another technique is that referred to as a “multi-touch resolve” (MTR) functionality provided by a MTR module 114. This is for sensing changes in the mutual capacitance at the intersection of a row and column line, i.e., the row-to-column capacitance C_{RCF}.

The capapacitive sense block or capacitive-to-digital converter 112 is basically controlled to scan row and column lines and determine the self capacitance thereof to ground. If a change in the self capacitance occurs, this indicates that some external perturbance has occurred, such as a touch. By evaluating the self capacitance values of each of the rows and columns and comparing them with previously determined values, a determination can be made as to where on the touch screen a touch has been made. However, if multiple touches on the touch screen have occurred, this can create an ambiguity. The MTR module 114, as will be described in more detail herein below, operates to selectively generate a pulse or signal on each of the row lines and then monitor all of the column lines to determine the coupling from the row line to each of the column lines. This provides a higher degree of accuracy in determining exactly which intersection of a particular row and column was touched.

Each of the column lines is monitored to determine the value of signal coupled across the row-to-column intersection with the row line being driven by the pulse or signal. Thus, if a pulse or any type of signal is input on a particular row line, for example, the change in the signal coupled across the intersection between that column line and a row line having a finger disposed across the particular intersection will be noticeable since this particular intersection will exhibit the highest change in mutual capacitance. In general, the mutual capacitance across the intersection between row and column lines will actually decrease when a finger is disposed in close proximity thereto. It should be understood that the pulse could be generated on column lines and the row lines sensed, as opposed to the illustrated embodiment wherein the pulse is generated on the column lines and then the row lines sensed, and row and column lines shall be utilized in the description herein in an interchangeable manner. It is noted that for each generation of a pulse, all of the column lines are monitored at substantially the same time depending upon inherent delays in circuitry and the such. This could be facilitated with dedicated analog-to-digital converters for each row/column line or a multiplexed bank of such. As will be described herein below, a pulse input is used in conjunction with a charge transfer technique.

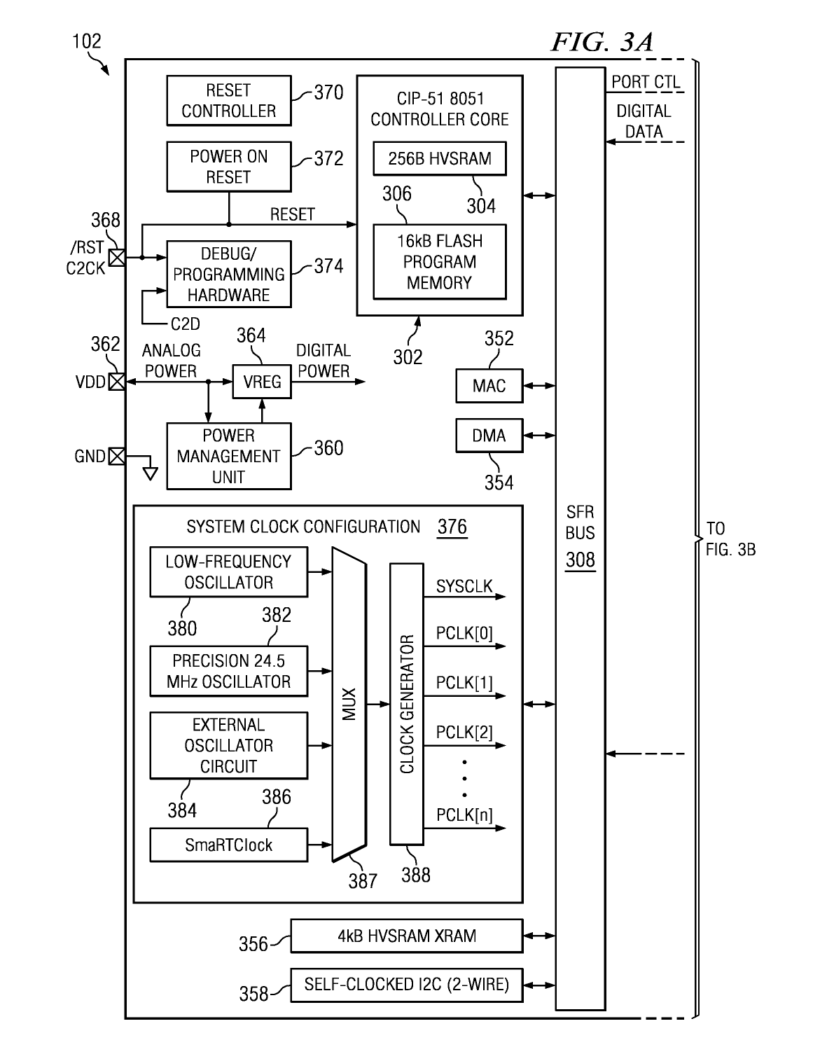

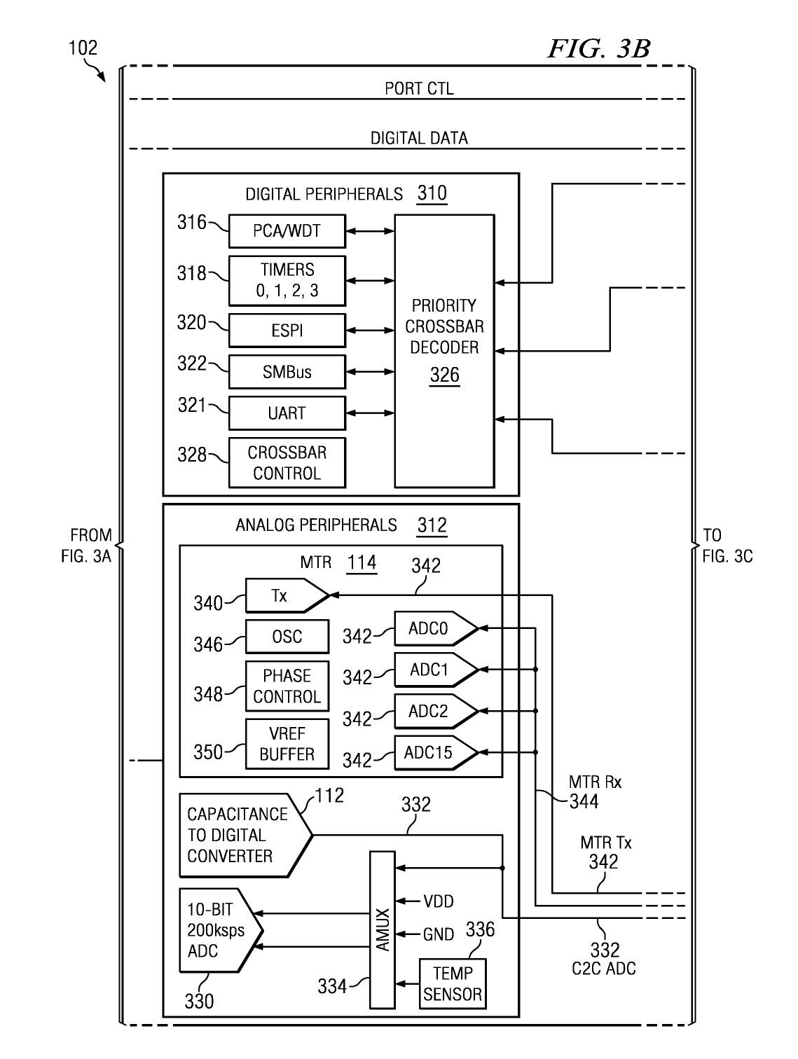

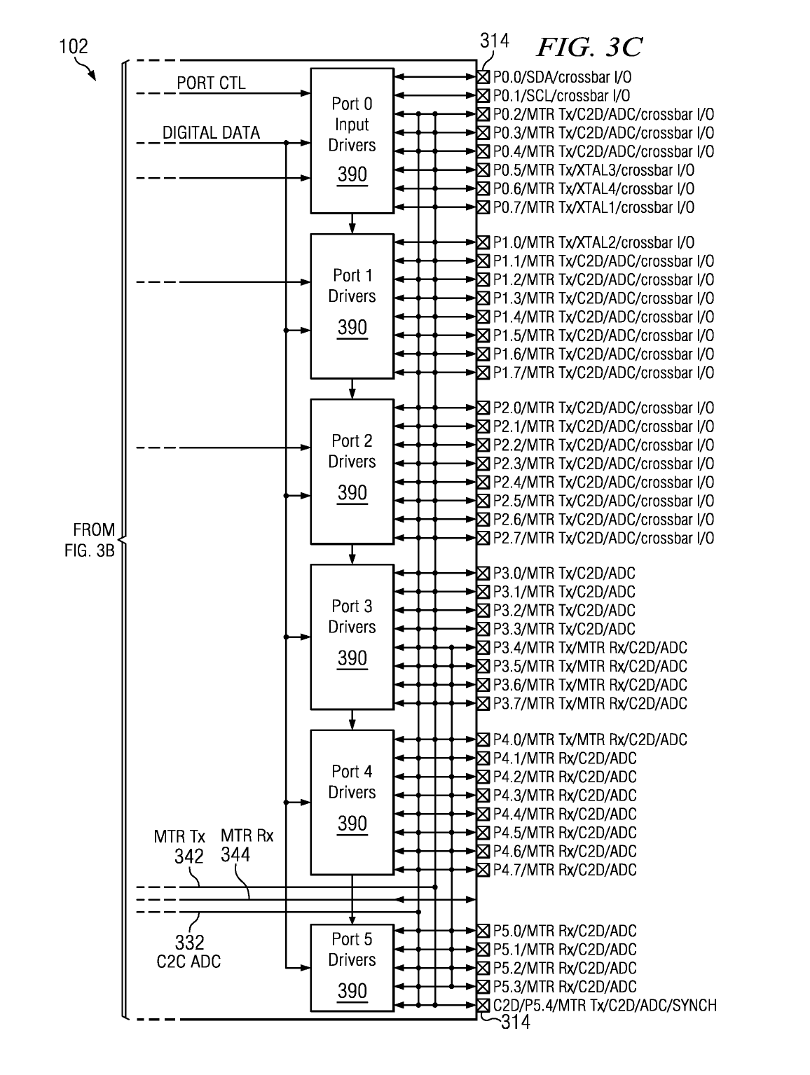

Referring now to FIG. 3a, there is illustrated a more detailed block diagram of the scan control IC 102. At the heart of the scan control IC 102 is an 8051 central processing unit (CPU) 302. The scan control IC 102 is basically a microcontroller unit (MCU) which is described in detail in U.S. Pat. No. 7,171,542, issued Jan. 30, 2007 to the present assignee and entitled RECONFIGURABLE INTERFACE FOR COUPLING FUNCTIONAL INPUT/OUTPUT BLOCKS TO LIMITED NUMBER OF I/O PINS, which is incorporated herein by reference in its entirety. The 8051 processing core 302 includes XRAM 304 and flash memory 306, the flash memory utilized to store program instructions, which memory constitutes non-volatile memory. The 8051 processing core 302 interfaces with various peripheral circuitry on the IC 102 such as contained in a digital peripherals block 310. The interface is provided by a Special Function Register (SFR) bus 308 which allows the processing core 302 to interface with the various peripherals via Special Function Registers (SFRs), these registers being addressable registers within the address spaces of the processing core 302 that allow the processing core 302 to store data therein for use by the digital peripherals and for the peripherals to store processed data or receive data therein for use by the processing core 302. This effectively provides a “gateway” for data back and forth between the various peripherals. The terms CPU, processing core and MCU will be used interchangeably throughout, as the MCU is a combination of the processing core (CPU) 302, memory and peripherals that allow the CPU 302 to carry out the various functions of the overall IC.

The digital peripheral block 310 is one set of peripherals operating in the digital domain and an analog peripheral block 312 provides analog peripherals. These peripherals provide an interface between an interface for the IC 102 to the external world through various external pins. These external pins or output port pins are illustrated in FIG. 3b and designated by reference numeral 314.

The digital peripheral block 310 includes a watch dog timer block 316, various timers 318, a serial peripheral interface block 320, an SMBus block 322 and a UART block 324. All of these blocks 316-324 are interfaced to a priority crossbar decoder 326. The priority crossbar decoder 326 is operable to be configured by a crossbar control block 328 in order to interface the various peripherals 316-324 with select ones of the output port pins 314. This is described in detail in U.S. Pat. No. 7,171,542, which was incorporated by reference herein above. The priority crossbar decoder 326 is utilized for the digital interface and will allow such things as the UART 324 to be interfaced with select pins on the output port pins 314 and these can be user configured for any pins that are desired to be associated therewith. The SMBus 322 utilizes a 2-wire serial bus interface utilizing a clock and a data line and this clock and data line utilize two pins and these can be configured for any two of the select pins. As described in U.S. Pat. No. 7,171,542, these pins, once assigned, can take priority over other pins.

The analog peripheral block 312 includes the cap sense block 112 and the MTR module 114 in addition to including an analog-to-digital converter (ADC) 330. This ADC 330 is a 10-bit ADC which is interfaced with a CDC/ADC bus or analog line 332, this bus or line 332 also interfaced with the input to the capacitive sense block 112. An analog multiplexer 334 is provided for interface between the ADC 330 and the bus 332 such that it can select the bus 332 or other analog peripherals. The analog inputs interfaceable to the bus 332 are typically scanned inputs such that the ADC 330 can selectively sample the analog values thereon by enabling the I/O pad associated with a desired pin designated as an analog input and convert these to digital values. In addition, the multiplexer 334 allows for sensing of the supply voltage, the ground voltage and a voltage associated with an on-chip temperature sensor 336. This temperature sensor 336 is basically associated with a voltage generated by a band gap generator (not shown) which generates various voltages for the operation of the analog circuitry on the IC 102. This is a conventional circuit that provides temperature stabilized voltage sources. By providing for selection of the temperature input, a temperature measurement can be provided which is utilized, as will be described herein below, for calibration of the MTR module 114. It is also used for other functions which are not described herein.

As will be described in more detail herein below, the MTR module 114 is comprised of a transmitter 340 which is operable to transmit a pulse on a negative going edge. This is provided as a driving signal on a single line bus 341. This can be selectively output to one of multiple pins associated with that functionality by enabling a desired I/O pad as an analog output. Additionally, there are provided dedicated ADCs 342 which each interface with one of 16 different input pins on a bus 344. This comprises the MTR Rx inputs, whereas the bus 341 comprises the MTR Tx output. There are 16 ADCs 342 to allow for simultaneous interface to 16 different MTR Rx inputs such that bus 344 has a width of 16. As will be described herein below, each of these ADCs 342 receives one of the 16 inputs in parallel and processes those values in parallel. These are dedicated to the MTR functionality. It should be understood that less than 16 ADCs 342 could be utilized by multiplexing the operation thereof.

In addition to the transmitter 340 and the receive ADCs 342, there is also provided a peripheral oscillator 346 such that the MTR module 114 is a “self-clocked” peripheral. This self clocking allows the MTR module 114, and other such self clocked analog peripherals, to operate when the digital circuitry including clocking circuitry is asleep. The MTR block could also operate on the system clock. This oscillator 346 utilizes an RC oscillator circuit that can run independently or be synched up with an external clock. However, when this oscillator 346 is running, it is asynchronous with respect to the system clock (described herein below) that is utilized to provide timing for the entire chip when running. During various low power modes, the system clock circuitry is halted or powered down and, as such, for the MTR module 114 to operate and scan a particular touch screen, an internal self contained clock is utilized. This will be described in more detail herein below. There is also provided a phase control 348 for control of different MTR operational phases and a V_{REF} buffer 350. This V_{REF} buffer is utilized to sense a reference voltage, which in the case of the MTR module 114 is the supply voltage, and latch it onto a node or, in other words, “freeze” this value during the operation of the ADC 342 conversion operation in order to remove noise. This will be described in more detail herein below.

The 8051 core 302, when performing certain operations, utilizes a Multiply Accumulate Block (MAC) 352 to allow certain multiply and accumulate operations to be carried out in the hardware. Additionally, there is a Direct Memory Access (DMA) block 354 that allows the peripheral units and other peripheral blocks to interface directly with an HVSRAM or XRAM memory 356 through the SFR Bus 308 to allow reading and writing of data therewith out requiring the 8051 processing core 302. Thus, any of the blocks associated with peripheral functions can utilize the DMA 354 to write data to the memory 356 and extract data therefrom. There is also provided a self clocked I2C block 358, which is a self-clocked serial data communication peripheral block that has associated therewith two dedicated pins to allow external chips to interface with the digital portion IC 102. Since this is self-clocked, it can operate when the IC 102 is in a sleep or idle mode. This I2C peripheral block 358 can also interface directly with the memory 356 through the DMA 354 such that an external device can directly read and write to the memory 356 through the I2C peripheral block 358.

There is provided a power management unit (PMU) 360 that is operable to interface with the V_{DD} battery voltage or power supply voltage on a power supply pin 362 in order to provide power to the chip. This is typically provided by a battery. The chip power is divided up into analog power, i.e., unregulated power, and digital power which is provided through a regulator 364. This is an LDO regulator that provides the digital voltage. Typically, the battery voltage can run between 1.8-3.6 volts and this is regulated down to a voltage comparable for operating the digital portion of the chip. The power management unit 360 controls the operation of the regulator 364. This regulator 364 is a regulator that can be powered down during sleep mode. This is described in U.S. patent application Ser. No. 11/865,661, filed Oct. 1, 2007, entitled POWER SUPPLY SYSTEM FOR LOW POWER MCU, which is incorporated herein by reference in its entirety.

In addition to the power management, there is also provided a reset and serial clock input on external pin 368 which is operable to provide for a Reset input and also to allow a serial control clock to be input for data input, debugging, etc. The Reset is controlled by a reset controller 370 and a power on reset block 372. Various debugging programming hardware in block 374 is also provided which is controlled by the C2 Data (CDC) which is received on another input and utilizes the C2 clock signal on pin 368 therefor. The CDC is derived from another input or pin.

All of the system clocks are provided by a system clock block 376. It should be understood that these system clocks are what are utilized for the digital operation and are to be distinguished from the internal clocks and the various self-clocked blocks such as the MTR module 114 and the I2C block 358. The system clocks are comprised of an on-chip, low frequency oscillator 380, a precision oscillator 382, an external oscillator circuit 384 and a smart clock block 386, this smart clock block comprising an RTC clock. This is a 32 kHz clock. Although not illustrated, there is provided an RTC function on the chip which is described in U.S. Pat. No. 7,343,504, issued Mar. 11, 2008 to the present assignee, entitled MICROCONTROLLER UNIT (MCU) WITH RTC, which is incorporated herein by reference in its entirety.

With specific reference to FIG. 3b, there is illustrated a diagrammatic view of the pin out configuration for the output port pins 314. These are the peripheral pins which allow the IC 102 to interface with various external devices such as displays, sensors and control lines. Each of these output port pins 314 is associated with an I/O pad (not shown). This I/O pad allows the output port pin 314 to be configured as a digital input/output pad or as an analog input/output pad. It should be understood that some of the output port pins 314 and the associated I/O pads can be manufactured such that they primarily have either a digital function or an analog function. This is a design choice, but it should be understood that each of the output port pins 314 could be given the functionality to accommodate both analog and digital signals.

When dealing with a digital interface, port drivers or pin interface circuits 390 are provided to interface with the various output port pins 314 when driving a digital value thereto. There are provided six port drivers for port 0, port 1, . . . port 5. As can be seen from the labels, the output port pins 314 associated with port 0, port 1 and port 2 drivers 390 can be associated with the crossbar decoder 326 and, as such, those are the only output port pins 314 that can be interfaced with the digital peripherals in block 310 in this example. However, it can be seen that the bus 341, a single wire bus, for the MTR transmitter 340 can be selectively interfaced to thirty two (32) of the output port pins 314 and, as such, the bus 341 is interfaceable therewith. For the MTR receive function, there is provided a sixteen line MTR Rx bus 341, as there are sixteen MTR ADCs 342. There are provided thirty six output port pins 314 interfaceable with the ADC 330 and thirty nine of the output port pins 314 associated with the CDC capacitive sense function through lines 332, a single line bus. Basically, anything that is associated with the CDC capacitive sense functionality will also be associated with the ADC 330, since they share a common bus 332. Thus, each of these pins will have an analog input capability via the associated I/O pad for selecting such. Although not shown, one of the pins will have a dedicated functionality associated with a SYNC function which is only utilized when multiple ones of the IC 102 are configured in a multi-chip operation and this will be connectable to the MTR Tx bus 341 such that respective pins 314 will be associated therewith.

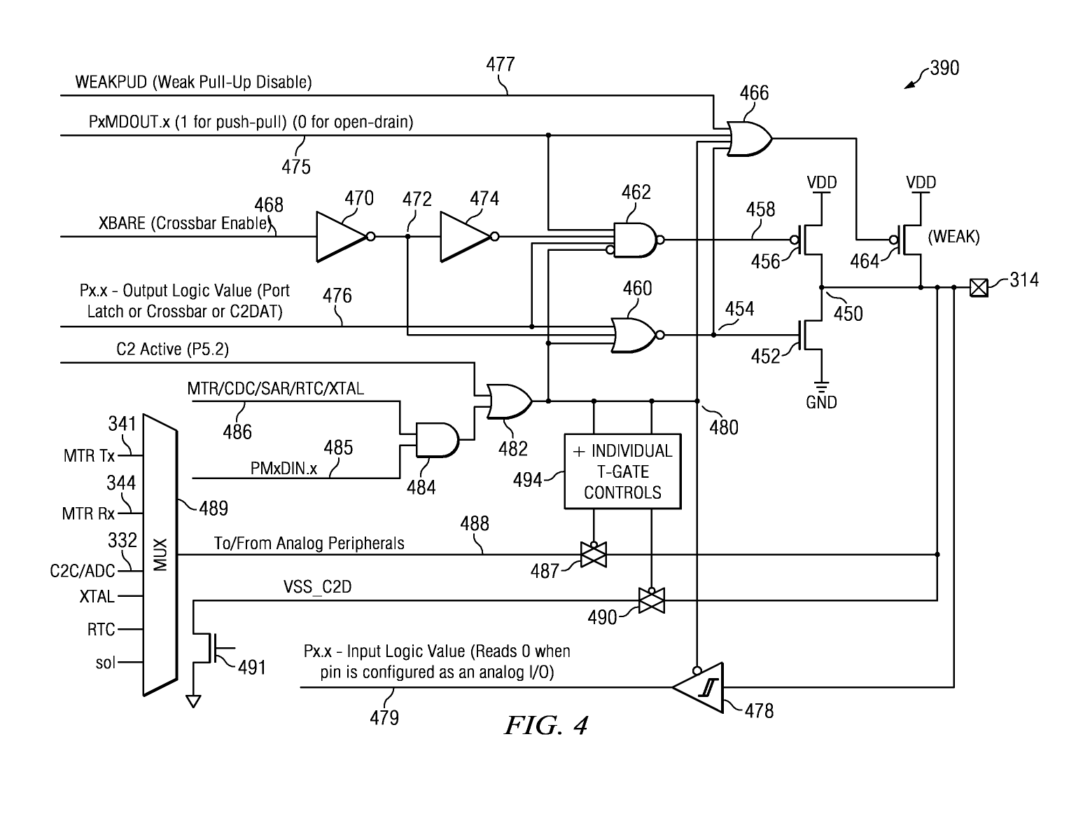

Reference is now made to FIG. 4 where there is shown in functional detail of one pin interface circuit 390, the I/O pad. The other pin interface circuits are constructed and operate in an identical manner, it being understood that some pin interface circuits primarily interface with digital data. While the various logic functions carried out by the pin interface circuit 390 are shown as implemented by traditional logic gates, in practice such functions are carried out by various types of transistor circuits which perform the logic functions. Those skilled in the art can readily devise many different types of transistor circuits to carry out the noted logic functions. Many of the signals coupled to the pin interface circuit 390 are generated by the CPU 302 and some by the analog peripherals 312. In the preferred embodiment, a triplet of the signals is coupled to each pin interface circuit by way of a priority cross-bar decoder. The cross-bar decoder circuit is described in detail in issued patents of the assignee identified as U.S. Pat. No. 6,839,795, issued Jan. 4, 2005 and U.S. Pat. No. 6,738,858, issued May 18, 2004, the subject matter of such patents being incorporated herein by reference.

The pin interface circuit 390 is operable to accommodate a digital I/O function to drive the port with a digital signal or to act as a digital input and receive a digital signal and also to function as an analog I/O port. The digital functionality is facilitated in a driver functionality wherein the output port pin 314 is driven from a node 450 that has the ability to operate as a push-pull node or an open-drain node. In the push-pull operation, an N-channel transistor 452 has the source/drain path thereof connected between node 450 and ground, node 450 connected to the output port pin 314. The gate of transistor 452 is connected to a node 454. A P-channel transistor 456 has the source/drain path thereof connected between node 450 and V_{DD}. The gate of transistor 456 is connected to a node 458. Node 454 is driven by the output of a NOR gate 460 and the gate of transistor 456 is driven by the output of a NAND gate 462. For the open-drain digital output function, there is also provided a weak pull up transistor 464, which is comprised of a P-channel transistor having a source/drain path thereof connecting node 450 and V_{DD} and the gate thereof being driven by an OR gate 466.

When the port is enabled as a digital output, a crossbar encoder enable signal X-BAR is provided as an input on an input node 468. This input 468 drives the input of inverter 470, the output thereof connected to a node 472, node 472 connected to the input of an inverter 474 that drives one input of the NAND gate 462. Node 472 is connected to one input of the NOR gate 460. A control signal received on a node 475 controls whether a particular port is a push-pull port or an open-drain port. This control signal on line 475 is input to one input of the OR gate 466. If it is a logic “1,” this indicates a push-pull operation such that the gate of transistor 464 is at a logic high, thus disabling transistor 464. The signal on node 475 is also input to one input of the NAND gate 462. The output logic value that drives the port when configured as a digital output is provided on a digital input port 476 to drive both one input of the NAND gate 462 and one input of the NOR gate 460. Therefore, if the value is a logic “1” in the push-pull mode this will drive the node 458 low, turning on transistor 456 and it will drive the gate of transistor 452 low. When a logic “0” is input to input port 476, the output of NAND gate 462 is driven high turning off transistor 456 and the output of NOR gate 460 is driven high, turning on transistor 452 and pulling node 450 to ground. This is a push-pull operation. In the open-drain operation, the control signal node 475 is set at a logic “0” in order to disable transistor 456 and enable OR gate 466. Node 454 is connected to one input of the OR gate 466 such that when a logic “low” is input to input port 476 and the output of NOR gate 460 is driven low, this will disable transistor 464. However, when a logic “1” is input to input port 476, this will force a logic “0” on node 454 which is connected to one input of the OR gate 466. This will cause the output of OR gate 466 to go low, enabling transistor 464 to act as a weak pull up. There is also an input on a line 477 that disables the pull up by putting a logic “1” on the input of OR gate 466 to pull the gate of transistor 464 high. This will utilize an external pull up in that event.

During a receive operation, the crossbar enable signal on input node 468 is pulled low, since this is not a digital output. The digital input is provided by a receiver 478 that has the input therefore connected to the output port pin 314 on node 450 and the output thereof provided on a receive output 479. The receiver 478 is controlled by a signal on a node 480 that, when at a logic “1,” would disable the receiver 478, and when at a logic “0,” the receiver would be enabled. Node 480 is connected to the output of an OR gate 482, one input thereof connected to a signal C2_Active, which is the serial input port for receiving serial data for configuration and debug operation. This is associated with the debug/programming hardware block 374. The other input of the OR gate 482 is connected to the output of an AND gate 484, one input thereof connected to a control signal on an input node 485 that defines the port as the digital input and the other input thereof connected through an inverter node to an input node 486, this being the input that allows the port to be configured as an analog port for use with the analog peripherals. The node 480 is also connected to one input of the NOR gate 460 and, through an inverting node, to one input of the NAND gate 462. Therefore, when the node 480 is at a logic “1,” this will force the output of NOR gate 460 on node 454 low, disabling transistor 452 and it will force a logic “0” on the input of NAND gate 462, forcing the output thereof high, disabling transistor 456, such that the port can not drive the signal to the output port pin 314.

Whenever the port is configured as an analog input/output, both the digital receive function and the digital transmit function are disabled. A logic “1” on node 480 disables the receiver 478 and disables transistors 452 and 456. This will also control two analog paths, one controlled by a transfer gate 487 to connect output port pin 314 to an analog peripheral node 488, this being connected to the output of an analog multiplexer block 489. A second transfer gate 490 is provided for connecting output port pin 314 to an N-channel pull-down transistor 491, this being a pull-down. Thus, if transfer gate 490 connects output port pin 314 for the associated output port to the drain of transistor 491, this node will be pulled to ground. As will be described herein above, for a panel scanning operation, prior to the panel scan, all nodes associated with the columns and rows of the panel are pulled to ground. Thereafter, a select one or ones of the nodes will be tested by either self capacitance measurement or mutual capacitance measurement with the remaining nodes being held to ground through this pull-down transistor 491. The node of interest for being tested will then have the transfer gates 490 deactivated during the analog operation and the transfer gate 487 activated such that the analog input or output will be connected to the node 488 and controlled by the multiplexer 489.

The multiplexer 489 is an analog multiplexer associated with the pad that is operable to selectively connect the node 488 to either the MTR Tx line or bus 341, the MTR Rx line or bus 344, the CDC/ADC bus or analog line 332 or to function as a crystal input for interfacing with one terminal of a crystal or to function as an RTC input. As noted herein above, certain ports can not be configured to connect to these particular lines. However, the analog multiplexer block 489 is a pad specific or port specific multiplexer that is capable of being interfaced with all of the associated potential analog signals. It may be that, from a layout standpoint, certain pins would not be connectable to, for example, the MTR Tx bus 341. In that situation, the line would not be run to the associated analog multiplexer. It may even be that certain ports would not have an analog functionality at all such that they would not require the associated T-gates 487 and 490 nor the multiplexer 489. However, for those ports that function both with digital input/output capability and an analog input/output functionality, the input/output circuitry of FIG. 4 will be utilized.

In order to select a particular pad as an analog input/output, the output of the OR gate 482 will be controlled to generate a logic “1.” Thus, one of the inputs to the OR gate 482 needs to be at a logic “1;” either the C2 Active input needs to be high or the output of the AND gate 484 needs to be high. The output of the AND gate 484 is high whenever the input on node 485 is high and the input on node 486 is low. Thus when the port manager generates a logic “1” on the node 485, then the node 480 is controlled by the signal on node 486. This signal can be generated by the CPU or it can be hardware generated by any of the analog peripheral blocks. As will be described herein below, the analog peripherals can operate in the various low power modes wherein the CPU is not operating. These analog peripherals, such as the MTR module 114 and the capacitive sense block 112, are hardware state machines. They can control any one of the particular blocks to function as an analog input/output block and also control which of the two transfer gates 487 and 490 are activated. This function is controlled by a transfer gate control block 494 which provides an AND function (not shown) which ANDs control signals from the respective hardware block to select either one of the transfer gates 487 and 490. As an example, consider the operation of the multi-touch resolve operation. In this operation, certain ones of the pins are controlled to be transmit pins and certain ones of the pins are controlled to be receive pins, as set forth in FIG. 3b. The control operation will, in a first mode, connect all of the respective columns and rows to ground, via global activation of the transfer gate 490. The respective output pads will be configured as analog input/output pads by pulling the node 486 low for those respective pads and then the transfer gates associated therewith will be turned on. In the next step, the panel scanning step, there will be a strobe of one row and all columns connected to ADCs 342 (a parallel sense operation). One row is connected to the MTR Tx line 341 and all of the columns are connected to their respective MTR Rx line on bus 344, it being noted that there will be one input to the associated multiplexer for a pad associated with one of the ADCs 342, this being a layout restraint. Thus, all of the MTR Rx signals will be connected through the T-gate 487 during a panel strobe to the respective MTR Rx bus line on bus 344 and, thus, to their corresponding ADC 342. The remaining row lines that are associated with the MTR Tx functionality will be connected to ground through the respective transfer gate 490. Alternatively, for the self capacitance check, each of the rows or columns in the display are individually selected with the remaining ones connected to ground through the transfer gate 490. Thus, one transfer gate 487 for one pad will be activated for this operation.

Thus, it can be seen that any particular pad can be controlled to provide an output driving signal from an analog signal generator or be connected to receive an analog input. This functionality can be provided in hardware such that a state machine running during the sleep mode of the processor can individually select a particular port for an output signal. As will also be described herein above, one of the output port pins 314 can also be configured as a synch port to provide a synchronization signal for a multi-chip operation. This would allow the state machine to generate a synchronizing edge at a given time for transfer to other chips. All this would require is that the transfer gate 487 for that pad be connected to the synchronizing signal generator, this typically being a logic gate that would output a synchronizing signal to the output that could be connected to other chips. This will be described in more detail herein below.

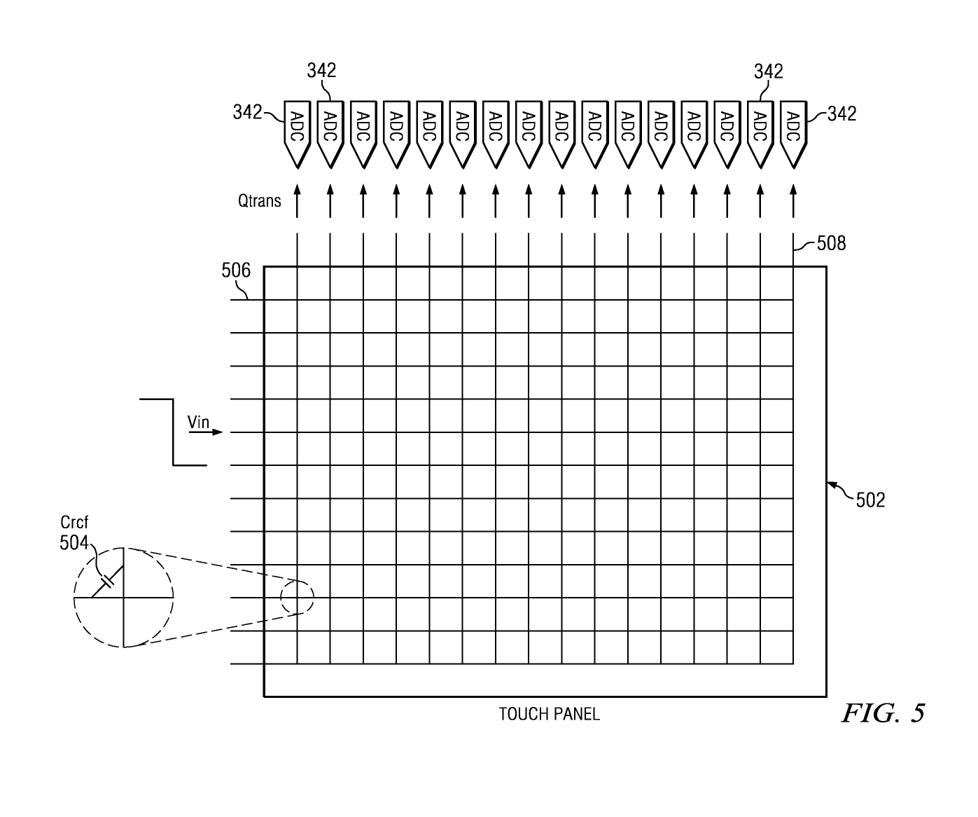

Referring now to FIG. 5, there is illustrated a diagrammatic view of a touch panel 502 representing the touch screen 104. The touch panel 502 is a capacitive touch panel that is comprised of a plurality of transparent row lines and column lines, the row lines being parallel to each other and the column lines being parallel to each other. These row and column lines are electrically isolated from one another and are all transparent. Typically, these conductive lines are formed from Indian Tin Oxide (ITO). This provides a mutual capacitance sensing medium such that, between the intersection of each row line and column line, there exists a row-to-column capacitance (C_{RCF}) 504. The row lines are designated as row lines 506 and the column lines are designated as column lines 508.

As was described herein above, each of the row lines 506 is sequentially driven by a negative going pulse and all of the column lines 508 are output simultaneously to a respective one of the ADCs 342 to allow charge to be transferred from the C_{RCF} associated with the intersection of the driven row line 506 and the respective intersection between that row line 506 and the column line 508. Charge is transferred from C_{RCF} to the respective ADC 342 and a conversion performed to convert that quantum of charge transferred out of C_{RCF} to a digital value, which will be described in more detail herein below. It should be understood that, although the illustration shows the rows being driven and the columns being sensed, it is possible to drive the columns and sense the rows. Thus, creation of a charge on the capacitor 504 followed by transfer of that charge to the ADC 342 allows for evaluation of the value of that charge.

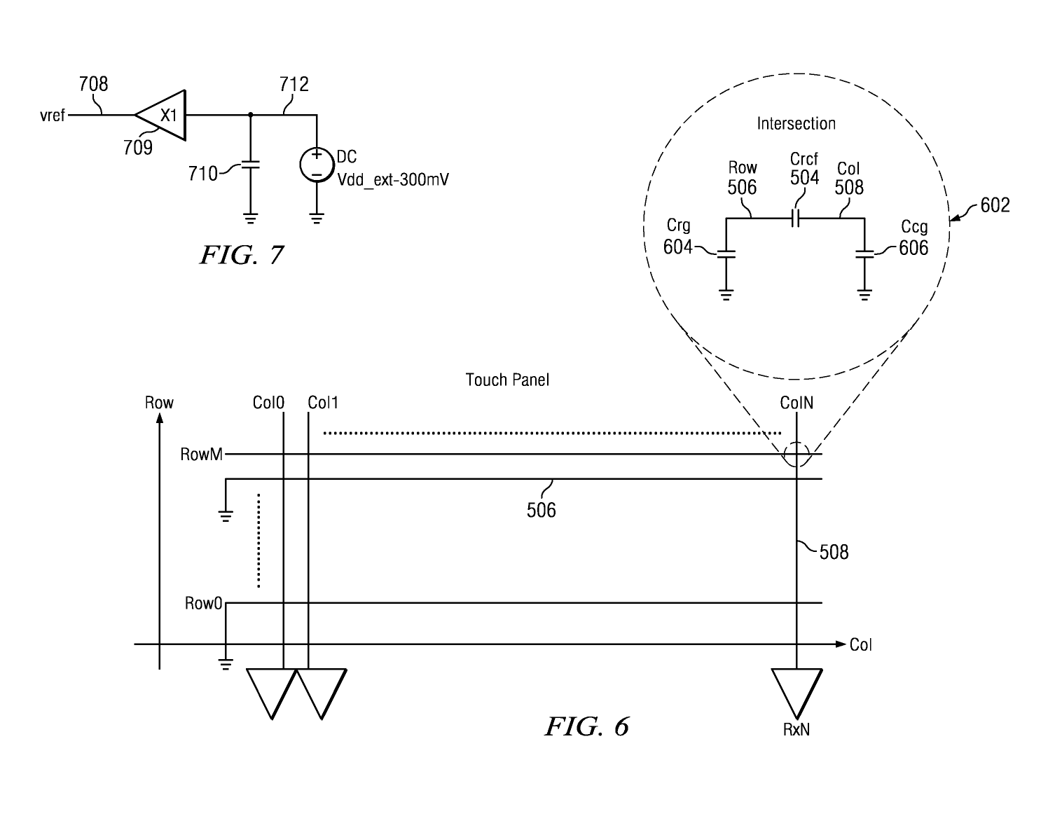

Referring now to FIG. 6, there is illustrated a detail of the touch panel 502 illustrating the intersection of the row lines 506 and the column lines 508 at a point 602. At this point, the circuitry therefor can be simplified as having the C_{RCF} for that intersection disposed between a row-to-ground capacitance (C_{RG}) 604 and the column-to-ground capacitance (C_{CG}) 606. Each of the row lines 506, depending upon the size of the panel, will have a capacitance to ground associated therewith. The larger the panel, the more the capacitance. This is also the case with respect to the C_{CG} capacitance on the column line. The desire is to measure the capacitance change of C_{RCF} whenever a finger touch is present. If there is a finger touch, what will happen is that C_{RCF} will decrease while C_{CG} and C_{RG} increase. Thus, each intersection is scanned such that the change in that the value of capacitance C_{RCF} can be determined. It is noted that the stronger the touch, the stronger the change in capacitance. However, the CPU 302 that evaluates these values will determine from the intersection or intersections that exhibit a change in capacitance whether a finger touch has actually occurred and what that information means. The circuitry associated with the display and the MTR function functions to measure the capacitance, determine if a change has occurred, collect data and inform the CPU 302 of such.

Referring now to FIG. 7, there is illustrated a diagrammatic view for the sampling circuitry for sampling the voltages for the ADC operation. Prior to performing a “conversion” operation wherein the charge from the associated C_{RCF} is transferred to the ADC 342 and converted into a digital value, power noise is minimized. As noted herein above, this particular peripheral block, MTR module 114, associated with the MTR function, is interfaced with the unregulated supply voltage, i.e., the battery voltage. In order to remove the noise, the driving voltage V_{DRV} for the MTR transmitter 340 is a divided and buffered value of V_{REF}. The ADC 342 utilizes this reference voltage on a node 708 that is derived from a sample capacitor 710 through a buffer 709 that samples the DC input voltage from the battery onto a node 712. The switches are not illustrated for the sampling operation for each of the node 712, but they will utilize such. The divided voltage V_{DRV} and the V_{IN} voltage are ratiometric so that the power noise will not be in the final result.

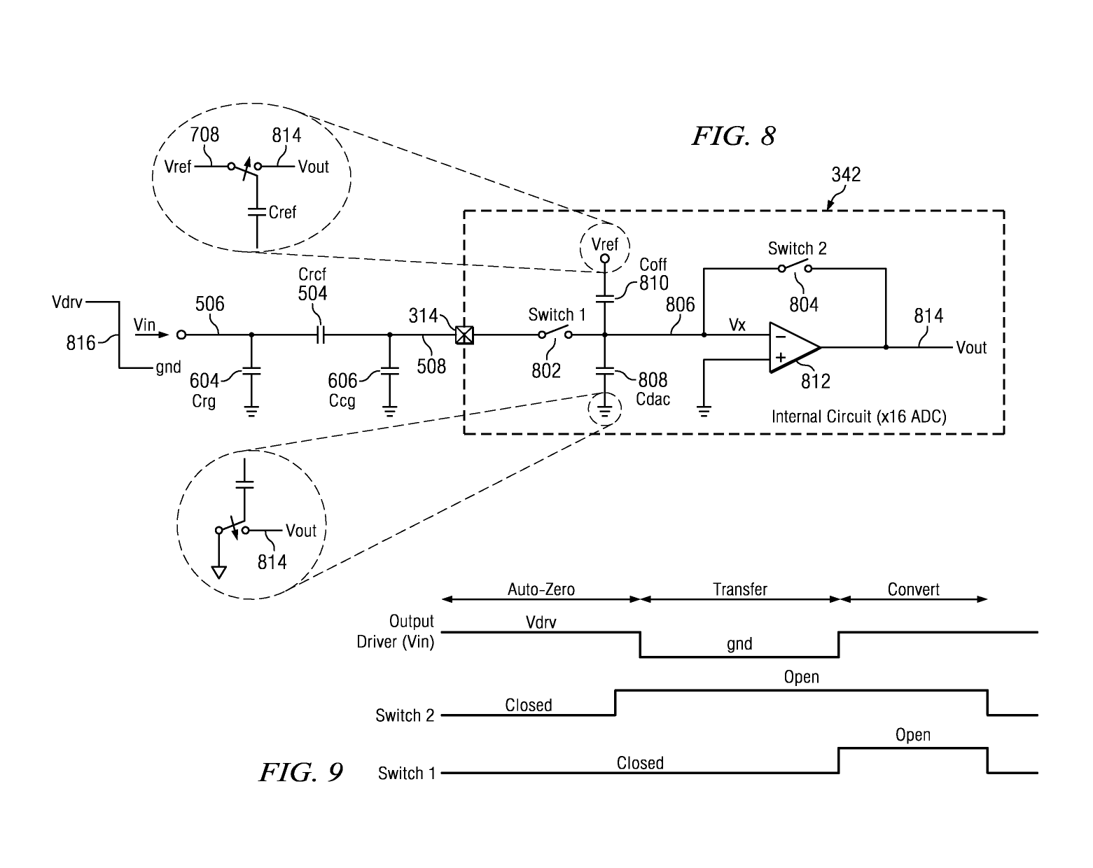

Referring now to FIG. 8, there is illustrated the basic configuration for the ADC 342. External to the chip at one of the output port pins 314 associated with a particular MTR Rx input, one column line 508 will be associated therewith. A row line 506 will be driven, it being noted that there will be up to sixteen ADCs 342 associated with sixteen column lines 508 that are perpendicular to the one single row line 506 that is being driven with the negative going edge referred to as V_{IN}. The ADC 342 interior to the IC 102 is denoted by a dotted line to indicate that it is interior to the chip. The ADC 342 will be connected to or interfaced to the column line 508 through the output port pin 314. A switch 802 (switch 1) is operable to switchably connect the column line 508 to an internal node 806. Node 806 is connected to one plate of a capacitor 808 labeled C_{DAC} and also to one plate of a reference capacitor C_{OFF} 810. The C_{DAC} capacitor 808 has the other plate thereof connected to ground with the C_{OFF} capacitor 810 having the other plate thereof connected to a voltage V_{REF}. Voltage V_{REF} is the voltage sampled onto the capacitor 710 and node 712 and then output on node 708 by buffer 709. The node 806 is connected to the negative input of an amplifier 812, the positive input thereof connected to ground for illustrative purposes. In general, the positive node will be connected to a common mode voltage in most instances, but this could be ground and is illustrated as such for clarity purposes. It should also be noted that this particular amplifier 812 has an offset voltage. Therefore, the negative input will typically be offset by an offset voltage which, for this embodiment, is approximately 900 mV but can vary depending upon the amplifier circuitry. The switch 804 is connected between the node 806 on the negative input of the amplifier 812 and the output thereof to switchably connect the two together and basically short the negative input to the output to provide a unity gain amplifier. The output is labeled V_{OUT}. The purpose for the capacitor C_{OFF} 810 is to guarantee that the amplifier 812 works in the high gain region for the entire range of C_{RCF} such that any voltage variation across C_{DAC} will not go above or below the rail voltage on the output of the amplifier 812.

The plate of capacitor 810 opposite to node 806 that is illustrated as being connected to V_{REF} is actually switchably connectable between V_{REF} on node 708 and the output of the amplifier on a node or V_{OUT} terminal 814. Thus, the other plate of the capacitor can be connected to two different voltages. Similarly, the other plate of the C_{DAC} capacitor 808, illustrated as being connected to ground, is switchably connectable between ground and the V_{OUT} terminal 814. This will be clarified with the description herein below.

Prior to describing the operation in detail, the general operation will be described. The goal of the operation is to initially charge up both the row line 506 and the column line 508 in what is referred to as an auto zero mode. This occurs at the high side of V_{IN} at a point 816 at level V_{DRV}. Depending upon the size of the display, the value of C_{RG} (capacitor 604) can be rather large. Similarly, the capacitor C_{CG} could also be large. Thus, there is required a certain amount of time for this capacitor to fully charge to the voltage V_{DRV}. This is a programmable length of time. It is noted that, prior to a “strobe” of any portion of the touch screen, all inputs (nodes associated with row lines 506 and column lines 508) are grounded. In order to charge up the node 508, switch 804 (switch 2) is closed such that the unity gain amplifier will drive the negative input. In this configuration, the negative input is essentially disposed at a virtual ground which, if amplifier 812 had no offset, would be the voltage on the positive input thereof. However, with the offset, the negative input will be offset from the positive input by 900 mV in one embodiment, although this offset value is a design choice. In any event, it will be at a fixed voltage which will cause the node 508 to be charged to the virtual ground voltage, referred to as “V_{X},” and this will charge up the column to ground capacitor C_{CG} 606, the C_{DAC} capacitor 808 and the C_{OFF} capacitor 810 to V_{X}. The next step is the sampling or transfer operation wherein the charge from the C_{RCF} capacitor 504 is transferred onto the C_{DAC} and C_{REF} capacitors. To do this, switch 802 is maintained in a closed position but switch 804 is opened and the C_{OFF} and C_{DAC} capacitors are connected in parallel between node 806 and the output of amplifier 812. This will effectively maintain the negative input at the virtual ground level V_{X} that existed when switch 804 was closed. This will keep the column line 508 and the node 806 at the same voltage and then V_{IN} is moved from the V_{DRV} voltage to ground. This will effectively transfer the charge on capacitor 504 to the C_{OFF} and C_{DAC} capacitors. A conversion operation is then implemented wherein the column line 508 is isolated from node 806 and then the charge difference on the C_{DAC} and C_{OFF} capacitors determined with a successive approximation register (SAR) algorithm to determine a digital voltage representing the difference in charge. By isolating the column line from the ADC 342 during conversion, any noise that might occur during the conversion process will also be isolated. Thus, the operation will entail first charging up the capacitor 504, the C_{RCF} capacitor, with a quantum of charge. This quantum of charge is then transferred onto an internal capacitor or capacitors to change the charge disposed therein. This is followed by a determination of the change in charge. It is this change in charge that correlates to the charge on the capacitor 504. As will be described herein below, since the voltage on node 806 is maintained at the same voltage for the initial auto zero or charging operation of the column line and the charge transfer operation, this column-to-ground capacitor is effectively canceled out from the operation.

Referring now to FIG. 9, there is illustrated a timing diagram for the ADC operation. This ADC operation consists of three phases, an auto zero phase, a transfer phase and a charge to digital conversion phase. The first waveform illustrates the input driver signal that drives the row. This is a signal that is shifted between the drive signal V_{DRV} and ground. Initially, in the auto zero phase, switch 804 (switch 2) is closed and switch 802 (switch 1) is closed. This allows both the column line 508 and the row line 506 to be charged up from the initial ground condition, noting that one row is driven by a Tx pulse, whereas 16 columns are connected to ADCs 342. As noted herein above, the column line is charged to virtual ground V_{X} on the negative input of the amplifier 812. With the offset, this differs from the common mode voltage (or ground) on the positive input of the amplifier 812 by that offset voltage.

In the next phase, the transfer phase, switch 804 (switch 2) is opened and the voltage of V_{IN} driven to ground to transfer charge from the C_{RCF} capacitor (504) to the C_{DAC} and C_{OFF} capacitors. Switch 802 (switch 1) still remains closed. Note that, when switch 804 is open, the opposite plates of C_{DAC} and C_{OFF} which were originally connected to ground and V_{REF}, respectively, will be switched to V_{OUT}. This effectively transfers a charge onto C_{DAC} and C_{OFF}. At the end of the transfer phase, the convert phase is initiated with switch 804 still remaining open. The opposite plates of capacitor C_{DAC} and C_{OFF} from node 806 are again switched to ground and V_{REF}, respectively, after switch 802 (switch 1) opened. During this phase, the amplifier 812 functions as a comparator in a SAR conversion operation, which will be described herein below.

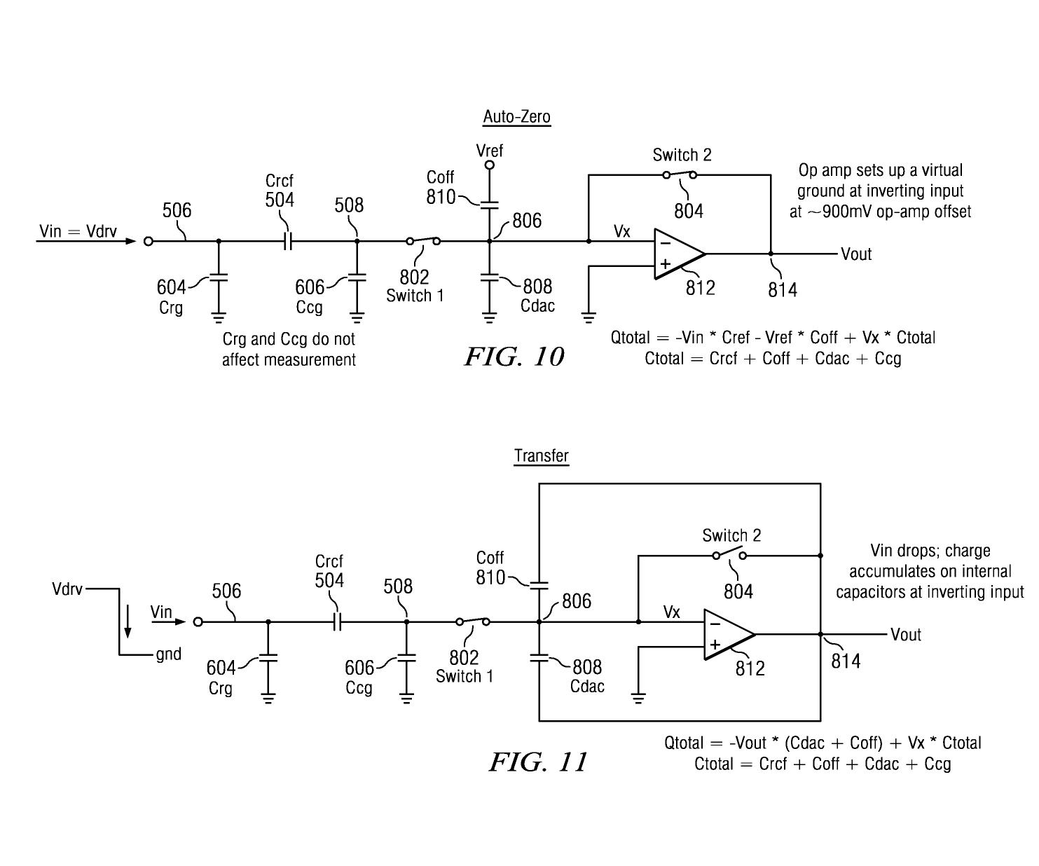

With specific reference to FIG. 10, there is illustrated a configuration for the auto zero phase. In this configuration, switch 804 (switch 2) is closed thus driving the negative input of amplifier 812 on node 806 to virtual ground which will charge node 806 to the virtual ground voltage V_{X}. This will result in a voltage across C_{DAC} of V_{X}, a voltage across C_{OFF} of V_{REF}−V_{X}, a voltage across C_{CG} of V_{X} and a voltage across C_{RCF} of V_{DRV}−V_{X}. The charge on the plate 806 is referred to as the total charge or Qₜₒₜₐₗ. Since the charge across the capacitor is set by the relationship Q=CV, the following relationship will exist for Qₜₒₜₐₗ:

Qtotal=−Vin·Cref−Vref·Coff+Vx·Ctotal

Where: Ctotal=Crcf+Coff+Cdac+Ccg

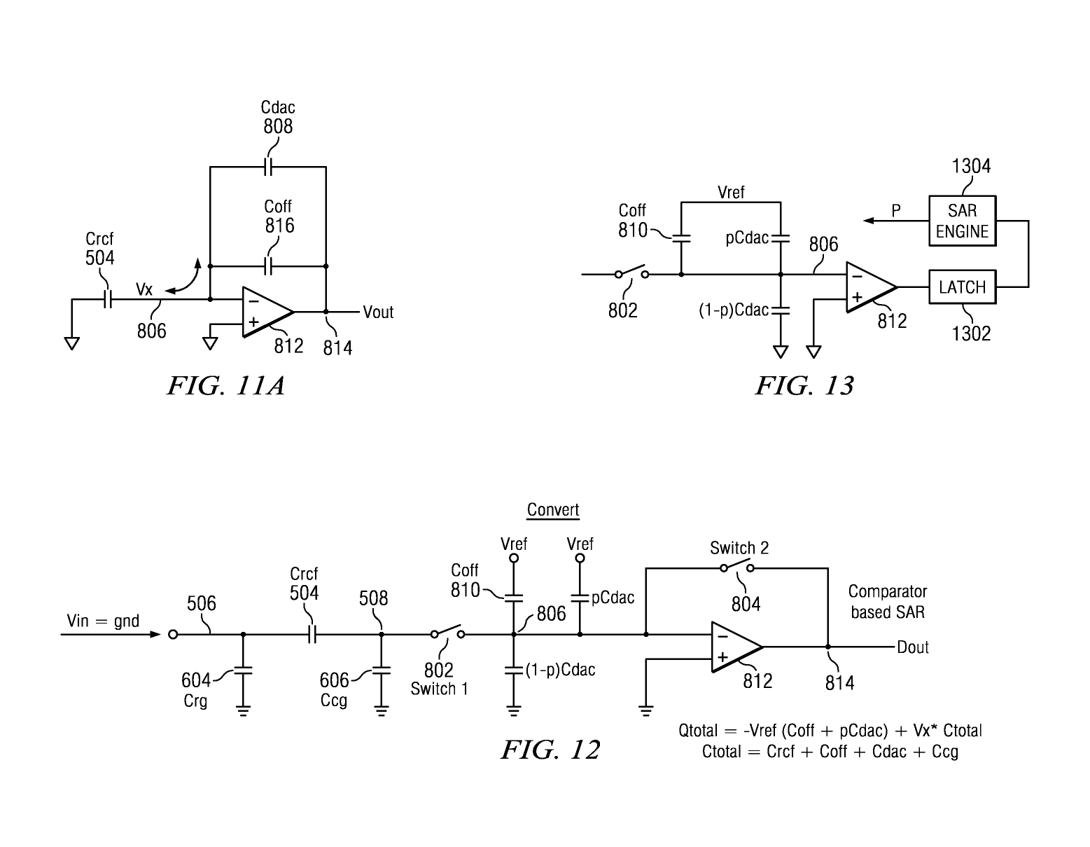

Thus, the amplifier 812 was configured as a unity gain op-amp to basically set up a virtual ground at the inverting input thereof on node 806. The next step is to go to the transfer phase illustrated in FIG. 11. In this phase, switch 2 is opened and the opposite plates of C_{OFF} and C_{DAC} from node 806 are connected to the V_{OUT} terminal 814. Then, V_{IN} is dropped from the V_{DRV} drive level to ground. This will force charge onto the C_{OFF} and C_{DAC} capacitors because the node 806 is at a virtual ground level at voltage V_{X} and is maintained there by the amplifier 812 configured as a feedback amplifier. This will cause the charge on capacitors C_{DAC} and C_{OFF} to change. This is better illustrated in the simplified diagram of FIG. 11a. It can be seen that the charge on the capacitor C_{OFF} and C_{DAC} would be defined by the relationship Q=(V_{O}−V_{X})(C_{DAC}+C_{OFF}) after charge is transferred thereto. This change in C_{RCF} would be changed once V_{IN} was lowered. When V_{IN} is lowered, the charge on the C_{RCF} capacitor 504 is transferred because the voltage across the C_{CG} capacitor 606 has not changed. The result of V_{IN} going from V_{DRV} to ground causes an increase to the charge in C_{RCF}, thus decreasing the charge in C_{OFF} and C_{DAC}. The following relationship exists with respect to the total charge on the node 806:

Qtotal=−Vout·(Cdac+Coff)+Vx·Ctotal

Where: Ctotal=Crcf+Coff+Cdac+Ccg

After the defined time during which the charge will transfer, the conversion operation is then entered, this being a SAR conversion operation. Prior to the conversion operation, however, switch 802 is opened to isolate the column line 508 from the ADC 342 such that any external noise, will not affect the conversion operation. Since the charge has already been transferred to C_{OFF} and C_{DAC}, all that remains is to determine the amount of charge transferred thereto.

During the conversion operation, the switches that switch the opposite plates of C_{DAC} and C_{OFF} to V_{OUT} are reconnected to ground and V_{REF}, respectively, such that the capacitors are in substantially the same condition as the auto zero phase noting that analog ground for different components connected to different grounds, i.e., on-chip, off-chip, can have various noise components associated therewith and there may be slight differences. Initially, C_{DAC} at full value is connected between node 806 and ground. The amplifier 812 is now in an open loop configuration such that it is no longer operating as an op-amp and, thus, does not hold the inverting input thereof at the virtual ground level, what will occur is that the voltage on node 806 will change, i.e., it will not be at V_{X}. Thus, the output of the amplifier 812, it now functioning as a comparator, will be high or low. What then occurs is that the value of C_{DAC} is ratioed such that a portion thereof will be connected from node 806 to V_{REF}. The capacitor C_{DAC} is set at a value of approximately 5 pF which is essentially the approximate full range value of the row-to-column capacitance C_{RCF}. It is configured utilizing a plurality of unit caps of value “C” connected in parallel to provide a 5 bit binary set of capacitors, i.e., capacitors C, 2C, 4C, 18C and 16C, and a 5-bit thermometer code utilizing 32 unit caps of value. These can be configured such that the portion of C_{DAC} that is connected between node 806 and ground will have a value of (1−p)C_{DAC} and the portion of C_{DAC} connected between node 806 and V_{REF} will be pC_{DAC}. It can be seen that if p=0, this would indicate that the value of C_{RCF} would be equal to zero. This would be expected in that no change in the charge across C_{DAC} and C_{OFF} existed and, therefore, the voltage on node 806 would essentially be V_{X}, a voltage right at the trigger point for amplifier 812 configured as a comparator. When C_{RCF} is not zero and has some charge stored therein, and charge has been transferred, the SAR algorithm will vary the value of p until the voltage on node 806 is approximately equal to V_{X}, the trip voltage. At this point, there will be a digital value associated with the value of p which will equal the digital value corresponding to the charge on C_{RCF}. Thus, what has been achieved is an analog-to-digital converter that converts charge to a digital value. It is a charge-to-data converter in essence. The relationship for Qₜₒₜₐₗ for node 806 during the conversion operation is, for the configuration illustrated, as follows:

Qtotal=−Vref·(Coff+pCdac)+Vx·Ctotal

Where: Ctotal=Crcf+Coff+Cdac+Ccg

Another way to describe the way in which the charge is present on the various capacitors and nodes is to calculate the charge in a different manner. Referring back to FIG. 10 and the auto zero mode, it can be seen that the common plate charge on node 806 will be as follows:

Qaz=Vx·Cdac+(Vx−Vref)·Coff+(Vx−Vdrv)·Crcf+Vx·Ccg

This takes into account the charge across each of the C_{RCF}, C_{CG}, C_{DAC} and C_{OFF} capacitors.

Then, following through to FIGS. 11 and 11a, it can be seen that, when the voltage on the row line is pulled from V_{DRV} to ground, the common plate charge on node 806 will be defined as follows:

Qxfer=(Vx−Vo)·CDAC+(Vx−Vo)·Coff+Vx·Crcf+Vx·Ccg

Since the total charge has not changed but, rather, has merely been shifted from C_{RCF} to C_{DAC} and C_{OFF}, the other relationship Q_{az}=Q_{xfer} will be valid. With this equality, and substituting in the equations for Q_{az} and Q_{xfer}, the following relationship will result:

Crcf·Vdrv=Cdac·Vo+Coff·(Vo−Vref)

This will result in the following relationship with respect to the output voltage of the amplifier 812:

$$Vo = \frac{Coff \cdot Vref + Crcf \cdot Vdrv}{Cdac + Coff}$$

In the conversion phase, illustrated in FIG. 12, the two capacitor values will be C_{OFF} and pC_{DAC} connected between node 806 and V_{REF} and (1−p) C_{DAC}, disposed between node 806 and ground. The relationship for the common plate charge on node 806 at the end of the SAR conversion phase where the voltage on the inverting input of the amplifier 812 will be essentially equal to the trip point which is V_{X}, i.e., the virtual ground voltage. The plate charge on node 806 in the configuration of FIG. 12, wherein the node 806 is disposed at V_{X} at the end of the SAR conversion process and the capacitors C_{OFF} and pC_{DAC} are connected between node 806 and V_{REF} and the capacitor (1−p) C_{DAC} is connected between node 806 and ground, should be identical to the charge that was stored on C_{OFF} and C_{DAC} when they were connected in feedback with amplifier 812 in FIG. 11 and FIG. 11a. Thus, the following relationship will represent that equality:

Cdac·Vx(1−p)+pCdac·(Vx−Vref)+(Vx−Vref)Coff=(Vx−Vo)(Cdac+Coff)

Upon reducing the above equation, the following relationship will exist:

p·Cdac·Vref=Cdac·Vo+Coff(Vo−Vref)=Crcf·Vdrv

which will yield:

$$p = \frac{Crcf \cdot Vdrv}{Cdac \cdot Vref}$$

It can be seen from the previous equation that, if C_{RCF} is set equal to zero, the value of p will be set equal to zero, which shows that there will be no distribution of charge. If C_{RCF} is equal to C_{DAC}, and V_{DRV} is equal to V_{REF}, then the value of the capacitor C_{DAC} disposed between node 806 and ground would be equal to zero, since p=1.

Referring now to FIG. 13, there is illustrated a diagrammatic view of the SAR engine during the conversion phase. During this phase, the amplifier 812 is configured as a comparator and switch 802 (switch 1) is open, thus isolating node 806 from the array and, thus, preventing any noise from being passed across switch 802 from the array. C_{DAC}, as described herein above, is comprised of multiple capacitors such that a portion of the capacitor C_{DAC} can be disposed between node 806 and ground and a portion can be disposed between node 806 and V_{REF}. The output of amplifier 812 is input to a latch 1302, the output thereof utilized by a SAR engine 1304 to generate the value of “p.” The C_{DAC} capacitor is comprised of a 5-bit binary capacitor section and a 5-bit thermometer section. The binary section is comprised of a combination of unit capacitors which stores a value “C” such that the capacitors in the 5-bit binary array are C, 2C, 4C, 8C and 16C, resulting in 31 unit capacitors. The thermometer portion will have 2⁵−1 capacitors or 31 capacitors of size 32C. This type of DAC is usually referred to as a hybrid DAC wherein the thermometer coded bits are associated with the five most significant bits and the binary weighted bits are associated with the five least significant bits. With the binary weighted portion of the DAC, elements corresponding to the more significant bits are weighted higher than elements corresponding to the less significant bits. With respect to the thermometer coded DAC portion, the number of asserted bits in the thermometer code would be proportional to the value of the digital signal and each bit of the thermometer code is provided to a corresponding capacitor. A binary to thermometer decoder is utilized to generate the thermometer code from the binary code.

During the SAR operation, the first step will be to assert the most significant bit and determine if node 806 is at or below the trip point. As described herein above, the trip point will be the virtual ground which is basically the voltage offset from the positive input voltage. Even though this voltage is illustrated as being connected to circuit ground, it would typically be connected to a common mode voltage generated on-chip. Thus, when the voltage goes above the trip point, the output of amplifier 812 will go negative and, when it is below the trip point, the output will go positive. The SAR engine 1304 will test each bit to determine if the voltage on node 806 is above or below the trip point. If it is below the trip point, that bit will be maintained as a latched value and then the next value tested, such that each lower MSB can be tested in sequence. If the next MSB causes the voltage to go above the trip point, this bit is maintained at a logic “0” for the value “p.” At the end of the SAR operation, after 10 bits, the value will be latched and this will constitute the result. What this value indicates is a digital value corresponding to the charge that was transferred to C_{OFF} and C_{DAC}. As noted herein above, if the value of the transferred charge were “0,” there would have been no change in the charge stored on C_{OFF} and C_{DAC} and the voltage on node 806 in that situation would have been equal to the trip point voltage (the virtual ground voltage) and the result would be that value of “p” would be equal to zero. Thus, by transferring the charge to the capacitors C_{OFF} and C_{DAC} and then isolating node 806 from the array, a conversion can be made to a digital value that represents the charge on C_{RCF}. This is thus a data converter that converts charge to a digital value or a charge-to-digital converter.

The value output by the ADC 342 is utilized to determine whether there has been a change in the capacitance value or the charge stored on the capacitor. In the presence of a touch, the column to ground capacitance will increase and the column-to-row capacitance (C_{RCF}) will decrease. If the decrease is beyond a certain threshold, a decision can be made that this is a “touch” condition. However, scanning of an array will usually result in a no-touch decision since the display is idle a large percentage of the time with respect to the user interface thereto. Thus, it is the desire to minimize the amount of power required to make the determination that there is a “no-touch” condition.

To determine that there is a touch one compares a current value of C_{RCF} to a prestored value representing the no-touch situation. This is referred to as the “baseline value.” The baseline value for each of the C_{RCF} capacitors in the array will be determined during a calibration operation. This calibration operation can be user initiated or it can be automatically based on time or even temperature. When the temperature of the device containing the touch screen and the chip changes, this can change the values of the capacitor C_{RCF} and, therefore, there will be some type of calibration.

As will be described herein below, there are multiple modes of operation of the chip to conserve power. One of the largest sources of power consumption on the chip is the operation of the controller core or CPU 302 and the digital circuitry associated therewith, the operation referred to as the MCU operation. When the MCU is active and executing instructions, the current draw will go up significantly. Thus, the entire chip has the ability to operate in different modes of operation to, for example, stop execution of the controller core or CPU 302, suspend operation of the system clock block 376 and even remove power from a large portion of the digital circuitry. There are defined multiple modes. One mode is the active mode which is a mode wherein the system clock block 376 is operating to generate the system clock, the controller core or CPU 302 is executing instructions and, in essence, the MCU is fully functioning. There can be multiple modes, there being an active mode, a normal mode and a low power mode. In the normal mode, everything is functioning. In the low power mode, certain select aspects of the digital circuitry can be turned off. For example, if the SMBus is not being accessed, it is not necessary to clock that peripheral. The clock generator block or system clock block 376 has a clock generator 388 that can generate the various peripheral clocks. As will be described herein below, these peripheral clocks are generated in response to a request for a clock signal thereto. The circuitry for generating the clock is not activated until such request is made.

A second mode is an idle mode. In the idle mode, the execution operation for the controller core or CPU 302 is halted but digital power is maintained thereto. The operation of the system clock can also be suspended. When the system comes out of idle mode to active mode, the CPU 302 will begin servicing the various interrupts, etc., that have requested to be serviced and the programs run that are associated with the requests. However, the digital power is maintained in the idle mode. Once digital power is removed, the CPU 302 will effectively have to boot up when the LDO portion of the regulator 364 is again brought up to power. This can take time and consume unnecessary power. Therefore, the CPU 302 in the idle mode will be in a ready condition. There is also the sleep mode wherein the digital portion is essentially powered down but portions of the chip can remain operational. Typically, the RTC or smart clock block 386, the I²C block 358 and other portions of the circuitry such as a function termed “port match” will operate. These are analog peripherals in the analog peripheral block 312. As noted herein above, the MTR module 114, the CDC 112 and the I2C block 358 are self-clocked such that they can operate outside the presence of the system clock generator block 376 or the CPU 302 in operational mode. An interrupt will “wake up” the CPU 302. Since most scans will result in a no-touch determination, it is desirable to minimize the amount of digital power that is applied to the digital portion of the circuitry. It is noted that the MTR module 114 operates in the idle mode, but not the sleep mode.

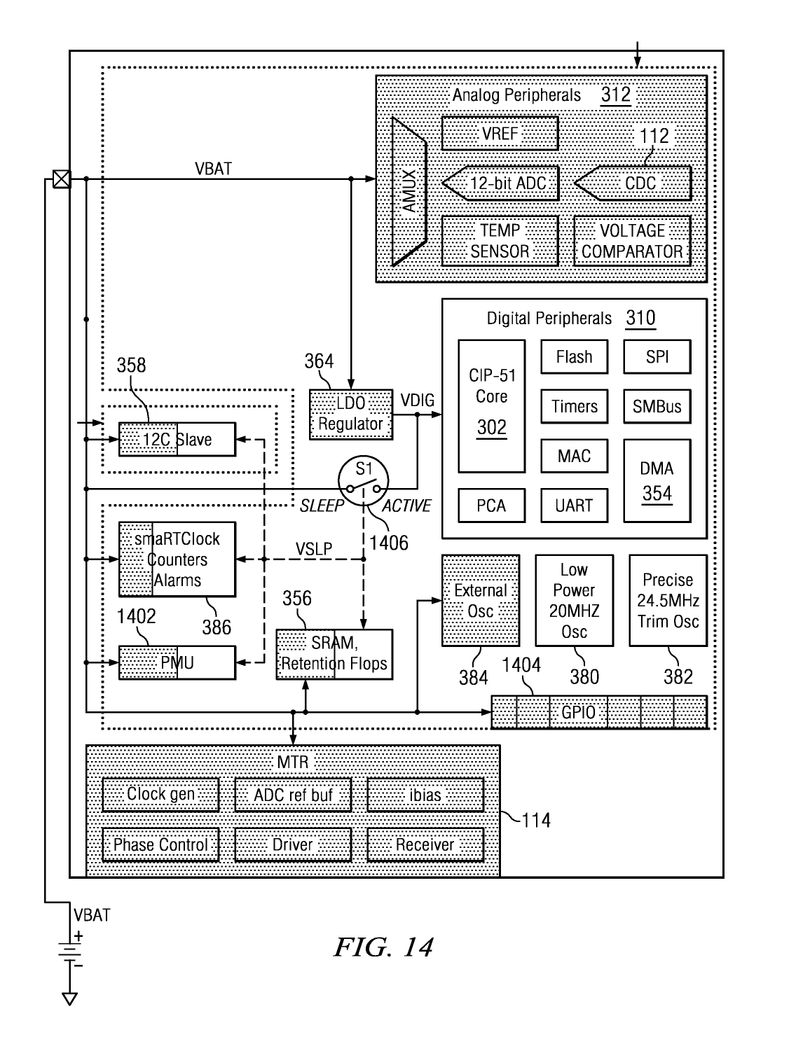

Referring now to FIG. 14, there is illustrated a diagrammatic view of the top level power domain architecture. There are essentially three different supply domains. The first is V_{BAT}, which is the battery voltage domain with a range of 1.8-3.6 V. The second is V_{DIG}, the digital voltage domain, which is the regulated supply for the digital core. This is set at approximately 1.8 V. The next is the V_{SLP} domain. This domain is not an actual supply, but denotes that the supply node switches between V_{DIG} and V_{BAT} depending on the part being in an active or a sleep mode. The portions of the circuitry that are connected to the V_{BAT} domain are illustrated in crosshatching and they constitute the analog peripheral block 312, the LDO regulator block 364, a portion of the I2C block 358, a portion of the RTC block 386, a portion of a power management unit (PMU) 1402, a portion of the XRAM 356, the MTR module 114, the external oscillator circuit 384 and a general purpose I/O block (GPIO) 1404. The digital peripheral interface block 310 (including the CPU 302, the DMA 354 and the MAC 352), the low frequency oscillator 380, and the precision oscillator 382 will be in the digital domain, i.e., that will be in the active mode. The LDO regulator 364, when in the active mode, will generate the voltage V_{DIG}. There is provided a switch 1406 that represents switching between the active and the sleep mode. In the sleep mode, the remaining portion of the voltage for the I2C block 358, RTC block 386, PMU block 1402 and memory 356 will be supplied by the battery. In the active mode, this remaining portion will be connected to the digital voltage, this circuitry allowing such things as peripherals to interface between two clock and voltage domains. This essentially comprises some of the digital circuitry in these particular blocks which will be active during sleep mode. In sleep mode, as described herein above, the LDO regulator 364 will be powered down but, as can be seen from the entire diagram, the analog peripheral block 312 and the MTR module 114 will be active. The V_{SLP} is used to prevent loss of the information inside SRAM and retention flips during sleep mode. This way the MCU can resume operation immediately without having to initialize the memory.

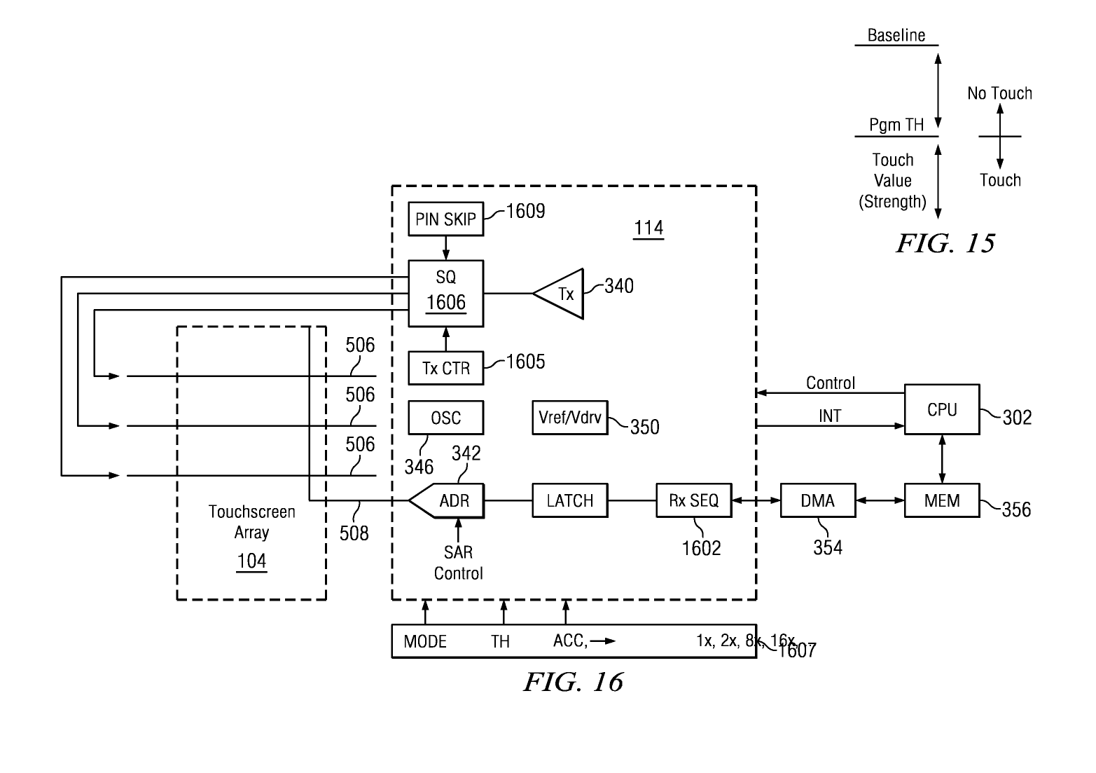

Referring now to FIG. 15, there is illustrated a diagrammatic view of the hardware MTR module 114 block and the implementation thereof in the touch/no-touch decision operation. This is a state machine. A baseline will be provided and stored in the memory 356 in a particular location for each capacitor C_{RCF} in the array or each intersection of row and column lines. Essentially, this will be the intersection of each MTR Tx output and each MTR Rx input. This baseline value will constitute the no-touch MTR Result. However, any kind of noise or small change in C_{RCF} may not constitute a touch. Therefore, a threshold is programmed into an SFR associated with the MTR module 114. This will provide a threshold relative to the baseline value beyond which a decision will be made that the change in C_{RCF} constitutes a touch. Any value of a change beyond the threshold relative to the baseline value will constitute the strength of the touch value. As will be described herein below, it is not necessary to store the actual raw data from the ADC 342 but, rather, the value of the strength after the touch determination, although there is a mode to store just raw data. Therefore, the value stored when a touch is determined will be the baseline value (BL) minus the threshold value (TH). For example, if the baseline value were equal to 1.0 and the threshold value were equal to 0.5 and the actual value were equal to 0.3, the value of 0.2 would be the strength. This is all that would be stored for processing by the CPU 302.

First the actual strength or touch value is determined and this is facilitated with a hardware circuit. This operation will constitute the scanning operation of a particular row which is referred to as a “strobe” operation. A “single strobe” is referred to as the operation wherein the row is processed through the auto zero phase, the transfer phase, and the conversion phase wherein the charge of all of the C_{RCF} capacitors associated with that row are transferred to the associated ADC circuits 342 and these will each generate a value for processing to determine if a touch occurred, this determination made for each C_{RCF}. Once a touch has occurred, the strength value is transferred to the memory 356 utilizing the DMA 354, as will be described herein below. Note that the determination of a “touch” at a particular C_{RCF} may in fact be a false “touch.” All that is determined is that the value has changed a significant enough amount to suspect a touch when the data for the entire array is evaluated.

Although a single calculation for a single transfer operation will provide a value for C_{RCF} and the charge associated therewith on the output of the associated ADC 342, it may be desirable to average the calculation over multiple charge transfer operations. This is a programmable function which is referred to as the accumulator function. This is a programmable function such that the number of accumulations for a given determination will be defined by the user. Therefore, when an accumulation mode is entered, a “single strobe” will be further defined as the result after all of the accumulations are performed. Thus, each row will be subjected to the transmit pulse falling from V_{DRV} to ground a predetermined number of accumulation times. For each accumulation operation, there will be an auto zero, a transfer and a convert phase to provide a result which will be added to a previous result. (Note that all modes are grounded before autozero.) The sum of these values will constitute the value of charge for C_{RCF}. Thus, with such a digital accumulation operation, it is possible with the setting of a particular value in an SFR to accumulate 2×, 4×, 8×, 16×, etc. without any changes to the circuitry. Of course, the higher the accumulation number, the longer the scan time for each row. (Again, it is important to note that the terms “row” and “column” are utilized herein in a sequence but it should be understood that the rows could be connected to the ADCs 342 and the MTR Tx pulses input to the columns.)

Referring now to FIG. 16, there is illustrated a simplified diagrammatic view of the MTR module 114 State Machine and the interface with the DMA 354 and the memory 356. The MTR module 114 includes a hardware controller 1602 which is operable to interface through the DMA 354 with the memory 356 and also with the output of the ADC 342 operation. This allows for a Read and/or Write operation. The hardware controller 1602 will retrieve the results, accumulate them if such is designated by a user, determine if the threshold has been exceeded and, if so, then a determination is made as to what the strength of the touch is and this stored in the memory 356. During operation, the memory 356 is accessed if necessary to either retrieve a baseline value or to store information therein. Thus, if a baseline value is required to determine if the threshold has been exceeded, a Read operation is performed. With the use of the DMA 354, it is not necessary for the CPU 302 to operate.

Once a decision is made that a touch has occurred, the strength of that touch can, in one mode, be stored in the memory 356 in a particular location and then an interrupt generated to the CPU 302. There are various interrupts that are generated, one indicating the end of a strobe (the end of all operations utilized to generate a total set of accumulated value for a given row), an interrupt for a touch determination, etc. These interrupts are merely to advise the CPU 302 that a certain operation has been completed such that the CPU 302 can initiate another operation. For example, the CPU 302 initiates a scan or strobe of a given row with an initiating control value. This control value is generated and sent to the MTR module 114. The CPU 302 can then go into an idle mode at that time and allow the MTR module 114 to go forward therefrom. The CPU determines which row will be strobed by enabling the appropriate MTR Tx signals, i.e., setting start and stop values for selecting the particular output pin for the V_{IN} signal. Once this is enabled, the MTR module 114 generates the correct V_{IN} signal at the appropriate time for the particular auto zero/transfer/conversion operation for the accumulated number of times. If it was determined that no touch was sensed, an interrupt to the CPU 302 would be generated to indicate the end of a particular row line. The CPU 302 need not access the memory 356 until an entire scan of the touch screen 104 is performed or a portion thereof in accordance with a predetermined program. Thus, the CPU 302 need only be activated at the end of a strobe to sequence to the next block in the “single strobe” scan operation or at the end of a panel scan in the “panel scanning” mode of operation. The panel scan operation can scan the MTR Tx pins automatically with a sequencer block 1606 whereas the CPU 302 initiates the next strobe in the single strobe scan operation. The sequencer block 1606 operates in conjunction with a Tx counter 1605 that increments the Tx output for each strobe. There is provided an MTR SFR that has stored therein the start and stop MTR Tx channels for a particular scan operation, in addition to other configuration information. In addition, there is provided a pin skip decoder 1609 that controls the sequencer block 1606 to skip certain pins that are not connected. This will be described herein below.

In the MTR module 114, there is illustrated the buffer 350 which is operable to define the V_{REF} value and the V_{DRV} value. These are typically the same value, but it is possible to program the V_{DRV} value for a lower voltage such as V_{REF}/2, V_{REF}/4, or V_{REF}/8. The reason for this is that, by design, the C_{RCF} capacitor is expected to be approximately 5 pF, but it could be larger. In this situation, it may be desirable to lower the value of V_{DRV}. Also, the MTR module 114 has a randomizer 1610 that randomizes the start time of the transfer operation to reduce tonal interference.

In order to minimize the amount of noise that occurs as a result of the sampling operation wherein charge is transferred from the C_{RCF} capacitor to the node 806 and on to the capacitors 808 and 810, sample time dithering is utilized. This is facilitated by randomly changing the time at which the transfer or sample time occurs. This is basically delaying the time at which the transfer operation occurs. However, it is important to note that the opening of switch 2 is tied to the operation of the transmitter. Therefore, switch 2 will be opened just prior to the transmitter changing the voltage on the transmit channel from a high voltage to a low voltage. It is important that the amount of time between switch to opening and charge being transferred be tightly controlled. Additionally, the time that switch 1 is opened is also controlled relative to the time that the transmit output voltage for the selected channel drops from high to low. All the times are relative to each other. The dithering merely changes the time at which this charge transfer occurs. This will reduce total interference which, if not reduce, could decrease sensitivity. There are two ways to achieve this sampled dithering. The first is to utilize a randomizer 1610 and introduce a delay at each sample time. This could be a positive delay or a negative delay, keeping in mind that there is a defined minimum for the autozero time. This delay could be generated for each conversion operation, keeping in mind that for a “single strobe,” there could be multiple accumulations for a given strobe operation. The delay could be maintained constant for all accumulations in the single strobe or it could be varied for different accumulation operations within a given single strobe. Since the clock generates the switch controls for all ADCs 342 at the same time, it may not be possible to individually control the conversion operation for each of the ADCs 342. However, there is also a possibility this could be implemented, although it is not described in the present embodiment. Thus, this method utilizes a random number generator disposed therein as part of the State Machine that will vary the opening of switch 804 and the opening of switch 802 relative to the charge transfer operation when the voltage on a Tx channel is pulled low by a predetermined delay.

The second method is one that is controlled by the CPU 302. In this method, a delay value is written into the MTR SFR 1607 to define the amount of delay for the sampling time for a given strobe. This technique would utilize a delay of, for example, “3” counts of the MTR clock for one single strobe operation of a given row or Tx channel and, for the next row or Tx channel, extend this by an additional 3 counts for a total of 6 counts and, for each row or Tx channel thereafter, keep extending it by an additional 3 counts. The idea is that the sampling time for each conversion operation is delayed from the previous operation and the CPU 302 can effect this because it is able to program the length of the auto zero phase.

The hardware controller or State Machine 1602 is operable to operate in multiple modes in conjunction with the ADC 342. The MTR module 114 and the hardware aspect of the MTR module 114 operate in a number of different modes. These modes allow the MTR to perform in hardware many of the scanning functions and decision operations required in order to perform a scan, make a decision as to whether there is a touch or no-touch, collect data and transfer this data to memory with little or no assistance of the CPU 302 such that the overall MCU can be in the sleep or low power mode during this time.

As to the conversion modes, there are two conversion modes provided for. The first is the single strobe which basically utilizes one transmit operation to a row and multiple receive operations. The single strobe, as noted herein above, can require multiple accumulations for a given strobe operation. However, the single strobe is initiated by the MCU and, at the end of that strobe (all accumulations), the CPU 302 is notified and the MTR module 114 awaits further instructions. The second conversion mode is the panel scan mode which involves multiple strobes. These multiple strobes are initiated at a particular start and end Tx channel defined by data loaded into the MTR SFR.

Each of the different conversion modes has data modes. This is the operation wherein data is to be transferred either to the memory through the DMA 354 or directly to the CPU 302. The first data mode is the SFR mode wherein the MCU directly reads data from a single SFR associated with the hardware controller 1606 without requiring access to the memory. A second mode is the DMA mode wherein data is dumped into the memory. This can be performed by requiring an acknowledgement signal for each transfer to the DMA or the system can operate in a DMA burst mode wherein multiple requests are sent to the DMA to transfer data for multiple channels. There is the compare mode wherein the data from the ADC 342 (raw data) is subtracted from a baseline value which is retrieved from memory via the DMA 354 and compared to a threshold voltage to determine a touch/no-touch decision. In a fourth mode, a subtract mode, the strength of a particular touch after a touch detection is determined and stored in memory via the DMA.

There are also provided a plurality of interrupts and flags that can be generated by the hardware controller. The first interrupt flag is a “conversion done” generated after each single strobe. A second flag is one for a “conversion done” after each panel scanning. A third flag is one for “less than event” during the compare mode. A fourth interrupt or flag is a “DMA timeout” flag. It is noted that the “conversion done” flag is set after the accumulation is completed.

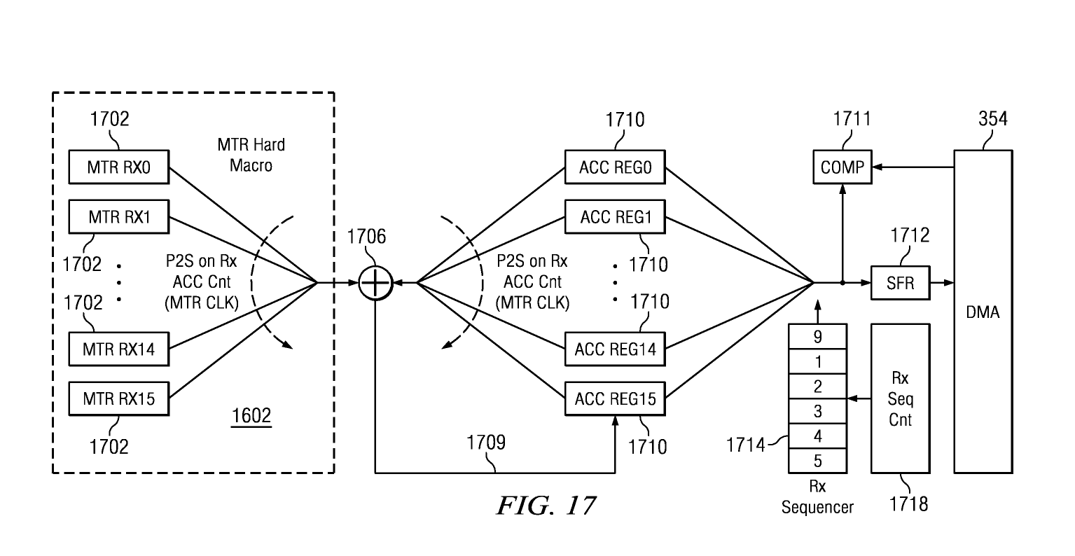

Referring now to FIG. 17, there is illustrated in more detail a diagrammatic view of the receive sequencer 1602. The receive sequencer 1602 is comprised of a plurality of MTR receive registers 1702 which are basically the latched output from the associated ADC 342 after the SAR conversion. These constitute registers wherein the value at the end of the conversion cycle is stored. (Note that another conversion operation can be initiated after storage in the register 1702.)

When the last SAR cycle in the conversion phase occurs, the value of p, the digital value corresponding to the transferred charge, will be stored in register 1702. There will be provided an accumulator counter 1703 that will sequence through each of these stored values for output to a summing block 1706. The summing block 1706 is shared and is operable to sum the output of the selected one of the stored values in the register 1702 with an accumulated value stored in an associated accumulator register 1710, one each for each of the ADCs 342. For the current embodiment described, there are sixteen ADCs 342 and, thus, sixteen receive registers 1702 and sixteen accumulator registers 1710. The summing operation is illustrated by a line 1709 which transfers the sum back to the accumulator register 1710 for each generation of a V_{IN} pulse and the auto zero/transfer/conversion operation for the predetermined number of times. The receive count accumulator clock that cycled through each of the registers 1702 will also cycle through each of the accumulator registers 1710. For each count value of the receive accumulator counter 1703 (all of which are based on the self-clocked MTR clock), the value in the accumulator register 1710 for that count will be processed, depending upon the particular data mode. The value from each accumulator register 1710 can be transferred to an SFR (Special Function Register) 1712, the output of which is interfaced with the DMA 354 to allow for direct access to the memory 356 at the appropriate location. There will also be provided a receive sequencer 1714 which is operable to determine the order of access of the accumulator registers 1710 when transferring data. This is controlled by a receive sequence counter 1718.

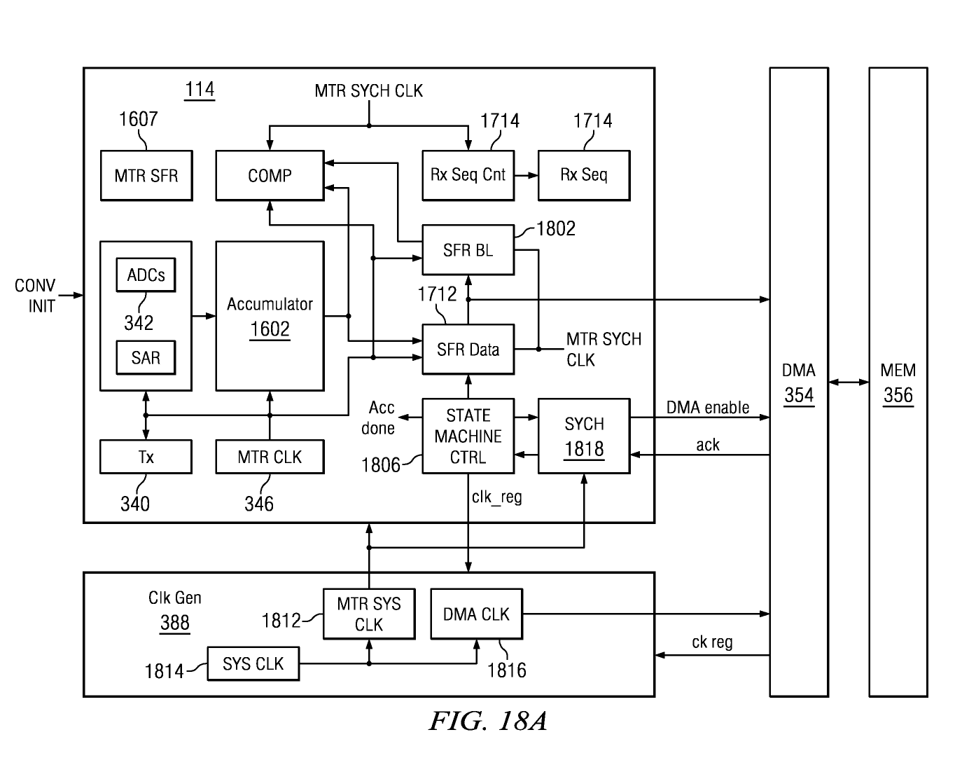

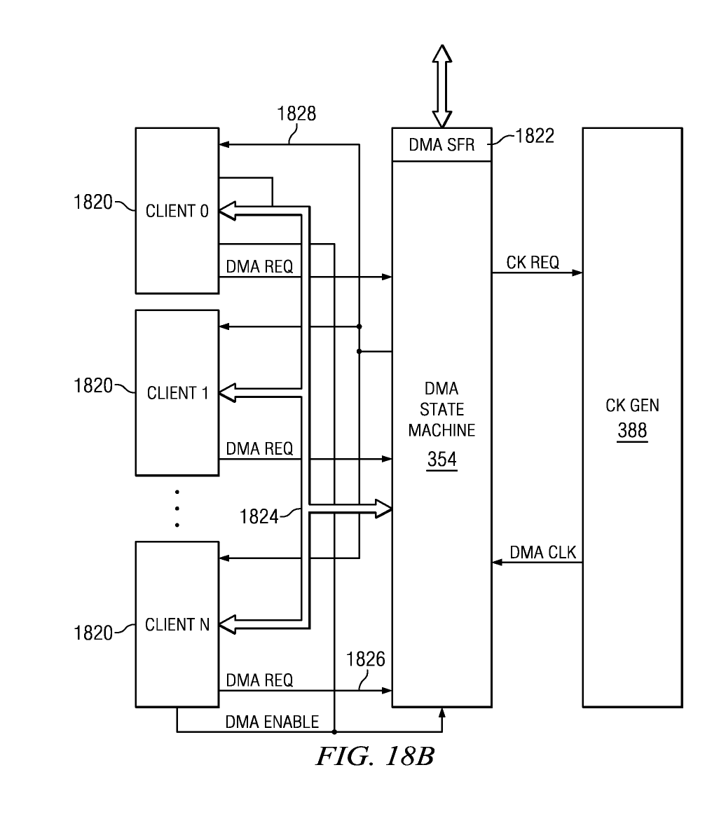

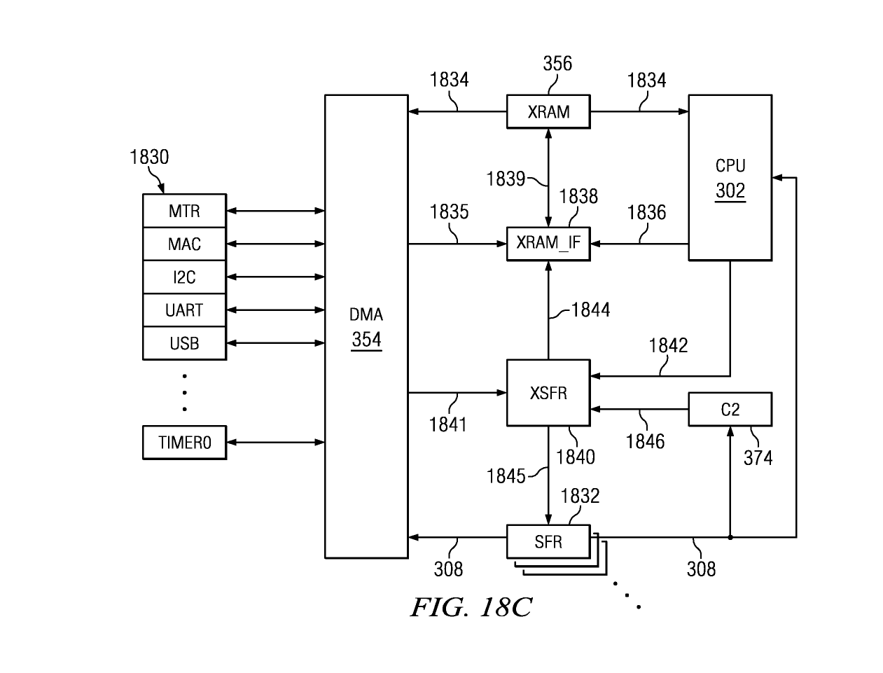

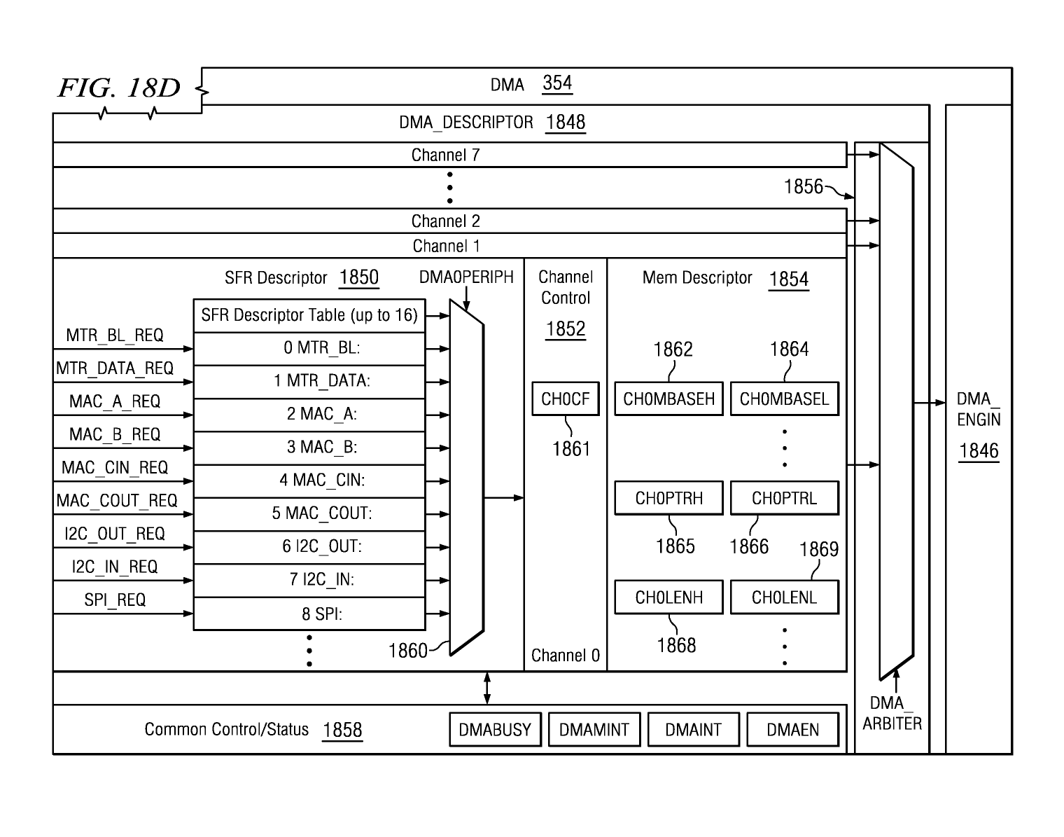

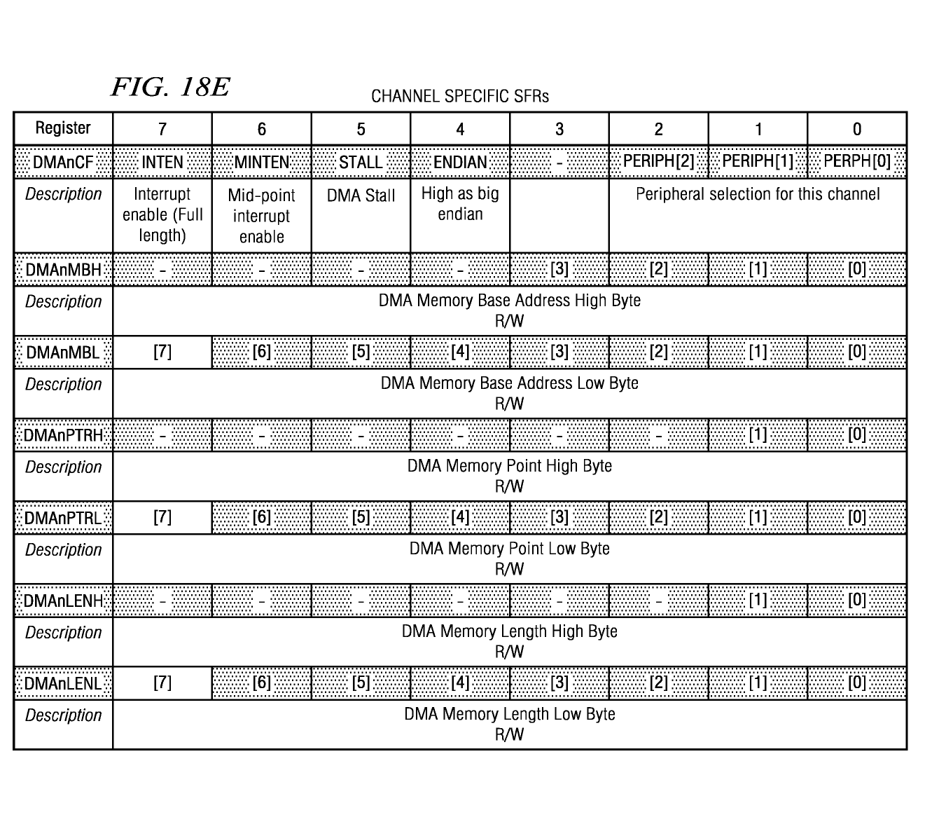

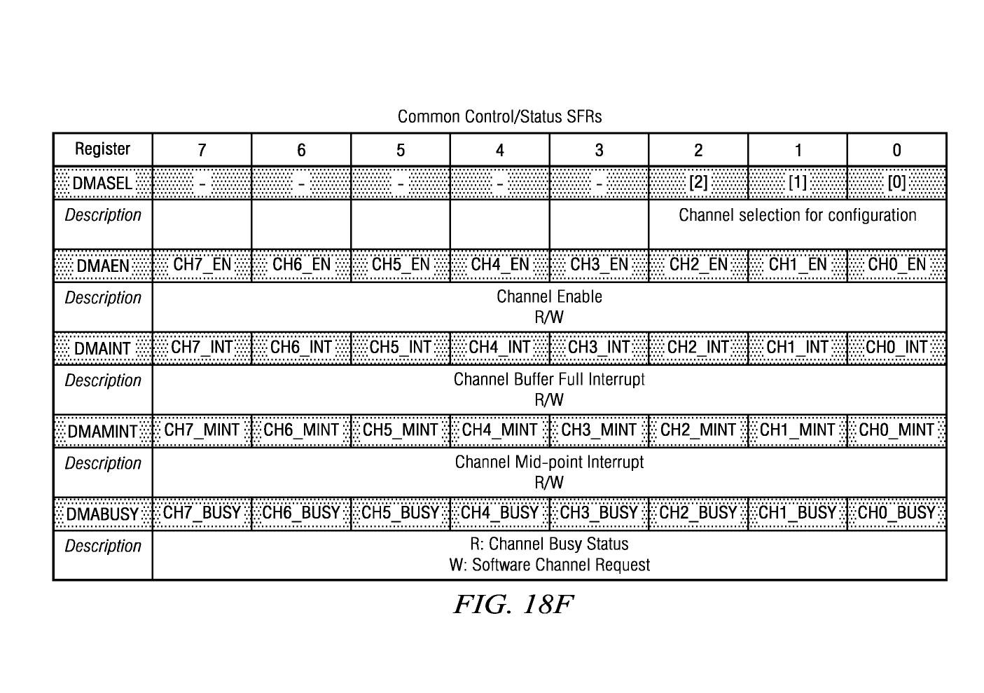

Referring now to FIGS. 18a-18f, the operation of the interaction between the peripherals which includes the MTR module 114 and the DMA 354 will be described. With specific reference to FIG. 18a, the core portion of the MTR module 114 is comprised of two portions, one portion working exclusively within the MTR clock domain and the second portion operating within the SYSCLK domain. The operation of processing receive data after a CONV INIT operates in the MTR clock domain with the ADCs 342 converting the charge on C_{RCF} to a digital value in conjunction with the SAR engine to provide an output to the hardware controller 1602. As noted herein above, the block hardware controller 1602 can operate with an accumulation of X1 up to X64 or any number. After the accumulations have been completed, then internal processing can be effected to determine if a touch has occurred, to determine the magnitude of that touch or to just transfer the accumulator results to memory. In any of these scenarios, access to the memory is effected through the DMA 354. However, in this direct data transfer operation, whether it be retrieving the baseline data or writing data to the memory, requires access to the XRAM memory 356. This operation, in this exemplary embodiment, requires everything to be synchronized with the SYSCLK output, thus, there will be an MTR clock domain and a SYSCLK clock domain. As noted herein above, data transfer is effected with SFRs. For the MTR operation, this will utilize two SFRs, one for transfer of the data from memory 356 to the MTR module 114 and one for transferring data from the MTR module 114 to the memory 356. The transfer of data from the MTR module 114 to the memory 356 is effected via the data SFR 1712. A second SFR 1802 is utilized for reading of data from the memory 356, this being the baseline data. The DMA 354 is configured via an SFR which defines the plurality of “clients” within the system. When a request is received from a particular client, the configuration data that is preloaded for the different data modes, for example, will define the initial address in memory to which to store data and the number of data transfers that will occur. Therefore, if there are 16 Rx channels and 16 Tx channels for a data storing mode for the MTR function, the DMA SFR for that operation will recognize that the start of the data transfer mode begins at the first Rx channel for the first strobe on the first Tx channel. An internal DMA counter will sequence through the addresses for each data transfer request from the State Machine controller 1806 of the MTR module 114 until no more requests are received. Of course, this requires the MTR SFR 1607 in the MTR module 114 to coordinate with the SFR in the DMA 354 via an initial set up process.

As noted, for the MTR module 114 data transfer operation, two SFRs, the SFR 1712 and the SFR 1802 will be utilized. Each of these constitutes a client to the DMA 354. Therefore, for a data transfer operation of data from SFR 1712 to memory 356, the DMA 354 recognizes the request for such data transfer as coming from the SFR 1712 client and it will respond with an operation that causes data to be transferred to the memory 356 to the appropriate address in accordance with the setup in an internal DMA SFR. That SFR 1712 is associated with one client. If the baseline data is to be transferred, the transfer operation is associated with a second “client” that will result in a Read of data from the baseline area of the memory 356 at the appropriate address for the appropriate Tx channel and Rx channel and transmit it to the SFR 1802 for the compare mode and the subtract mode, as will be described herein below.

For the data transfer operation, the SFRs 1802 and 1712 and the receive sequencer operation will operate in the SYSCLK clock domain. Thus, after the accumulation operation, operating in the MTR clock domain, all of the accumulation results will also be stored in the accumulator registers 1710 associated with each of the Rx channels. Once this is complete, a clock request is sent out to the clock generator 388 for a peripheral clock. This will turn on one peripheral clock block 1812 that is synchronized with the SYSCLK, as represented by block 1814. As noted herein above, by turning off the clocks when not needed, power savings can be effected. Additionally, even if the SYSCLK is turned off, it can actually be turned on in order to provide the synchronizing clock data. The State Machine control block 1806 will generate an enable signal for the DMA 354 in the event that the DMA is in a sleep mode. It is noted that the DMA need not be powered up and operating when data is not being transferred. DMA 354 will also send a clock request to the clock generator 388 in order to turn on a peripheral clock block 1816 to generate the peripheral clock for the DMA 354. Of course, if the DMA is operating to either service another peripheral block or in the event that the MCU is in the normal operating mode and not in the sleep mode, then there is no necessity to generate another clock request from the DMA. Further, the State Machine control block 1806 will also receive information as to whether the DMA 354 is busy with another transfer operation and, in essence, effect a hand shake therebetween. This is in the form of enable signals to the DMA 354, data requests, acknowledgments back from the DMA 354, etc. All control outputs for the State Machine 1806 will be synchronized with the edge of the system clock. As such, there will be a synchronization circuit 1818 associated with this operation, there being one block illustrated for such. This will provide an MTR synchronized clock that will control the operation of the SFRs, receive sequencer, etc.

Once the transfer operation has been effected, the receive sequencer 1714 determines the order in which the data is transferred from the accumulator 1710 to the SFR 1712 for outgoing data and the order in which data is transferred to the SFR 1802 for input to the comparator and for the subtraction mode. It should be understood that there could be provided 16 separate data transfer SFRs, one for each accumulator register 1710. However, this would require for there to be a data request associated with each SFR to the DMA 354 so that it could recognize which SFR to address, i.e., each SFR would be a client to the DMA. By utilizing a single SFR 1712 and the counter and the receive sequencer, a single multiplexed SFR 1712 is utilized. The receive sequencer is pre-loaded with the appropriate value for given Rx channels from “0” to “15.” In the default mode, these are provided in the normal sequence order. There are therefore provided 16 receive sequence register values, each associated with a particular Rx channel. There will be provided a start value for the Rx sequencer and an end value such that, for example, the sequence could be started at the Rx sequencer register “0” and terminate with the Rx sequencer register “15.” It could be that only the values in the accumulator register 1710 associated with Rx sequencer register “8” through “12” are necessary to evaluate and this would be set in the MTR SFR 1607 as the starting and stopping registers. Now, the registers in the Rx sequencer are mapped to the particular Rx channels. These could be in the sequence as set forth in the pinout portion of the chip or it could be mapped to different channels. It may be that, due to layout considerations, that the particular columns, C0, C1, C2 are mapped to Rx channels Rx5, Rx4, and Rx3. By loading these values in that order, and controlling the Rx sequencer, it is then easy to count the sequence through the count with the counter 1718. Thus, the order in which Rx pins are mapped in the MTR SFR 1607 will define the sequence of the columns as they are mapped into the memory 356. The start and stop values in the MTR SFR 1607 will define the beginning and the end of the scan and it also allows for less than all of the columns to be scanned such that a portion of the touch screen display can be scanned.

Referring now to FIG. 18b, there is illustrated a block diagram of the interaction of the DMA state machine 354 with the various peripheral blocks. The DMA state machine, as noted herein above, is a state machine that, depending upon the inputs, will service certain DMA requests, enable a system clock input and interface with the memory in order to transfer data to the memory or from the memory 356. By utilizing the DMA state machine or controller, the main CPU 302 and the high current flash can be powered down in idle mode or, in the active mode, perform other tasks uninterrupted. This allows the various peripherals to directly access the memory for the various operations associated with the panel scan operation (an operation associated with the MTR module 114). For illustrative purposes, there are illustrated a plurality of “clients” 1820, which each represent all or a portion of any of the peripherals. In general, as will be described herein below, each client represents a data SFR, which is operable to either transfer data to memory or receive data therefrom. This is associated with some type of functionality of the associated peripheral which requires that peripheral to transfer data to or from the memory. By providing an interfacing SFR, in addition to the potential lower power operation, this also facilitates better performance with high data rate throughput peripherals such as USB peripherals, SPI peripherals, UART peripherals, etc. The goal of the DMA state machine 354 is to service a request from any of the clients 1820 for either a Read of data from the memory 356 to the client SFR or from a Write of data from the client SFR to the memory. The DMA state machine 354 does not operate upon interrupts but, rather, operates upon data requests. Each of the clients 1820 are prioritized with the DMA 354, as will be described herein below, and are operable to asynchronously generate a separate data request to the DMA state machine 354. The DMA state machine 354 will then service that request in accordance with the assigned priority and transfer data from that peripheral or to that peripheral. The data request is associated with a particular SFR on the peripheral which provides a data interface to the memory via the DMA. As such, there may be a peripheral that has multiple channels associated therewith and multiple SFRs. It may be that this peripheral would be represented by multiple clients with respect to the DMA state machine 354. Thus, every client would have to generate its own DMA request in order to have that data SFR serviced by the DMA state machine 354 for either a Read or a Write operation. Typically, in a peripheral such as an I²C there will be a Read or a Write operation. For a Read operation, one SFR will be used and for a Write operation, another SFR would be utilized, each being a separate client. In this manner, the DMA could recognize the DMA request as a Read if it is coming from a specific client or a Write if it is coming from another client, even if both are on the same peripheral. All of this information is contained within a DMA SFR 1822, this being the configuration DMA SFR. This is written to or read from by the CPU via the SFR bus. It should be understood that all of the SFRs in the system communicate via the SFR bus

Each of the clients 1820 is interfaced via a representative bus 1824, which represents the SFR bus, to the DMA state machine 354. Each client has associated therewith a DMA request line 1826, there being one DMA request line 1826 for each client 1820. All of the clients 1820 receive a common DMA acknowledgement signal (dma_ack) on a line 1828. Thus, the particular state machines associated with each of the clients and the operation thereof must be logically compatible with the operation of the DMA state machine 354. The DMA enable signal on line 1828 allows the clients to send an enable signal to the DMA state machine 354 in order to ensure that the DMA is in operating mode and actively receiving the DMA clock signal from the clock generator 388. As described herein above, the DMA state machine 354 in certain modes is not required for the operation of a particular peripheral. This DMA state machine 354 at that time will power down by turning off the clock. When a client 1820 requests a DMA transfer, this will be utilized by the DMA state machine 354 to send out a clock request followed by activation of the DMA clock 1816 within the clock generator 388. As noted herein above also, all data transfer operations are conducted within the system clock domain.

Referring now to FIG. 18c, there is illustrated a diagrammatic view of the DMA state machine 354 interfacing with the memory 356 and also with the CPU 302 and with the C2 debug block 374. Each of the clients 1820 are comprised of two parts, a control portion 1830 and a SFR 1832. The control portion 1830 is illustrated as being from one of multiple specific clients such as the MTR, the MAC, the I²C, the UART, the USB or a timer. Any one of the peripherals in the system that would require interface to the XRAM 356 could be interfaced with the DMA. Further, although each peripheral is illustrated as being singularly interfaced with the DMA, it could be that there are multiple clients within a given peripheral. The SFR 1832 is illustrated separately from the control portion since it is interfaced with the SFR data bus 308. The XRAM 356 or memory 356 is interfaced to the CPU or the DMA through a data bus 1834. The DMA 354 and CPU 302 interface through respective control/address busses 1835 and 1836, respectively, with an XRAM interface 1838 which controls XRAM 356 via address control bus 1839. The DMA 354 and CPU 302 also interface with an SFR interface 1840 through respective control and address busses 1841 and 1842, respectively. The SFR interface 1840 interfaces with the XRAM interface 1838 through an address and control bus 1844 and also with the SFR 1832 via an address/control bus 1845. Additionally, the C2 block 374 interfaces with the SFR bus 308 to transfer data to the SFR 1832 or receive data therefrom and also with the SFR interface 1840 through address/control bus 1846. Thus, the overall system operation scheme wherein the CPU will have priority if it desires to interface with the XRAM 356 or the SFR bus 308 by sending appropriate bus commands to the various interfaces. The DMA 354 will be granted bus access if the CPU is not accessing the bus and, once granted, the DMA operation will typically be completed prior to the CPU again receiving a grant of access to the data busses. Thus, a data request can be received from the various control portion 1830 of the associated client 1820 which will then require the DMA state machine 354 to request access to the XRAM 356 for a Read or Write operation and, once granted, data will be transmitted from the SFR 1832 associated with the requesting client 1820 to the XRAM 356 or data transfer from the XRAM 356 to the associated SFR 1832.

Referring now to FIG. 18d, there is illustrated a more detailed view of the DMA control engine 354 illustrating how the DMA requests are handled. The DMA state machine 354 is divided into a plurality of channels, of which eight are shown in this embodiment. Each channel is uniquely associated with a particular DMA request line, i.e., with a unique client, and then will be operable, once a data request is received from that associated client, to look up an associated descriptor for that DMA request line that defines how the particular client data request is to be handled. This descriptor is then selected and associated with various memory conditions, i.e., the address of the SFR and the address of the XRAM, and then this information is all transmitted to a DMA engine 1847.

In the embodiment of FIG. 18d, there is illustrated a detail of one channel which shows how all of the descriptors associated with a particular channel are combined and selected to provide an overall DMA descriptor. The DMA descriptor is illustrated in a DMA engine 1847 which contains all of the channels. Channel 0 is illustrated in detail and this is comprised of an SFR descriptor block 1850, a channel control/status register block 1852 and a memory descriptor block 1854. All of these descriptors are combined for a particular channel in response to receiving the DMA request associated with that channel to provide an output for that channel to an arbiter block 1856. The arbiter block 1856 is operable to prioritize the operation such that a DMA engine 1847 can service the various data transfer requests from multiple channels in accordance with the priority of the channels. Typically, channel 0 will be the highest priority channel. Each of the channels is operable to be connectable to any one of the DMA request lines. In this manner, a user can configure the priority of the DMA request. For example, in one scheme, it may be that the MTR base line operation (this being a single client) could be assigned as the top priority, channel 0, and the MTR data operation (a second client) could be assigned as a second client, channel 1, followed by the I²C OUT/I²C IN operation as the third client, channel 2. Thus, any time a data request is received from the MTR base line client, this will be serviced over and above the MTR data client. An example of this will be provided herein below.

In general, the DMA descriptor includes the overall channel descriptor comprised of the SFR descriptor 1850, channel control/status register block 1852 and the memory descriptor block 1854. It also includes the control registers for that associated channel as set forth in a block 1858. It also includes an arbiter block 1856. The SFR descriptor associated with each of the data line requests for each of the channels is comprised of a 4-bit SFR selector register to select from a predefined (hard coded) list of up to 16 peripheral SFR descriptors. Each of these descriptors is comprised of an 8-bit SFR page number, an 8-bit SFR address, two additional bits provided to determine the number of bytes that have to be transferred per request, the transfer being as one byte, two bytes, four bytes or five bytes of transfer per request. There is also a 1-bit value provided for the direction, either the SFR to the XRAM or the XRAM to the SFR.

Each SFR descriptor is hard wired to a DMA request line, originating from that peripheral. The peripheral data width is either one byte for a single byte transfer, two bytes for a two byte transfer wherein the two SFR address map needs to be two byte aligned and wherein the low SFR byte locates at the lower address, a four byte width for a four byte transfer wherein the four SFR address map needs to be four byte aligned, and wherein the low SFR byte locates at the lower address and a five byte width for a five byte transfer, wherein the five SFR address map starts from 0xX2 or 0xXA with the lower SFR byte locating at the lower address. It is noted that the peripherals can each perform more complex data management therein while presenting themselves to the DMA simply as a one, two, four or five byte interface via the associated interfacing SFR. For example, if the data width of a peripheral is two bytes wide, the overall state machine operation for that particular DMA request must operate such that two one byte words are transferred from the SFR to the memory via the DMA in a single operation in order to service that request, i.e., a first byte, the lower byte, is transferred and then the second byte, the higher byte, is transferred to the appropriate section of the XRAM memory. Thus, each of the SFR descriptors would be represented as {page [3:0], addr [7,0], width[1:0], dir, dma_req}. Each of these descriptors, as described herein above, is associated with one of the data request lines. The SFR descriptor for each is output to a multiplexer 1860 which selects among the hard wired descriptors based upon a register value DMA0PERIPH which is stored in a channel configuration register 1861 for each channel, the channel configuration register for channel 0 being labeled CH0CF. The contents of this will be described herein below. This channel is writeable by the CPU during configuration or by the C2 bus to allow configuration information to be written therein for a particular channel.

Each of the channels, as described herein above, has its own configuration SFR. The memory descriptor block 1854 for each channel contains a plurality of SFRs. There is an SFR 1862 associated with the base address for the high byte and a base address for the low byte in an SFR 1864. An SFR 1865 provides the high byte for the channel pointer and an SFR 1866 provides a low byte for the channel pointer. The channel pointer defines the current address. Thus, the system is initialized with no data being written for a particular DMA request to the base memory address. This address is incremented by incrementing the pointer, at which time the next DMA request will result in data being written to that address. The length of the memory region for a particular client will be defined by two SFRs 1868 and 1869, which represent the high and low bytes, respectively, for the channel length. Thus, during operation, the memory is initiated at the base address and then the pointer incremented until the pointer is incremented to a number of address locations equal to the length of the memory. Thus, what is now input the DMA engine 1847 is the location of the SFR associated with the peripheral, whether it is a Write or Read operation, the number of bytes transferred per request and the data location in the XRAM 356. A common control/status register block 1858 provides means to allow the CPU to interface with the status of the various DMA channels and also provide control commands thereto, such as enable signals, etc. This will be described herein below with reference to each of the registers.

Referring now to FIG. 18e, there is illustrated a table of the SFR definitions for the channel specific SFRs, those associated with the channel control/status register block 1852 and those associated with the memory descriptor block 1854. The first SFR is the DMAnCF register which is the configuration register for each channel “n” such that each channel has its own configuration register. This is a register that is written to by the CPU or via the C2 interface. There are provided four bits to define the peripheral selection for a particular channel, of which three are illustrated, bits 0-3. This is the DMAnPERIPH control signal for the multiplexer 1860. This defines which of the hard wire peripheral descriptors is selected by the multiplexer 1860. As noted herein above, each of the DMA request lines is hard wired to an SFR descriptor associated with that particular data request and each is input to the multiplexer 1860. The DMAnPERIPH value will select which of these descriptors is selected. For example, an MTR Bit Line request, defined as the MTR_BL_REQ, will define the location of the SFR for that client, the width of the request, i.e., whether it is a 1, 2, 4 or 5 byte transfer per request and one bit directions, whether it is a Write or a Read operation. A bit 4 provides the Endian. This defines the order stored for multi-byte words. This can either be a big Endian or a little Endian. A big Endian is stored first which means that the first byte (lowest address) is the biggest. The little Endian indicates that the data is stored with a little end first, i.e., the first byte is smallest. This is set to high when defining it as a big Endian. Bit 5 is the stall bit which, if set, indicates a stall condition utilized in the lines arbitration scheme. This bit can be written by the CPU for a particular channel in order to stall the operation thereof. Bit 6 defines the mid point interrupt enable which, if set to a “1,” would generate or interrupt at the midpoint between the base address and the length. Bit 7, if set to a “1,” would generate an interrupt when the pointer reaches the full length of the buffer. Again, this register DMAnCF is a configuration register for a specific channel such that each channel can be individually configured to select the particular peripheral or client to apply that channel and to indicate the various interrupts and the way in which the multi-byte transfer is ordered. Again, the channels are prioritized.

There are provided two registers to define the memory base address. One for the high byte and one for the low byte. The high byte register DMAnMBH, is a 4-bit value and the low address register, DMAnMBL is an 8-bit register. The memory pointer register is comprised of two registers defining a high byte and a low byte, the high byte being a two bit value and the low byte being a full 8-bit value. These are the DMAnPTRH and DMAnPRTL registers, respectively. The length of the buffer is defined by two registers, the high byte register DMAnLENH, and the low byte register DMAnLENL. With the use of the memory descriptor registers, a linear region of the memory can be defined which consists of the 16-bit base address, the 16-bit current address offset (bytes) which is the pointer and the 16-bit length of value. The offset, as described herein above, serves as a byte counter for comparison to the length of the buffer such that the current address is equal to the base address summed with the offset. The offset is incremented by one for each byte transferred. The 16-bit length value is utilized in order to generate a DMA channel interrupt when the offset reaches the length (if the interrupt is enabled) and then disable the channel. The DMA channel midpoint interrupt is generated when the offset reaches one half the length of the buffer, it being noted that the offset is always less than the length. The 16-bit base address offset and length registers are not writeable when the DMA channel is busy.

Referring now to FIG. 18f, there is illustrated a diagrammatic view of the control/status SFRs in the common control/status block 1858. There is provided a configuration register DMASEL that contains a 3-bit value for channel selection during configuration. This is the only time that this is utilized. There is provided a DMAnEN register which is an 8-bit register for enabling the 8 channels, 1-bit for each channel. The default value for this register is a “0” and this register is a Read/Write register. There is provided a DMAnINT register to define a location wherein the interrupt can be written thereto when it occurs within a specific channel. There is provided one bit location for each channel and this is a Read/Write register. When a “1” is written to a location in this register, the associated channel thereafter will indicate the existence of a full interrupt. Thus, the CPU need only read this register to determine if an interrupt is present. To clear the bit, a “0” is written thereto. There is provided a DMAnMINT register which is an 8-bit register to define the presence of a mid point interrupt, one bit for each channel. When a “1” is written thereto by the channel, this indicates the occurrence of an interrupt on that channel. Writing a “0” to a location clears the associated bit. There is provided a DMAnBUSY register, which is an 8-bit register, showing the busy status for each channel. When written to by the MCU, this represents a software DMA request for a single transaction, i.e., when the CPU is controlling the system. Whenever a DMA request is received by either hardware or software, then a particular channel will write a “1” to this location. However, if the channel is stalled, i.e., it is inhibited from working, then a “0” exists at the DMA busy bit for that channel. A “1” represents a DMA request being present and a “not stalled” status.

Upon assembly of the information for a selected channel, the SFR page information, SFR address information, the width of the transfer, i.e., 1, 2, 4 or 5 byte transfer, the XRAM address and the Endian for a particular selected channel will be passed to the DMA engine for the data transfer operation. As noted herein above, the channels are fixed relative to each other's priority, which occurs at a transaction boundary. Once one transaction is completed, the next transaction is selected and the information for that transaction in the form of the various addresses, etc., are transferred to the DMA engine 1847 in order to interface with the arbitration interfaces to perform the various operations to transfer data from a particular SFR to XRAM or from the XRAM to a particular SFR. The DMA request from a client is only generated when dma_enabled is active. Thus, the peripheral will not generate the DMA request unless it receives an input from the DMA that it is enabled and ready to receive the DMA request. Once dma_req is asserted, it should be maintained in an asserted state until the last byte is transferred even if dma_enabled goes low. The peripheral only asserts that dma_req when it asks for a DMA data Write or DMA data Read. For a single byte transaction, such as for the I²C peripheral, the dma_req is negated when the first dma_ack occurs. For a single word transaction such as that associated with the operation of the MAC, the DMA request from that peripheral is negated when it receives a second dma_ack signal for this peripheral, since the peripheral recognizes that two bytes must be transferred. For a multi-byte transaction, the DMA request is maintained in an asserted state until it receives the appropriate number of dma_ack transactions, the last one associated with the last byte. For burst transactions, i.e., that associated with an MTR function, the DMA request for that peripheral is maintained asserted until it receives the dma_ack signal of the last byte (the 16×2 byte). Note that the clock enable for the DMA is an OR function where all of the DMA request lines are ORed together to provide a clock request output from the DMA to the clock generator.

For the interface to the peripheral from the DMA, the dma_ack signal is output from the DMA to all of the peripherals, i.e., it is a single signal broadcast. This is a one cycle pulse signal to indicate the status of each byte's transactions. The peripheral logically ANDs the dma_ack with the sfr_<reg>_rs representing the register select for that particular SFR. When the AND is active, this means that the sfr_<reg>_data has been read or written by the DMA. The DMA outputs a separate dma_enabled signal for each channel. When active, this allows a peripheral to generate a DMA request. Otherwise, an interrupt to MCU must be generated for data processing. For multi-byte transactions or burst transactions (typically associated with the MTR operation), once the DMA request is asserted, the DMA request is maintained in an asserted state until the last byte is transferred, even if the dma_enabled output goes low.

With reference to FIGS. 16, 17 and 18, the general operation, as described herein above, is an operation that is shared between the MCU 302 and the peripherals, one being the MTR module 114 for a scanning operation. With specific reference to the interaction of the MTR module 114 and the CPU, the power saving aspect of the interaction between the two involves minimizing the amount of processing by the CPU 302 and associated digital circuitry such as the clock, memory and digital peripherals, as well as the analog peripherals required to generate the necessary control signals to setup and initiate operation of the hardware aspects of the MTR module 114. After setup and scan initiation, the MCU will be placed in idle mode. In the idle mode, the MCU is at a reduced power level. Once the hardware operation of the scan is initiated, the power utilized by the MTR module 114 will be a factor in the overall power budget. Thus, utilizing the hardware aspects of the MTR module 114, the various scanning modes can be set up by the MCU and then initiated and the MTR module 114 takes over after that.

There are multiple scan modes for determining if there has been a touch and the strength of that touch. These operations involve generating a pulse and transmitting it to a specified row and sensing the output from all of the columns (noting that the transmit pulse could be input to a column and sensing effected from the rows). This operation involves some type of initiation for the “conversion” operation followed by converting the charge into a digital value, accessing memory for a Read, a Write or a Read/Write followed by generation of some type of interrupt. The initiation of conversion can be initiated by either Writing a bit to the MTR0BUSY bit of the MTR SFR 1607, an overflow of one of the timers, an output of the RTC from an internal RTC timer or some type of external trigger, noting that this will be a synchronous trigger that will be synchronized with the MTR clock. The conversion mode is either a single strobe mode requiring one Tx and multiple Rx or a panel scan mode requiring multiple strobes defined by starting and ending Tx channel.

The data modes are comprised of four modes. The first is the SFR mode wherein the MCU reads data form the SFR. The second mode is the DMA mode wherein the data is dumped into the DMA. These involve two types of modes. The first is where data is transmitted to the DMA via a request to the DMA for transfer followed by an acknowledgement from the DMA and the second is for the DMA burst mode where there is one DMA request for multiple channels. A third mode is the compare mode wherein the data is compared with the DLBL−RAW>TH. (RAW may be larger than DLBL). A fourth mode is a subtract mode (SUB mode) which requires the value of DLBL-RAW to be stored in the DMA. In the last two modes, both DMA writing and reading are required. There will be various interrupt flags generated. There are provided four different DMA flags, one for the “conversion done” after each strobe, one for the “conversion done” after each panel scanning operation, one for the “less than event” (a touch detected) during the compare mode and one for a DMA time out.

In the single strobe mode, the MCU will go into fully active mode and set up the scan by defining which type of hardware mode will be entered and various parameters of the scan such as what row line or MTR Tx pin will the scan be initiated at and the such. An initiating signal will then be sent and the MCU will go into the sleep mode. During the setup mode, the MTR module 114 will process the setup information provided by the MCU. If it is the single strobe mode, a single row will be serviced by the MTR module 114. This operation could be operating in any one of the four data modes. In the single strobe mode, an interrupt will be generated at the end of servicing each row and then the MTR module 114 will wait for the next initiating command and will select the next row unless the MCU generates additional information to start at a different row, i.e., different Tx channel. In the panel scanning operation, the initial row Tx channel number is defined and then the scanning operation will go through multiple rows until an end row Tx channel number is reached. This is controlled by the Tx counter. Therefore, all that is involved is for the MCU to store in the MTR SFR 1607 the start and end transmit channels for the scanning operation. At the end of the panel scanning operation, a “panel scan done” flag will be set as an interrupt. For the simplest panel scan, this involves nothing more than to determine if the difference between the raw data (the digital value associated with the accumulated digital charge values) and the prestored baseline value falls below a prestored threshold value, which threshold value is stored in the MTR SFR 1607. If this value falls below the threshold voltage, a flag is generated indicating that a touch has occurred and the scan operation stopped. If not, the scan continues involving only access to the memory though the DMA for a Read operation to access the baseline values for each row. This occurs after all of the accumulation operations for a given single strobe of a row. There are also two modes that are data collection modes that will occur after a touch has been detected. In these modes, only the strength of the value is collected and transferred in a Write operation to the memory. Raw data could also be transferred in the DMA data collection mode. Thus, the MTR module 114 and the receive sequencer 1602 can operate in data collection modes to either collect data for transfer directly to the MCU for processing by the CPU 302 from the SFR 1712 without the use of the DMA, it can access the DMA for processing the baseline value, it can access the DMA for downloading data thereto or it can just inform the CPU 302 of some type of action that needs to be taken. All of these operations are effected in a hardware State Machine such that the MCU can be placed in the sleep mode during such operation.

The DMA mode is a mode that transfers data to the DMA. The data is collected and, at the end of a strobe (after all accumulation operations are finished), the DMA 354 will receive a DMA request from the MTR module 114 which will cause the DMA 354 to generate a clock request to the system clock generator block 376 to generate the DMA clock. The DMA will then interface with the SFR 1712 and sequencer 1714 to transfer the contents of the accumulator registers 1710 to memory. Once the DMA 354 has transferred all the data, this operation will be complete.

The Compare mode is touch/no-touch mode. This involves the MTR module 114 to access baseline information stored in the memory. This baseline information is stored in one region of the memory such that there is one digital charge transfer value for each capacitor in the array. As described herein above, this operation is performed during a calibration operation. Thus, all that is required is to perform a memory access operation, i.e., a Read operation. There is no Write operation required. The Baseline (BL) data will be stored in a separate SFR (not shown). This will be output to the comparator 1711, all in accordance with the sequencer operation of receive sequencer 1714. The purpose of the comparator 1711, which is a shared digital comparator, is to compare the difference between the digital value from the corresponding accumulation register 1710 (raw data) and the baseline value with the threshold value to determine if it is less than the threshold value. As such, this is a “less than” comparator 1711, but it should be understood that a “greater than” comparator could be utilized. If it is a “less than” comparator, a touch condition will be declared when above the threshold and if it is a “greater than” comparator, a no-touch will be declared when above the threshold. In the described embodiment, the “less than” comparator 1711 will go high for a decision that a touch has occurred. In the event that a touch does occur for any comparison operation, the operation of the MTR module 114 will be halted and an interrupt generated to the MCU to basically take the MCU out of idle mode such that it can then initiate whatever operation is necessary to service a touch detection. This will typically result in the MCU 302 generating sufficient control and set up information to cause the MTR module 114 to enter a different mode and scan the entire panel and collect data for storage in a predetermined location in the memory. It is not necessary during a touch/no-touch detection operation to store any information in the memory, i.e., consume power to do such.

When the MCU receive an indication of a touch detection, it will then go into a mode where it will collect data. This data is collected by utilizing the subtract (SUB) mode. In the subtract mode, the actual strength value is what is transferred to the memory. This is compared to the DMA mode wherein raw data is dumped to the memory. For the subtract mode, the first step is to access the baseline data for the particular accumulation register 1710 evaluated and then subtract therefrom the raw data stored in the register. This will then be compared in the digital comparator 1711 to the threshold value stored by the user. A decision is then made to write a “0” to the memory location associated with the particular C_{RCF} if the difference between the baseline and the raw data is greater than threshold and, if it is less than threshold, then the amount that it is below the threshold, i.e., the strength value, will be stored. This is a data population mode (as is the DMA mode). Thus, the MCU will control the MTR module 114 to evaluate each row, accumulate results for each row over the number of accumulations programmed therein, store the strength values and sequence through all of the rows until the panel has been completely scanned. Also, it is possible for the MCU to select certain rows and columns to be evaluated. For example, if it were determined that the touch detection occurred at row 15 in a 32 row display, it would make sense to only collect data from row 15 and up. Additionally, it is possible through the programming of the sequencer to restrict the columns transferred to the memory in this situation where the touch detect did not occur until column 3 in a 16 column display. Again, this is a function of the scanning strategy that is programmed into the MCU.

In the panel scanning mode, the entire panel is scanned in a repetitive operation. All that is required is, after setting the mode to panel scanning, to set the start and stop Tx channels in the MTR SFR. The number of Rx channels can also be set if not all Rx channels are selected for the scan operation. This is the function of the size of the panel and the number of Tx pins and Rx pins that are utilized. After each strobe is completed, the “single strobe conversion done” flag will be set after the accumulation is completed for that strobe of a row. After the last “single strobe conversion done” flag is set, the “panel scanning conversion done” flag will be set in the same clock cycle. If, the selected mode in the panel scanning mode is to transfer data to the DMA, the timing is such that all data be logged before the next conversion operation is initiated on a time out flag may be set for such operation to ensure that the parallel conversion operation is completed before the next accumulation.

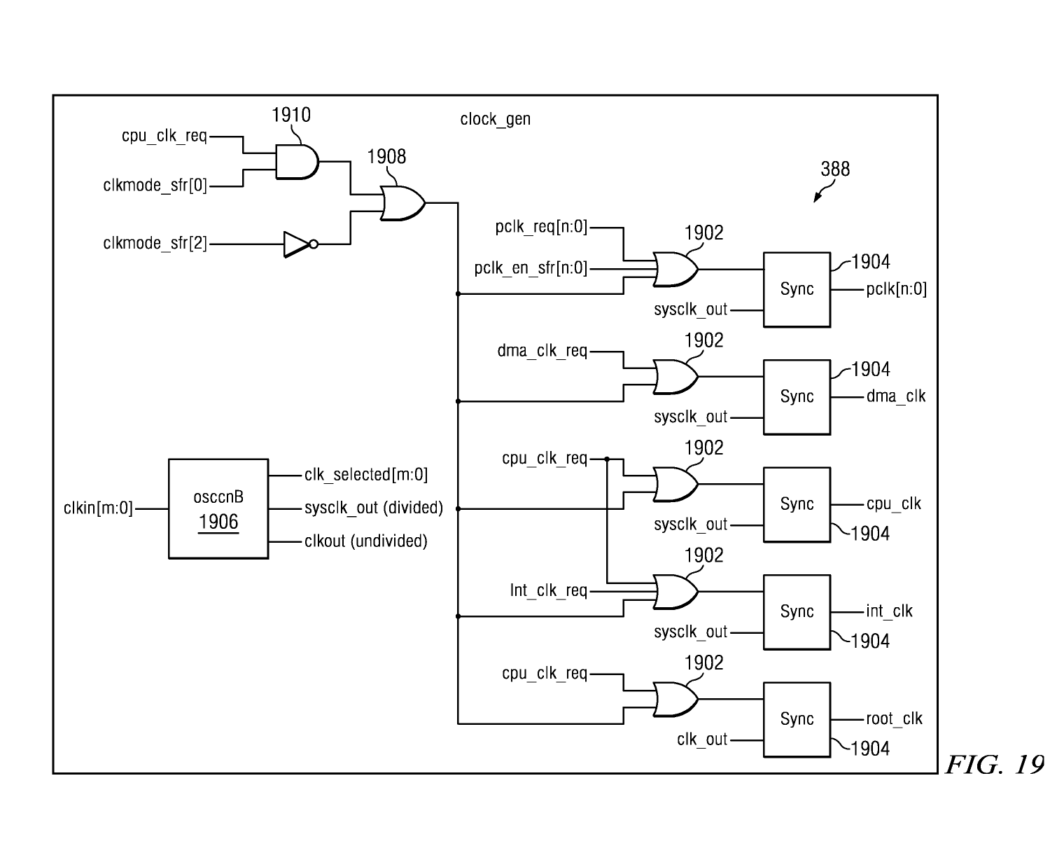

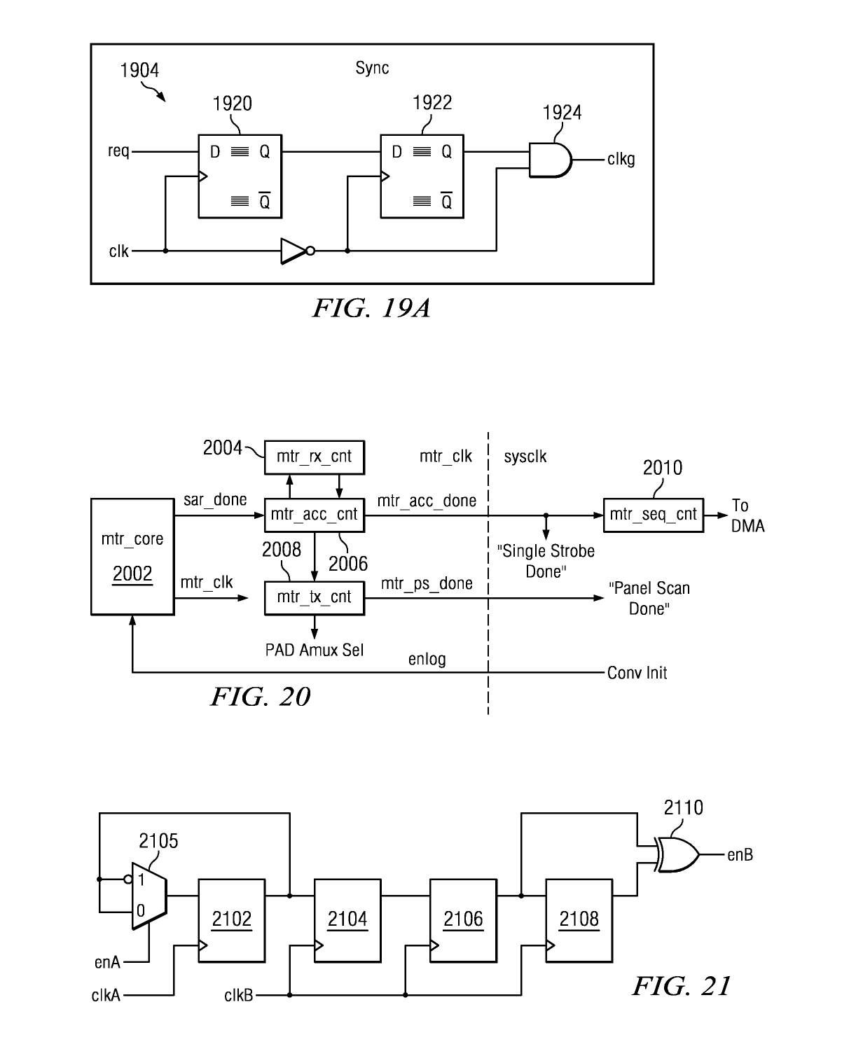

Referring now to FIG. 19, there is illustrated a block diagram of the clock generator 388. The clock generator is comprised of a plurality of multi-input OR gates 1902, each operable to receive a clock request from one of the peripherals and provide the output request to a SYNC block 1904, there being one SYNC block associated with each of the OR gates 1902. Various clock sources input to block 1906 are operable to generate various clock selected outputs, a SYSCLK output, a divided clock output and a CLKOUT output—an undivided clock output. Each of the OR gates 1902, in addition to receiving the clock request, is also operable to receive a logic output from an OR gate 1908. One input of the OR gate 1908 is connected to a bit in a clock mode (CLK MODE) SFR and the other input thereof connected to the output of an AND gate 1910. One input of AND gate 1910 is connected to a CPU clock request input and the other connected to a clock mode output from a configuration SFR. When the CPU clock request is received and the clock mode is appropriate, this will enable the output of all of the OR gates 1902. In the absence thereof, the output will be in response to a clock request.

There are illustrated five different clock requests, one for a peripheral clock, one for the DMA, one for the CPU, and another for the internal CPU clock. These will provide, respectively, a peripheral clock output, a DMA clock output, a CPU clock output, an internal clock output and a root clock output. The peripheral clock is synched with the SYSCLK, as is the DMA clock, the CPU clock and the internal clock. However, the root clock is synched with the undivided CLKOUT. The MTR is clocked with a peripheral clock block.

Referring now to FIG. 20, there is illustrated a block diagram of a basic MTR module 114 digital hierarchy. There is provided an MTR core 2002 that performs the SAR and contains the MTR clock. The MTR core provides, at the end of the SAR operation, a sar_done signal. There are provided three counters, an MTR receive counter 2004, an MTR accumulation counter 2006 and an MTR transmit sequence counter 2008. The receive (Rx) counter 2004 interfaces with the accumulation counter to input counts to each of the receive channels for the accumulation operation. Once the accumulation is complete for all of the receive channels, the MTR transmit (Tx) counter 2008 will select the next pad or Tx channel. The counters 2004-2008 and the MTR core 2002 are all in the MTR clock domain. When the MTR accumulation counter 2006 is complete, i.e., all of the accumulations are complete for one strobe, the mtr_acc_done signal is output to the SYSCLK domain. This goes to the MTR sequence counter, represented by a block 2010. This sets a flag for the single strobe done. Additionally, there is an mtr_ps_done signal output from the MTR transmit counter 2008 indicating that a panel scan has been complete, the setting of a flag “panel scan done” on the SYSCLK side. On the SYSCLK side, the conversion initiation signal will be provided as an input, this is referred to as the enlog signal, to the MTR core 2002 which will initiate the next conversion cycle, i.e., the generation of the transmit signal and the SAR conversion operation. The MTR sequence counter 2008 provides an output to the DMA and controls the transfer operation, as set forth herein above with respect to FIGS. 16 and 17.

Referring now to FIG. 21, there is illustrated a block diagram for the synchronization operation for synchronizing between two clocks, i.e., the MTR clock and the SYSCLK. A first clock, clkA is input to the clock input of a flip-flop 2102, the D-input connected thereof to the output of a multiplexer 2105, where two inputs thereof are connected to the Q-output of flip-flop 2102 with one being inverted such that a zero on the output will result on a one on the input. This is enabled with a signal enA, the input edge. The clkA signal will clock through the output of the multiplexer 2105 to the input of a second flip-flop 2104, which will be chained with two other flip-flops 2106 and 2108. Each of these is clocked with the second clock, a clkB. The output of the second flip-flop 2106 is input to one input of an exclusive OR gate 2110, the other input thereof connected to the output of the flip-flop 2108. This provides the enB edge on the output thereof.

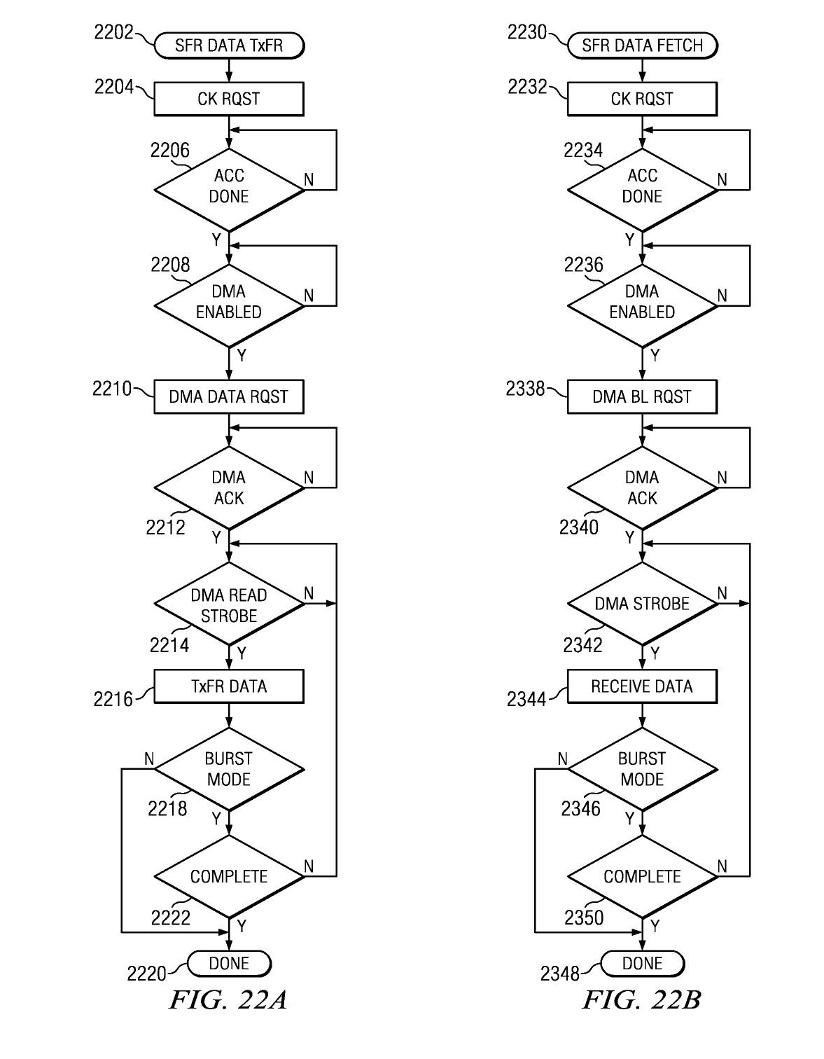

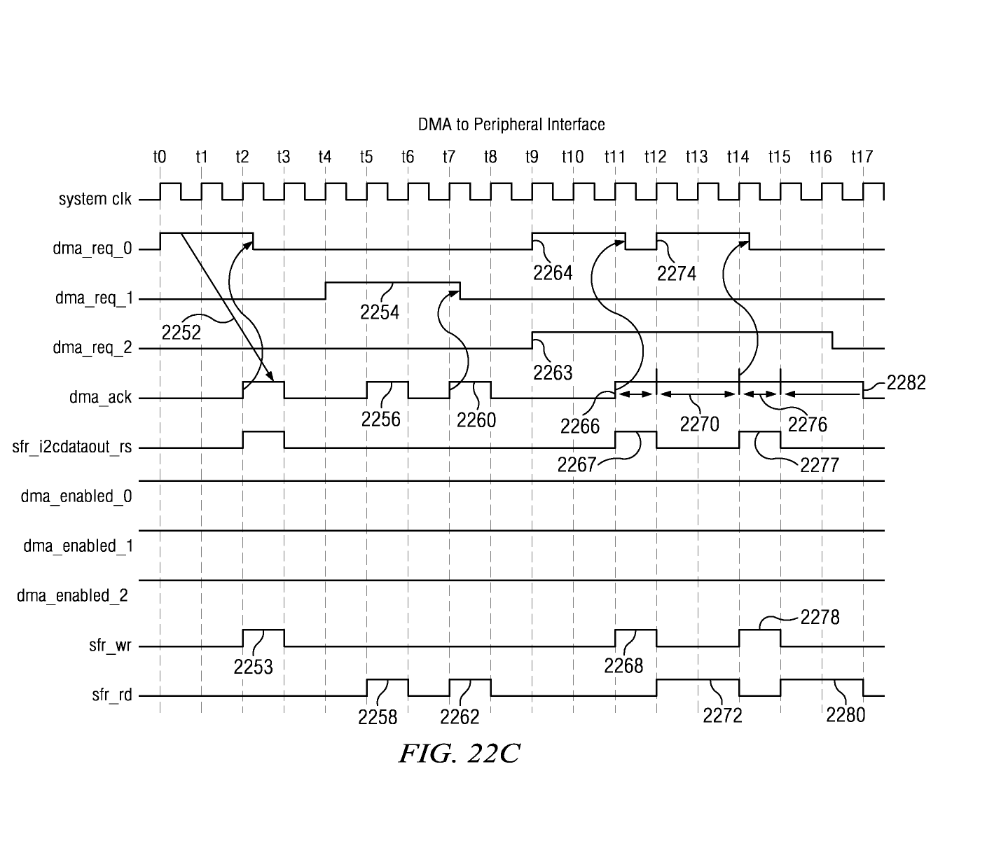

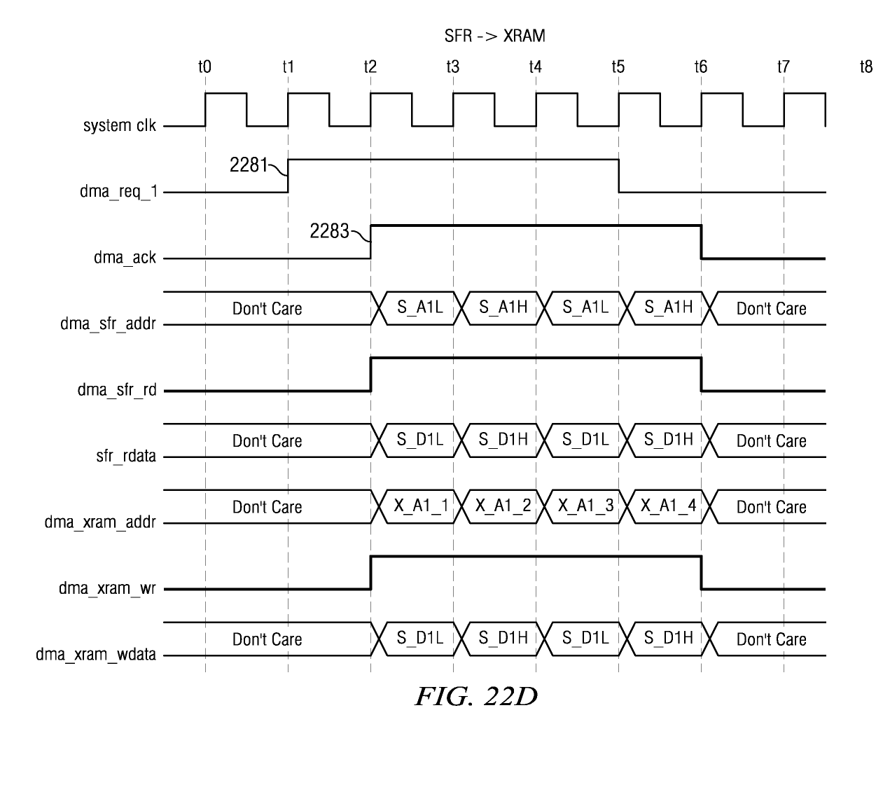

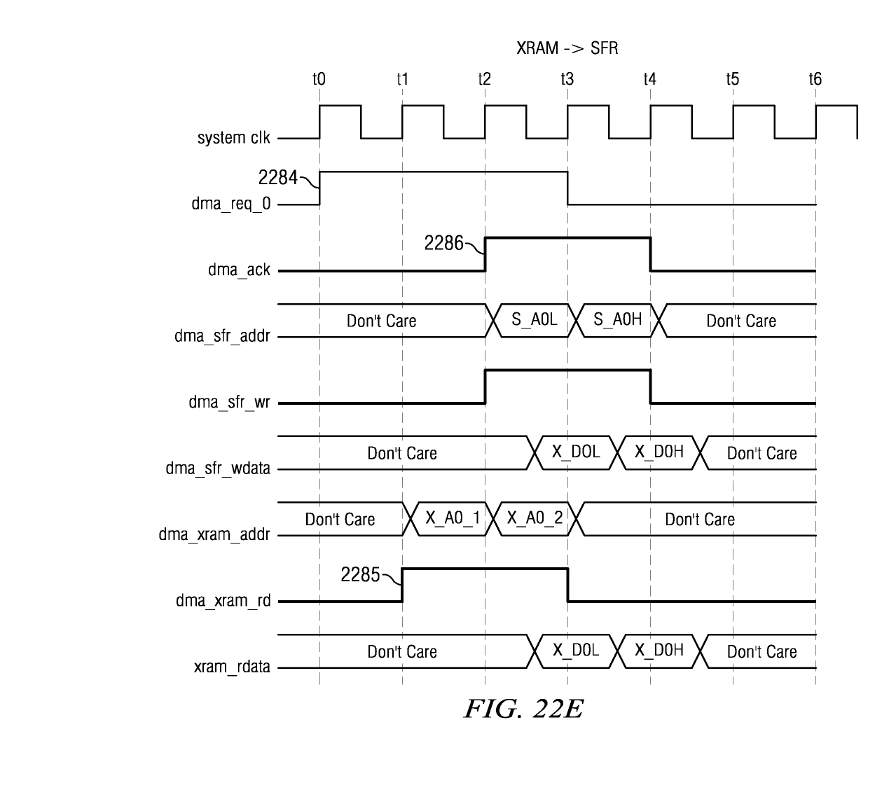

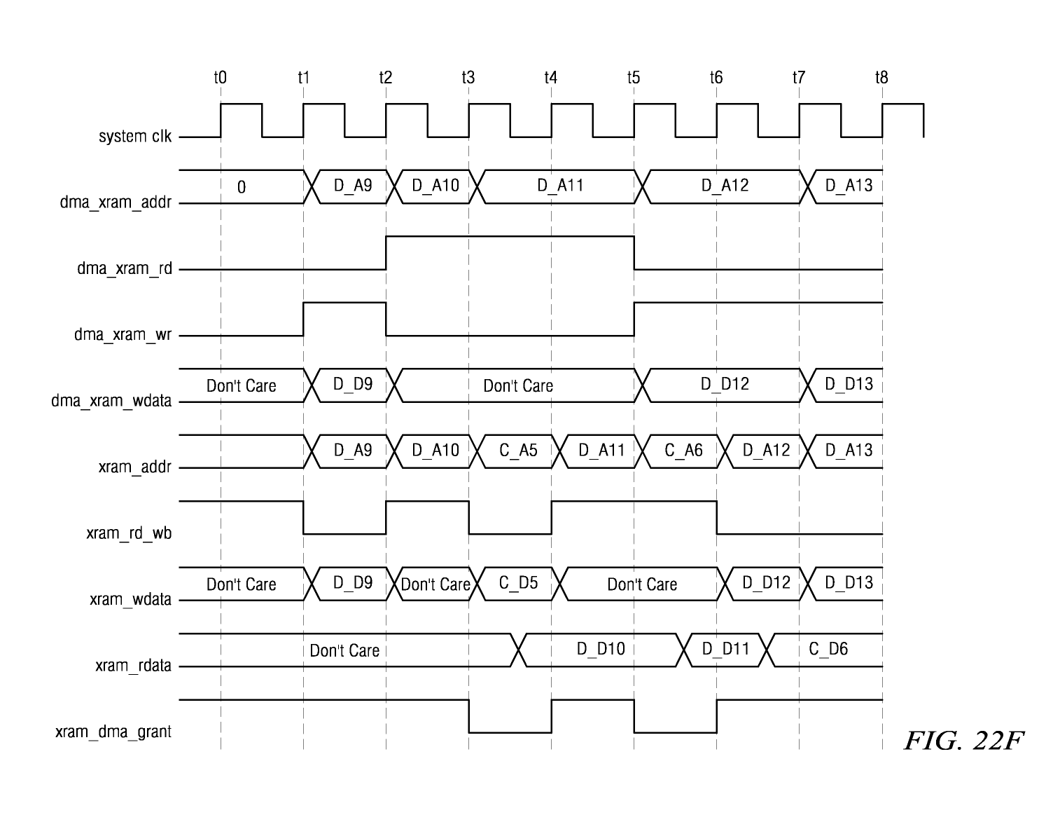

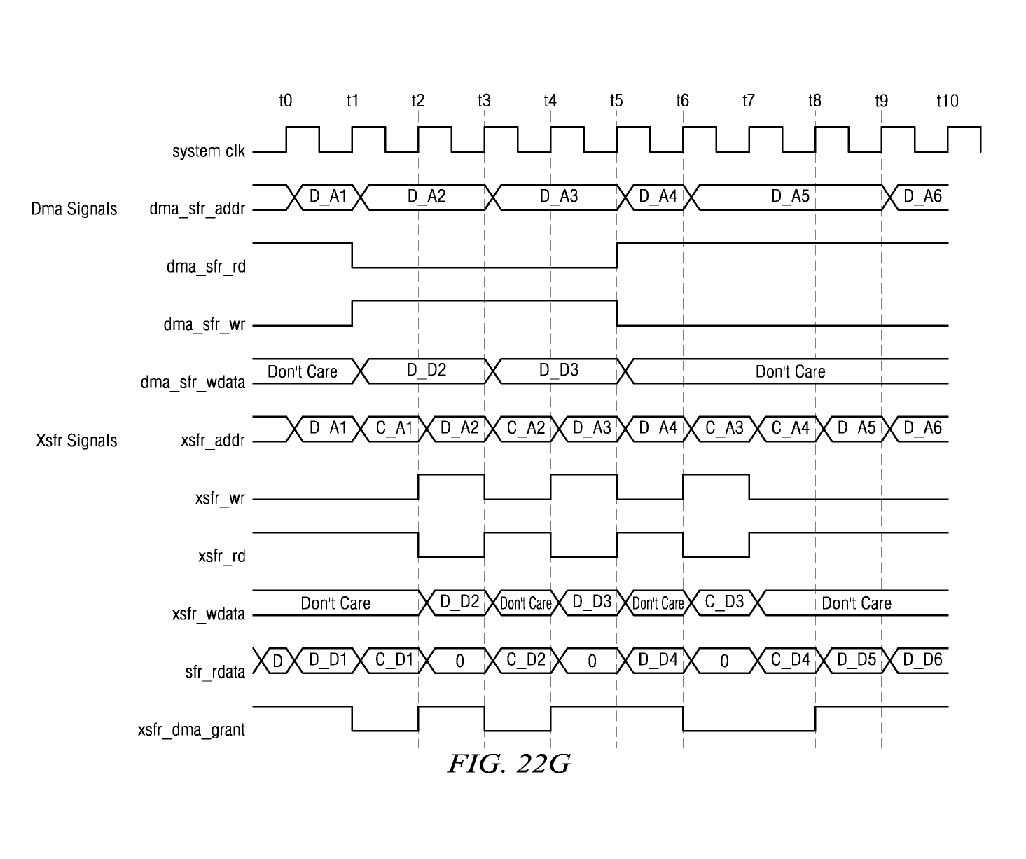

Referring now to FIGS. 22a and 22b, there are illustrated flow charts illustrating the general data transfer operation in either direction. In the first direction, associated with one client of the DMA, data is transferred to memory. This is initiated at a block 2202 and then proceeds to a block 2204 where a clock request is sent from the MTR block. This clock request can be sent before the accumulation operation is done, as the state machine recognizes this ahead of time and needs to ensure that the DMA is enabled and ready to receive a clock request in the correct amount of time, i.e., it may be that the DMA needs to request a clock and power up. The program then flows to a decision block 2206 to determine if the accumulation operation is complete. Once it is completed, the program flows to a function block 2208 to determine if the DMA is enabled. If so, the program flows to a function block 2210 to send a DMA data request. This DMA data request is performed in the SYSCLK domain (the result of the clock request being sent from the MTR block to the clock generator) and this DMA data request indicates to the DMA that this is a data request associated with the SFR 1712. There will be an acknowledgement received from the DMA, as indicated by a decision block 2212 which, when received, then awaits for a Read strobe from the DMA, as indicated by a decision block 2214. When the Read strobe is received, this begins the transfer data operation wherein data is transferred from SFR 1712 to the memory 356. An internal DMA counter, in this operation, is operable to, upon receiving the first DMA request for data to process that data. The internal DMA counter in the DMA will initially be set to a value of zero and it will increment upward from a base address. There will be defined a maximum number of operations that can be performed in response to this DMA request, depending upon the data mode. Additionally, the address for the initial count value will be set in the data memory for the particular data mode of operation in the form of a “length” of the available buffer. Thus, as the counter increments in the DMA, the address will also increment. Further, the DMA can operate in a number of different modes with respect to retrieving data. There can be a burst mode wherein the DMA will continually generate Read strobes to retrieve data. After the data has been retrieved and transferred to memory, it will generate another Read strobe until the maximum number of channels has been serviced for a particular strobe represented by the address being incremented to the last address in the buffer after which an interrupt is generated. Alternatively, the DMA can generate an acknowledgement after each read strobe indicating that it is ready for new data. In general, since the set up information is coordinated between the MTR and the DMA, each knows how many channels are to be serviced for a particular operation. The burst mode is determined at a decision block 2218 and, if the burst mode is not selected, this means the data transfer is complete after transferring of a single channel of information and then the program will flow to a Done block 2220. If it is in the burst mode, the program flows to a decision block 2222 to determine if all channels have been serviced. If not, the program will flow back to the input of the decision block 2214 to generate the next read stroke. When complete, the program flows to the Done block 2220.

Referring now to FIG. 22b, there is illustrated a flow chart for the operation of retrieving from memory, primarily to access baseline data. This is initiated at a block 2230 and then proceeds to a block 2232 to send a clock request. The program flows to a decision block 2234 to determine if the accumulation operation has been completed and then to a decision block 2236 to determine if the DMA is enabled. The program then flows to a function block 2238 to send the dmlelBl data request. This is recognized by the DMA as a Read operation and it will utilize the information in the configuration SFR to determine how many operations are required, the starting address and ending address, etc. The program then flows to a decision block 24340 to determine if a DMA ACK has been received. When received, the program flows to a decision block 2442 in order to generate the DMA read strobe, this being a strobe indicating that data is being read from memory to the SFR in the MTR. When the DMA strobe is complete, data is received, as indicated by a block 2444. The program then flows to decision block 2446 to determine if the burst mode is present which requires DMA to continually fetch data from the next sequential location and output this data. If not, the program terminates at a block 2448. When continuous data is transmitted, the program will flow along a path to a decision block 2450 to continue sending data until complete, at which time it terminates.

Referring now to FIG. 22c, there is illustrated a timing diagram for an interface protocol wherein there are provided three DMA requests from three peripherals. The first peripheral is associated with the I²C peripheral which is a single byte transfer operation, the second DMA request is associated with the MAC transaction requiring a single word, i.e., high and low bytes, and the third DMA request is associated with a multi-byte transaction, as would be associated with a MAC operation. This third operation is one where the width is defined as 1, 2, 4 or 5 bytes in width. As illustrated, this is also a two byte transaction. As noted herein above, all of the transactions in the DMA are synchronized with the system clock. The first DMA request, dma_req_0, is associated with channel 0 and is initiated when this signal goes high and it takes approximately two cycles for the data transfer operation to begin at which time dma_ack goes high. This is represented with an arrow 2252. The register select is generated when the data DMA_ack goes high, this being the sfr_i2cdataout_rs. This is associated with a Write operation of the SFR, this being indicated by a Write signal 2253. When dma_ack goes high, and since this is a single byte transaction, dma_req_0 will be pulled low. This particular channel will remain in a busy state until dma_ack goes low and the remaining peripherals will be aware of such. A second DMA request is generated, dma_req_1, for channel one, as indicated by a DMA request 2254. This is a single word transfer requiring a high and a low byte. This is a Read operation, noting that the Read operation is defined by the particular SFR descriptor for that DMA request. This will result in a first dma_ack 2256 going high resulting in a first Read operation 2258 of the SFR. At the end of this transaction, which only takes one cycle, a second transaction is initiated, which is indicated by a second dma_ack 2260. This corresponds to a second DMA Read to the SFR signal or operation 2262. When the dma_ack goes high, this will cause the dma_req_1 to go low, since this was a two byte transfer operation.

Since the DMA request associated with the Write signal or operation 2253 for the single byte transfer and the Read signal or operations 2258 and 2262 for the single word operation were separate in time, there was no contention, i.e., priority was not an issue. There is illustrated a third DMA request, dma_req_2 that occurs at an edge 2263 which coincides with the presence of a dma_req_0 DMA request at an edge 2264, i.e., at the same time. Since channel 0 has priority over channel 2, this will be serviced first. The timing for this will occur when dma_ack goes low at an edge 2266. This dma_ack is for a single byte transaction and will remain high for one cycle resulting in a register select 2267 for the I²C peripheral on channel 0, a one byte transaction. This will result in a Write operation 2268 on sfr_wr. At the beginning of the dma_ack, the rising edge will cause dma_req_0 to go low, deasserting the DMA request. When this occurs, channel 2 associated with the MAC and the two-byte transaction will result in processing of the SFR descriptor for that channel. This will result in reads of two bytes as indicated by a Read operation 2272, this being a two-byte transaction. However, a second dma_req_0 request is received from channel 0 at an edge 2274 such that after the first transfer operation of two bytes, i.e., one word, the DMA will be enabled for that channel in order to service the channel 0, over a range 2276. At the beginning of this range, indicating the beginning of the portion of the dma_ack associated with channel 0, the dma_req_0 request will be pulled low. This will result in a register select operation 2277 and a Read operation 2278 for channel 0. At the end of that transaction, since dma_req_2 is still high, requiring a second transfer operation represented by two bytes being transferred in a read operation 2280. At the end of the last transfer, the DMA engine recognizing that four bytes were to be transferred, dma_ack goes low at an edge 2282.

As such, there is provided a single dma_ack for all peripherals and this is a one cycle pulse generator for every byte that is transferred. This dma_req should be negated during the same cycle of the dma_ack for the last byte transfer. In the example above, channel 0 was a single byte transfer with the highest priority, channel 1 was a single word, two bytes, which is read by the DMA and channel 2 was associated with two bytes with the lowest priority which is read by the DMA. By utilizing the DMA requests from the peripherals, no interrupt is required in order to interrupt the operation thereof. The DMA engine merely services the highest priority one of the data requests with the various descriptor, transfers the appropriate data between the memory and the appropriate SFR and at the end of that transaction, services the next priority data request such that transfer can be maintained in an orderly manner.

Referring back to FIG. 18c, the DMA 354 via the DMA engine 1847, will provide an XRAM address output, an XRAM Read output command for a Read operation, an XRAM Write output command for a Write operation and an XRAM Write data output to the DMA. Inputs to the DMA are a Read data and a grant. The grant indicates that the XRAM bus is granted to the DMA when there is no CPU activities on the XRAM interface 1838. With reference to the interface with the XSFR 1840, the DMA provides an output as the SFR address, the SFR Read command, the SFR Write command and the SFR Write data command. The inputs are the Read data and the bus grant. The DMA engine will also output the SFR page to indicate the page location for the particular SFR. Relative to the interface to the CPU, the DMA will output an interrupt. With reference to the interface to the clock controller, the DMA engine will output a dma_clk_req which is asserted upon a DMA data request from any of the clients and negated when the DMA is idle. Therefore, whenever a peripheral desires to transfer data or read transferred data between an SFR and the XRAM, the DMA request is asserted. From the peripheral viewpoint, it merely waits until it receives a dma_ack to indicate that the transaction has begun and it will not deassert the DMA request until it receives a signal from the DMA that the transaction has been completed.

Referring now to FIG. 22d, there is illustrated the timing protocol for transfer from the SFR to XRAM. Again, the timing is all within the system clock timing domain. In this example, there is a DMA request, dma_req_1, received from channel 1. This is asserted at an edge, t1, 2281. Since this is an SFR transfer, the SFR address must be asserted, which is done by the SFR when the dma_ack goes high at an edge 2283. This is a multi-byte transaction, so sequential SFR addresses for low and high bytes are generated, there being four SFR addresses generated. The dma_sfr_rd output goes high at time t2 along with edge 2283 to initiate the SFR read operation. The address will read the data out as the low and high bytes for two data words and, at the same time, the dma_xram_addr output will provide the addresses for the XRAM, these having been defined in the memory descriptor portion of the channel. This will provide four sequential address locations. Synchronous with edge 2283 at time t2, there will be a Write operation initiated by the command dma_xram_wr followed by the data transfer from the SFR. This will be transferred to the four sequential addressed locations in the XRAM. This will constitute a sequential transfer of four bytes of data from the SFR to the XRAM.

Referring now to FIG. 22e, there is illustrated a timing protocol for the transfer of data from the XRAM to the SFR. A DMA request, dma_req_0 is initiated at time t0 at an edge 2284 and, one cycle thereafter, the dma_xram_rd signal will go high at an edge 2285. The dma_xram_addr output will provide the address of two sequential address locations, beginning at the pointer, from which to Read two bytes of data. After the first byte is read, the dma_ack command goes high at an edge 2286 and at the same time, the dma_sfr_wr output command goes high for a Write operation along with the address of the SFR locations to which the low and high bytes are to be stored. The data is then transferred as the dma_sfr_wdata which is slightly delayed in time and will be at the same time that the XRAM data is Read out on XRAM_rdata. Thus, the data is read out from the XRAM in accordance with the dma_xram_rd signal and written to the SFR. This is a one word transaction for a low and a high byte.

For the interface arbitration to the XRAM, access is controlled such that for the CPU, the maximum access rate is one access for every three cycles. This controls the DMA access also. Essentially, the DMA can park on the XRAM bus but the CPU will take the bus for one cycle for a Read and Write operation when there is CPU activity on the bus. The CPU is not allowed to stall due to the DMA operating; rather, the CPU can access the data and cause the DMA operation to stall while writing a bit to a particular DMA channel.

Referring now to FIG. 22f, there is illustrated a timing protocol for the XRAM interface 1838. Initially, the xram_dma_grant grants access to the DMA. During this time, the DMA will generate an XRAM address and an XRAM Read command or a Write command. During the Write command, an XRAM address D_A9 is generate and the XRAM data written thereto is the data D_D9. At the end of the dma_xram_wr signal at time t2, an XRAM Read is initiated with dma_xram_rd. The XRAM addresses for this will be D_A10, D_A11, D_A12 and D_A13. The XRAM address is generated to the XRAM at the xram_addr, the output of the interface 1838. There will also be a Read signal generated by the interface 1838 by pulling the xram_rd_wb signal low indicating a read operation. The data D_D9 is then output to the XRAM. When the dma_xram_rd signal goes high at time t2, this indicates a Read operation. At this time, the xram_rd_wb signal goes high indicating a Read operation and the Read address D_A10 is output to the XRAM on XRAM_addr. However, at time t3, the DMA grant line goes low indicating that the DMA is stalled and the bus is granted to the CPU. The address is received from the CPU as C_A5 and the data is C_D5 to be written to the XRAM. When the grant goes high, the operation continues and the system processes the DMA XRAM address D_A11 and the Read data D_D10. It can be seen that a second CPU access again stalls the operation at time t5 wherein the grant line is pulled low. For this operation, it is a Read operation by the CPU which will read data and this data will be output after D_D11 as data C_D6.

Referring now to FIG. 22g, there is illustrated a timing diagram for the SFR interface arbitration controlled by the SFR interface 1840. For this operation, access is granted to either the CPU, C2 or the DMA. Again, the CPU or C2 takes over the bus for one cycle for a Read or Write operation when there is such activity. It can be seen in this example that initially, between t0 and t1, the DMA grant signal is high allowing a DMA SFR Read operation. This will result in the DMA outputting an SFR Read command and a Read address of D_A1. The XSFR block will then output the address D_A1 and the data D_D1 will be output on the data line to the SFR. However, at time t1, the grant line goes low, granting the CPU access. The CPU at this point is doing a Read operation such that the Read output from the XSFR block will be high and the CPU address C_A1 will be output and the data C_D1 will be output on the SFR data bus. At this time, the grant goes back high to grant the DMA access to the bus. A Write operation was output by the DMA at time t1. However, the DMA was stalled for the CPU operation until time t2 when the grant went back high. At this time, the XSFR will output a Write command to the SFR and data D_D2 will be output on the XSFR_data, corresponding to the data output by the DMA. However, the DMA will output the data at time t1 but it will be stalled and be maintained there until time t2 when it can be written to the SFR. It can be seen that the CPU again at time t3 accesses the bus for one cycle and at times t6 and t7 accesses the bus, with a Write at time t6 and a Read at time t7. The corresponding addresses are output and the data either written to or read from the SFR.

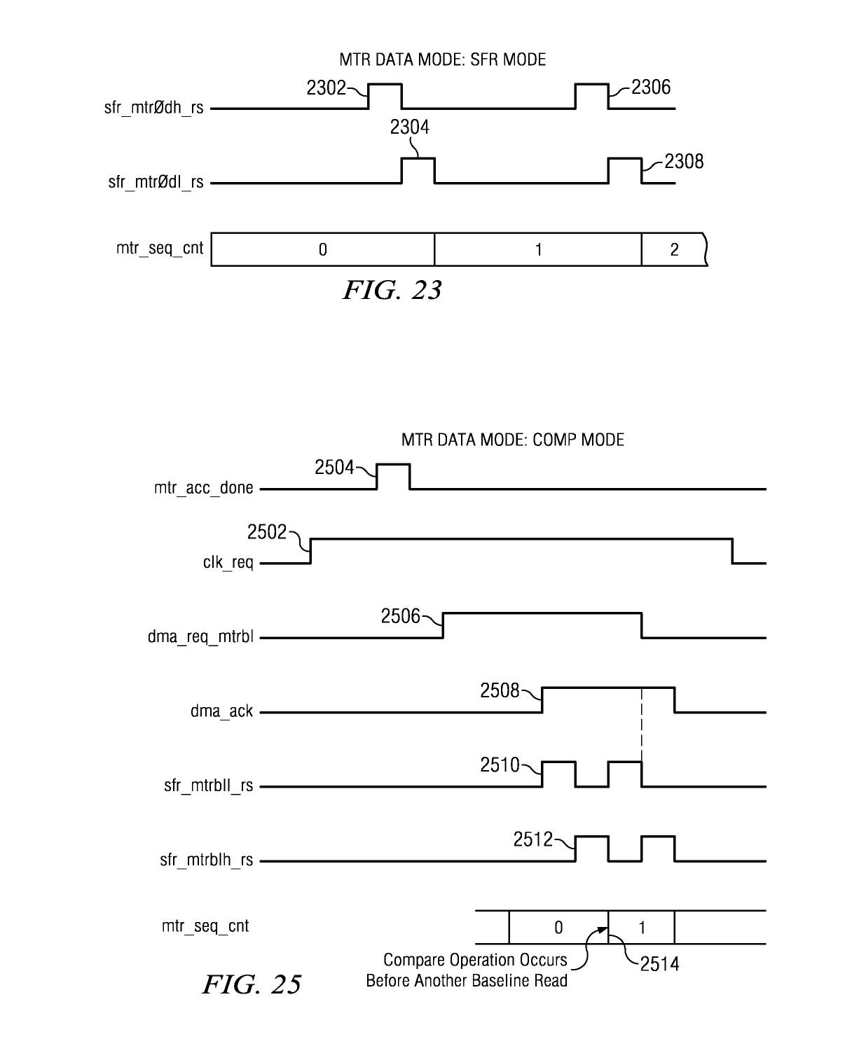

Referring now to FIGS. 23-26, the timing diagrams for the various storage modes of transferring data between the MTR block and memory or directly to the CPU. Referring specifically to FIG. 23, there is illustrated the MTR data mode referred to as the “SFR mode.” In this mode, after the “conversion done” flag is set for the “single strobe,” the CPU in this mode can then read data directly from the SFR 1712. Although the SFR 1712 is depicted as a single SFR, it is actually two SFRs, one for the high data byte and one for the low data byte. These are referred to as MTR0DH and MTR0DL. The MTR sequence counter will begin at a value of “0” and then sequence up. It should be understood that the count could begin at other than the “0” count. This is a sequencer value and not necessarily the channel value. The channel value depends upon how the channels were loaded and in what order within the receive sequencer. The sequence counter is set at the end of the end of the data transfer operation. Data transfer is facilitated with a Read strobe for the DH data byte with a strobe 2302. This is followed by a strobe 2304 for the low byte. The sequence counter is then incremented at the end of this data transfer and then another Read strobe 2306 for the data high byte is generated followed by a Read strobe 2308 with the low data byte. Each of these Read strobes indicates the operation wherein the CPU is reading the contents of the MTR0DH or MTR0DL, the low and high data bytes. The CPU is aware of, for a particular strobe, how many receive channels are present and, thus, how many counts the receive sequencer counter will count through.

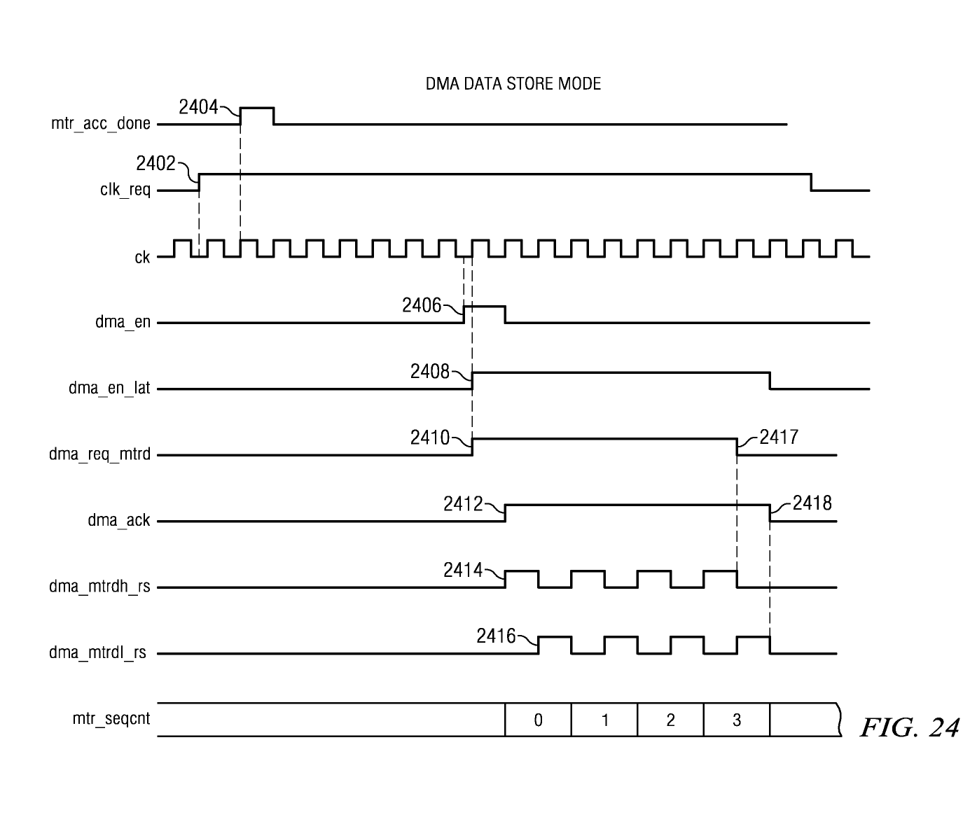

Referring now to FIG. 24, there is illustrated a timing diagram for the DMA data store mode. In this mode, raw data is stored in memory. Therefore, for a single strobe, the DMA will receive a data request and then generate Read strobes upon each increment of the MTR sequence counter. Initially, the accumulator operation will run based upon the MTR clock and no data transfer is required until the accumulation operation is done. Thus, the DMA need not be powered up or receive a clock signal. Neither does the MTR need to be synched up to the system clock. However, toward the end of the accumulate operation, it is necessary to generate a clock request at an edge 2402, which is not synchronized with the system clock. This is in order to generate the mtr_acc_done signal indicating that the accumulation operation is done, as this signal is in the SYSCLK domain. Thus, the mtr_acc_done signal is generated at an edge 2404 after the clock request at the edge 2402. This signal, once being generated, is followed by a DMA enable signal at an edge 2406, which is also not synchronized with the SYSCLK. This allows the DMA, if not operating and not being clocked by a system clock, to send out a clock request and go to a fully operational mode. The DMA enable signal is then latched on the next rising edge of the system clock at an edge 2408. At the same time, a DMA request for data is sent out at an edge 2410 to the DMA. This request indicates to the DMA that data is now being transferred for MTR0DH and MTR0DL, these being two SFRs which have an address known to the DMA when receiving such request. This request indicates the “client” which is requesting data transfer. After the DMA has recognized this request, it will raise a dma_ack line high at an edge 2412. Immediately thereafter, the Read strobes for the DH and DL Read operations will be generated, one for each of the MTR0DH and MTR0DL SFRs. The MTR sequence counter will initiate at the initial value (“0” in this illustration) and then it will increment to the next count. For each increment of the Rx sequence counter, the DMA will generate the next set of strobes to transfer the next Rx channel. For each of these operations, it is necessary for the Rx sequencer to increment to the next Rx channel and transfer data into MTR0DL and MTR0DH. This will continue until the DMA request line is pulled low at an edge 2417. This will indicate to the DMA that this is the last data transfer operation. At the end of the next Read strobe, the dma_ack signal is pulled low at an edge 2418. Again, this is for a “single strobe” such that for each initiation of a single strobe, the raw data can be transferred directly to memory. The reason for this data store mode is to allow the CPU to process the data and not utilize the various hardware features of the State Machine associated with the MTR to make such decisions. Note that this can allow all averaging and the such for the raw data to be done at the CPU such that the accumulator actually need not be used at no more than the X11X value.

Referring now to FIG. 25, there is illustrated the MTR data mode for the comparison mode. In this mode, as described herein above, the comparator 1711 requires the baseline data to be retrieved from memory. As also noted herein above, this baseline data is data that was taken by the MTR block in a calibration mode. Typically, if the accumulation value is X64 for the normal operating mode, it will be the same for the calibration mode. This is stored in a separate area of memory. For this operation, a Read is required. Again, the first operation is to generate a clock request at an edge 2502, this being synched to the MTR clock. This is followed by generation of the mtr_acc_done signal at an edge 2504 in a SYSCLK domain and then send out a data request at an edge 2506. It should be understood that the enable signals and the such, set forth in FIG. 24, will be required here but are not shown for simplicity. After the data request is sent, this will be followed by a dma_ack signal at an edge 2508. This will be held high for two bytes for baseline information of a particular RX channel to be read. The compare operation will perform between the baseline and the MTR accumulator results. For each state of the counter, there will be a first Read strobe generated at an edge 2510 for the BL low data byte and then a Read strobe generated at an edge 2512 for the BL high data. It is noted that in these diagrams, the sequence of whether the low or high byte is read first is arbitrary, it typically being desired to retrieve the low byte first. At the end of the counter, at an edge 2514, the next Read strobe for the BL low byte will be received. At this edge, the DMA will recognize that the next dataBL data byte needs to be retrieved from memory and it will retrieve such in order to transfer this data to the MTR.

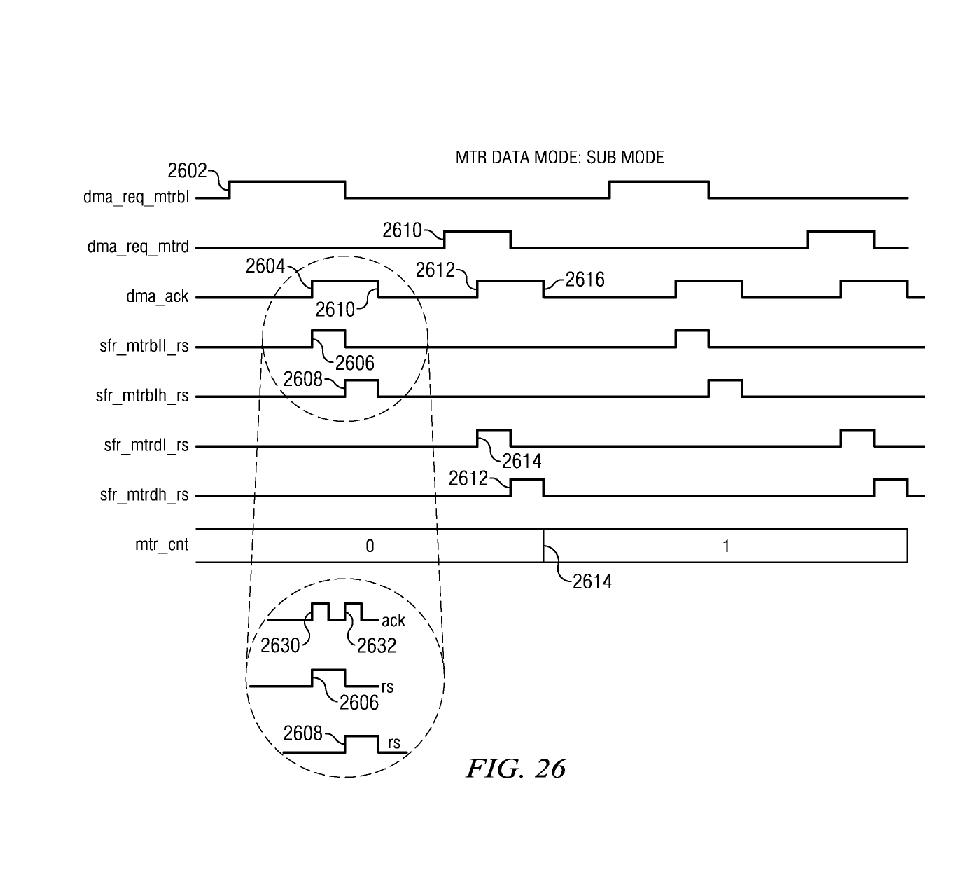

Referring now to FIG. 26, there is illustrated a timing diagram for the MTR data mode, the SUB mode. In this mode, it is necessary to read the baseline data, perform the comparison and determine by how much the accumulated data value for a particular Rx channel exceeds the difference between the baseline data and the threshold. This is the “strength” of the signal. This then requires a Write operation back to the memory. Thus, there will be a Read and a Write operation. This is initiated by a DMA request for baseline data at an edge 2602. This is followed by a dma_ack signal at an edge 2604, indicating that the DMA has acknowledged that this particular client is requesting retrieval of data from the baseline area. For the MTR sequence, a value of “0” in this example, the counter of the DMA will be set to “0” and this particular start location or address will be utilized to access the particular baseline data. At the same time as the ACK signal is generated, a Read strobe for the baseline low byte is generated at an edge 2606, followed by a Read strobe at an edge 2608 for the baseline high byte. At the end of this data operation, the dma_ack signal is dropped low at an edge 2610. This is then followed, during the same MTR count value by a DMA request for the MTR data at an edge 2610. This is followed by a dma_ack signal at an edge 2612 indicating the acknowledgement of the request. A Read strobe will then be generated directed toward the data SFR for the DL byte, at an edge 2614. The DH byte will then be accessed by a Read strobe at an edge 2612. At the end of this operation, this indicates the end of a particular count cycle. The Rx sequence counter in the MTR will be incremented at an edge 2614, the ACK signal will be dropped low at an edge 2616 to initiate the next operation. This will continue for all counts of the sequence counter. Again, the State Machine in the MTR will initiate everything based upon a data request. All that the DMA has to keep track of is the count or value such that the particular address can be determined. Initially, there will be an ack_done signal which, when generated, indicates that this is the beginning of a particular strobe of all Rx channels for that single strobe such that the counter can be reset in the DMA to the start channel and the initial address of the memory device.

Referring to a detail in FIG. 26 of the Read strobes for a particular Read or Write operation, it can be seen that the two edges 2606 and 2608 for the two Read strobes that are generated are associated each with a separate ACK edge. Therefore, there will be an ACK edge 2630 for the Read strobe edge 2606 for the baseline low Read operation and an ACK edge 2632 for the Read strobe edge 2608 associated with the baseline high data byte. Again, either a single ACK for the two Read strobes or one ACK for each Read strobe can be utilized.

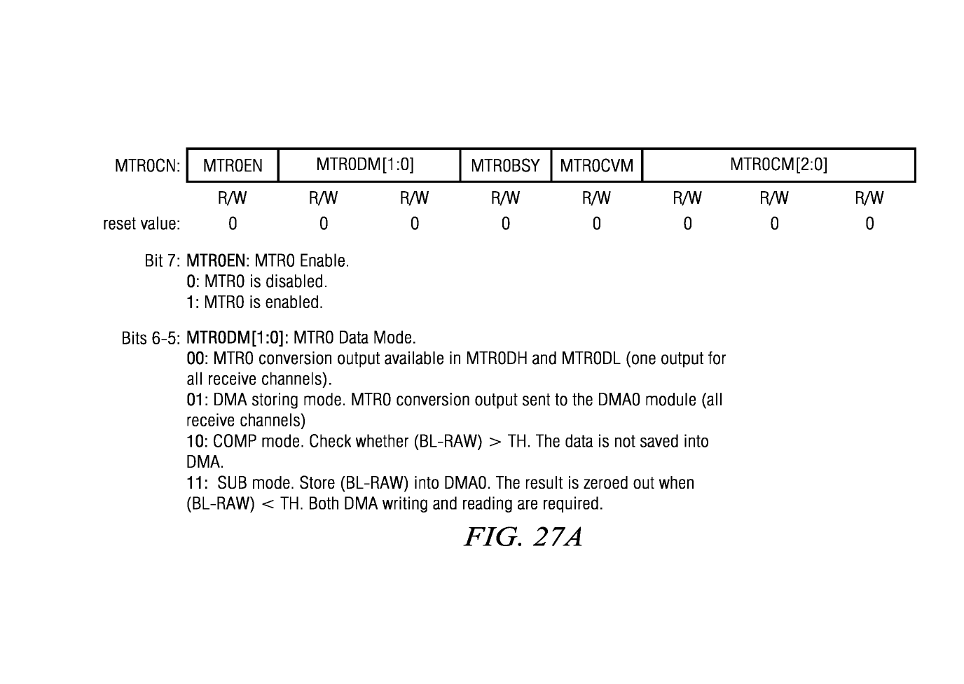

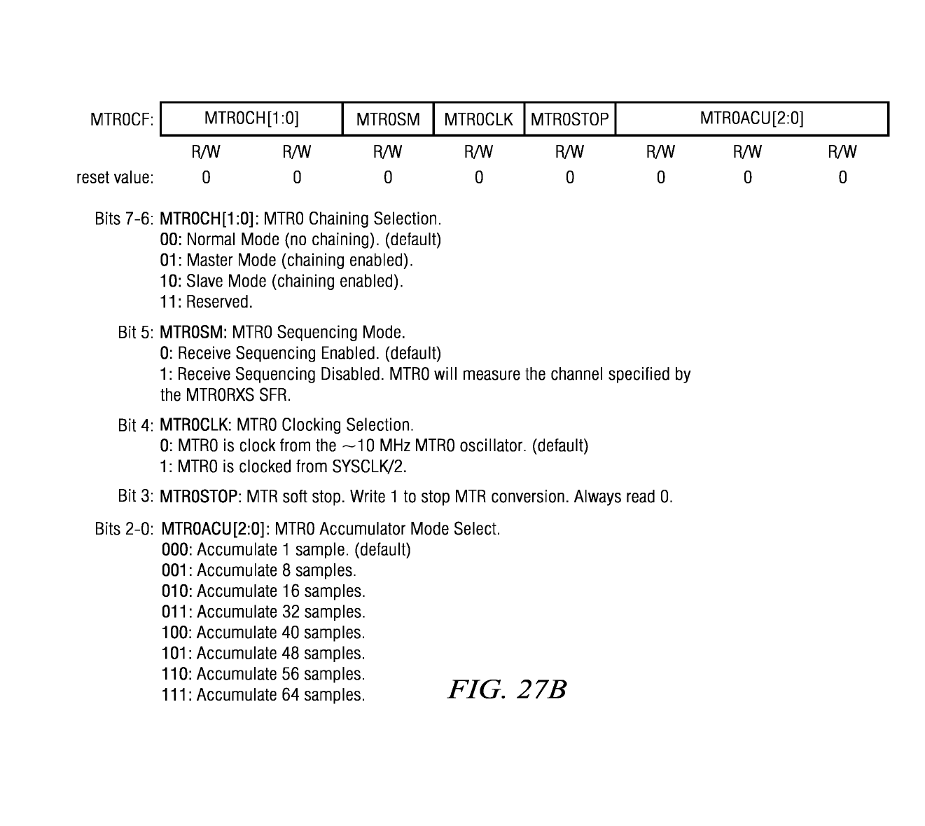

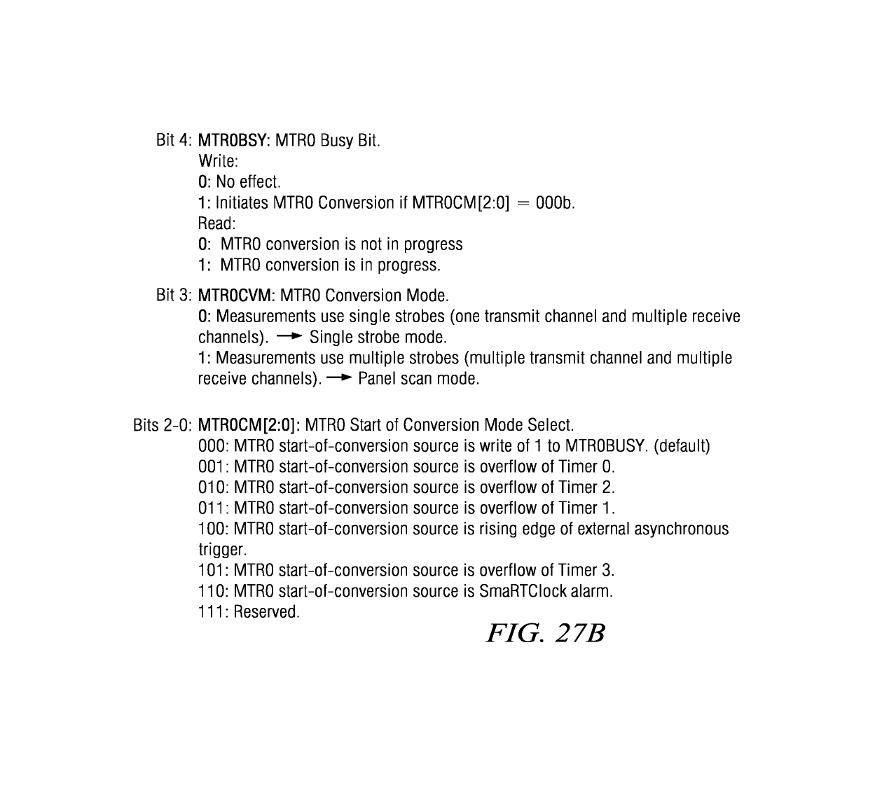

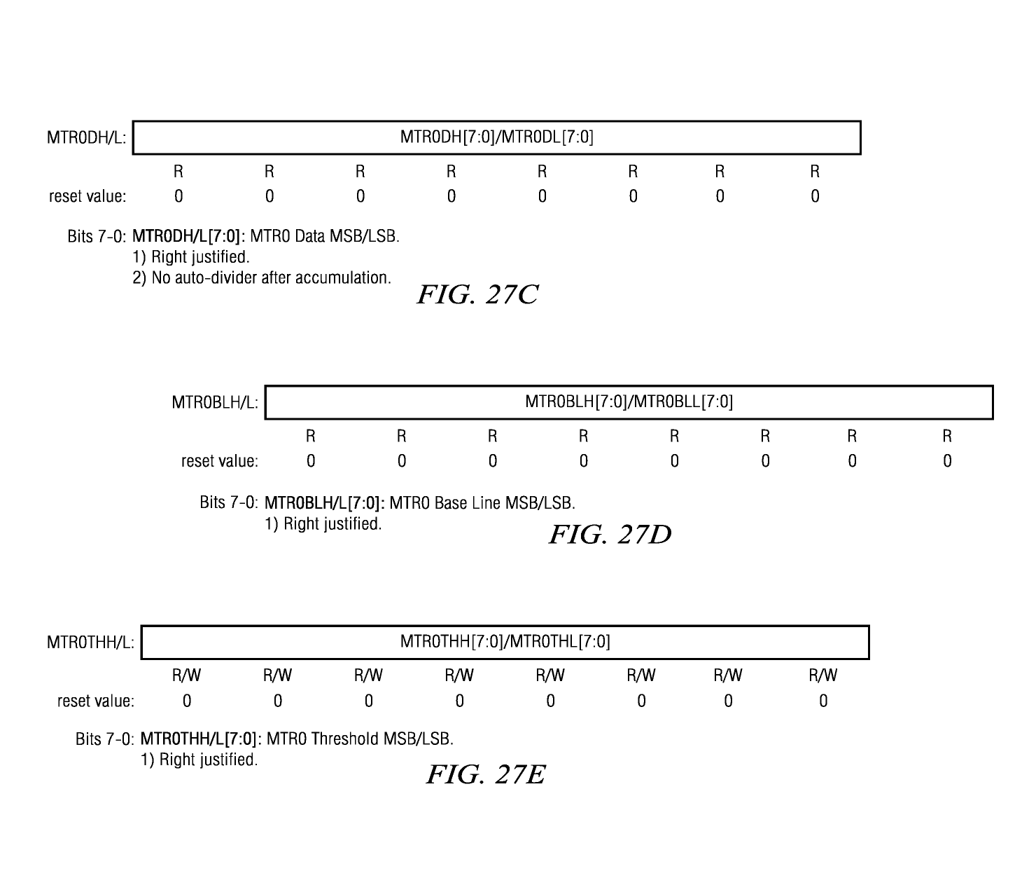

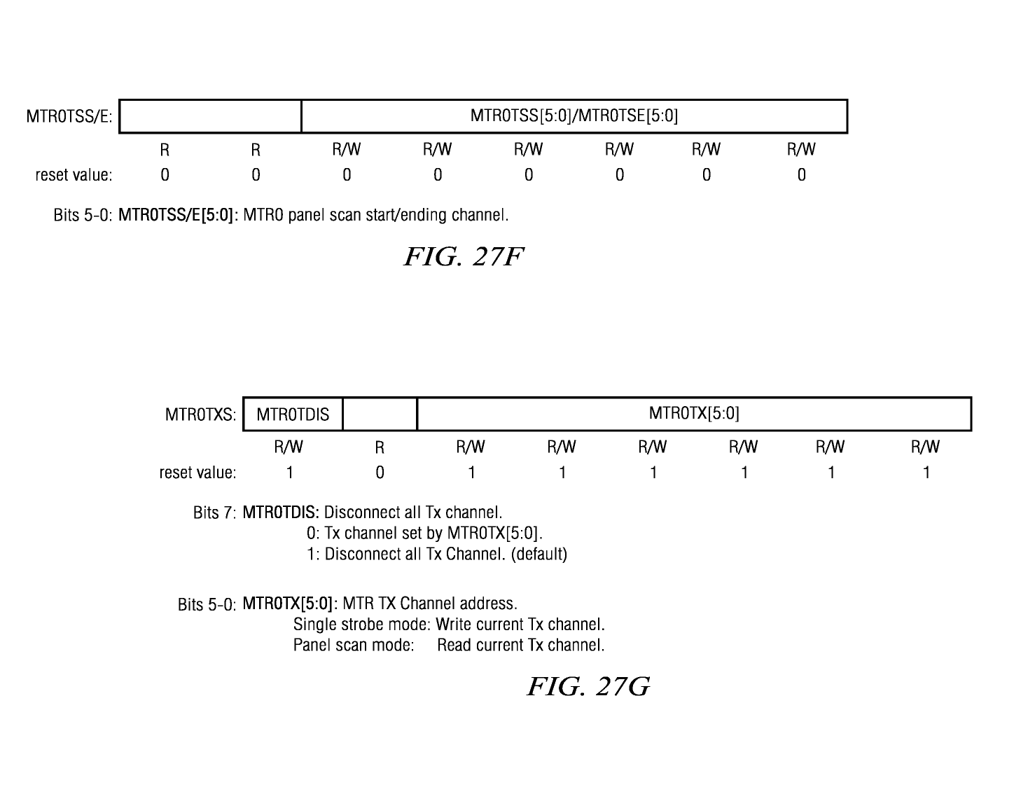

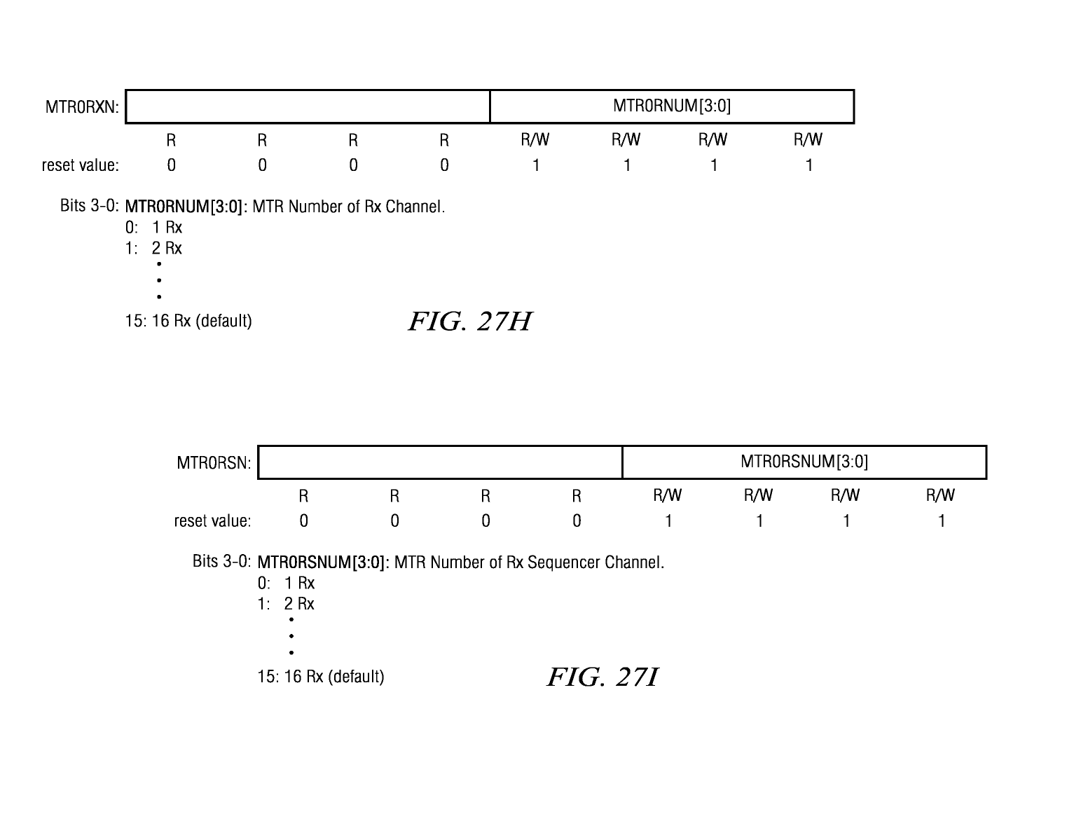

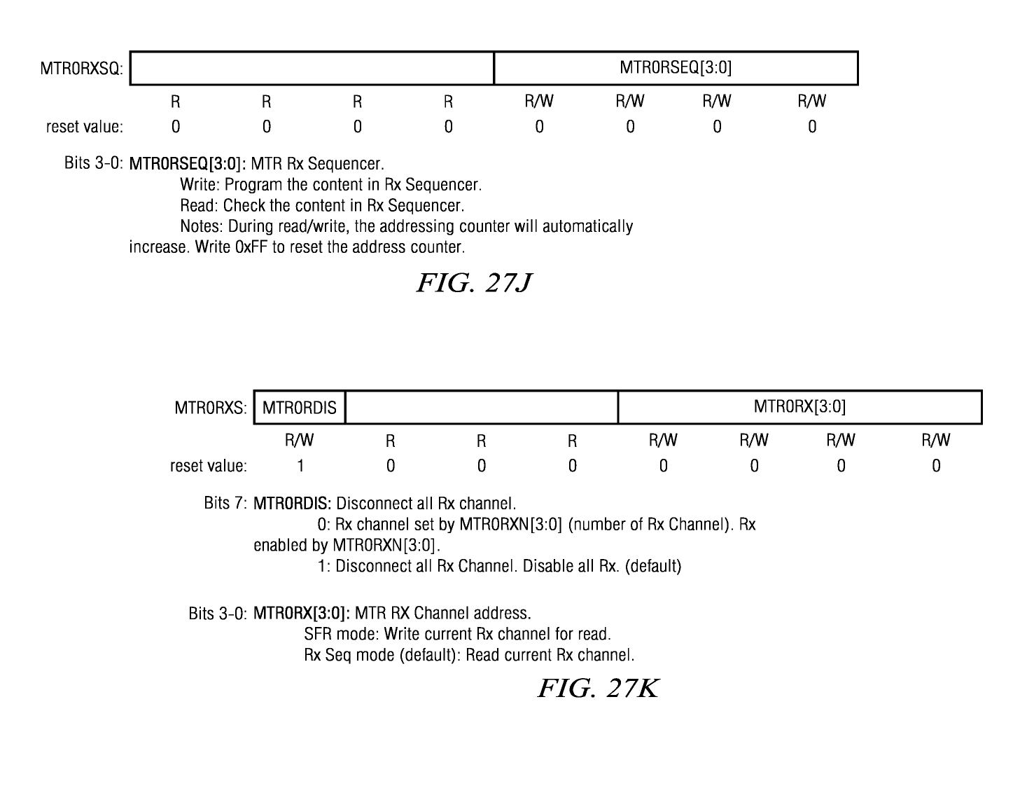

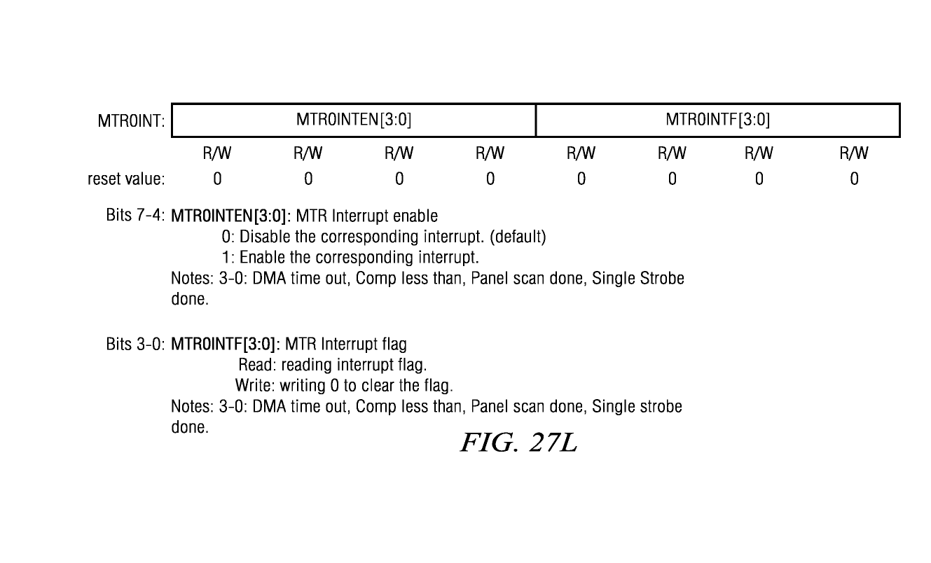

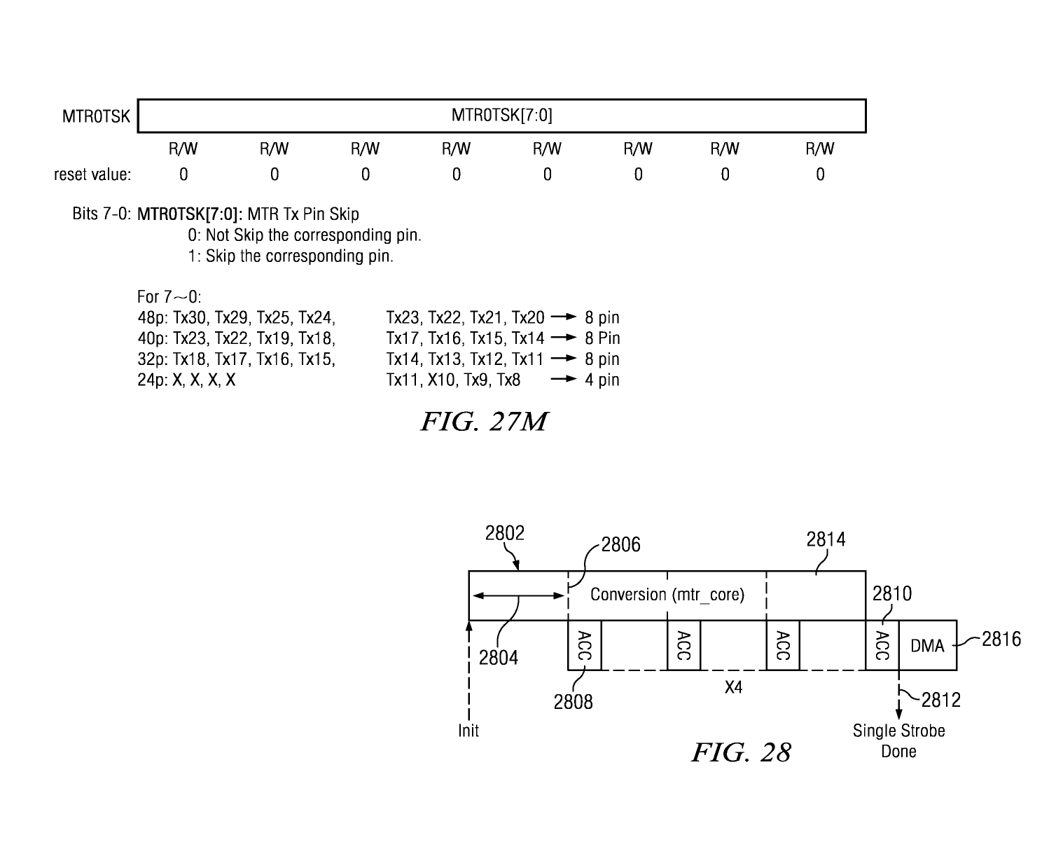

Referring now to FIGS. 27a-27m, there is illustrated a description of the MTR SFR registers. FIG. 27a illustrates a diagram of the MTR0 control register, MTR0CN. This is an 8-bit register for storing control values. The function of each of the bits in MTR0CN is as follows. Bit 7 is the MTR0EN bit which is the MTR0 enable. When it is set to “0,” the MTR is disabled and, when set to “1,” it is enabled. Bits 5 and 6 define the MTR0 data mode. There are four modes, the first mode (006) for indicating that the MTR0 conversion output is available in the MTR0DH and MTR0DL registers (one output for all receive channels) that is accessible by the CPU. In the second mode (016), the DMA storing mode, the MTR0 conversion output is sent to the DMA module as described herein above. In the third mode (106), the compare mode, the MTR module is operable to check whether the difference between the baseline value and the accumulated data output is greater than the threshold. This data is not saved into the DMA. Thus, this compare mode will only result in a Read operation of the baseline data. In the fourth mode (116), the SUB mode, the actual value of the difference between the baseline data and the raw data is stored in memory via the DMA as the strength value. When the results of BL-RAW are less than the threshold voltage, then the results are zeroed out such that the strength is “0.” Again, both DMA writing and DMA reading are required. Bit 4 is the MTR0 busy bit. When the CPU writes a bit to this location, a “0” results in noting happening and a “1” initiates the MTR0 conversion if the MTR0CM, start of conversion mode, bits are set to “000b.” The CPU is also able to read this location and, if, a “0” is read, this indicates that the conversion is not in process and if it is a “1,” then a conversion is in progress. Bit 3, MTR0CVM, is the MTR0 conversion mode. A “0” indicates that measurements utilize a single strobe conversion mode and a “1” indicates that multiple strobes are required, i.e., the panel scan mode. Bits 2-0 are associated with the MTR0CM operation, the start of conversion mode selected. There are seven modes of operation. The start of conversion can be initiated with a Write of “1” to the MTR0VSY location. This is the default operation. The start of conversion source can be any of the overflow timers “0,” “2” or “1.” The start of conversion could be the result of a rising edge of an external asynchronous trigger. The start of conversion source could be the overflow of the third timer and the start of conversion source could be as a result of the real-time clock (RTC) alarm.

Referring now to FIG. 27b, there is illustrated a diagram of the MTR0CF SFR, for defining the configuration information for the MTR0. The bit definition is set forth in the figure. Bits 7-6 are associated with the chaining selection, this being the MTR0CH function. There are three different modes, the normal mode with no chaining—the default condition, the master mode with chaining enabled and the slave mode with chaining enabled. These will be described herein below in more detail. Bit 5, MTR0SM, is associated with the MTR zero sequencing mode. A “0” indicates that receive sequencing is enabled and a “1” indicates that it is disabled. In this mode, the MTR0 will measure the channel specified by the MTR0RXS SFR. Bit 4 indicates the MTR0 clock selection, which is either clocked from the internal MTR0 oscillator, the default condition, which is not synchronized with the SYSCLK. The idea of the operation is to clock this off the SYSCLK divided by a factor of “2.” Bit 3 is associated with the MTR soft operation, MTR0STOP. A “1” written to this bit will stop the MTR conversion. Bits 2-0 are associated with the MTR accumulator mode operation, MTR0ACU. This is associated with X1, X8, X16, X32, X40, X48, X56 AND X64.

Utilizing the configuration register, the CPU can set up the MTR operation to define the master/slave operation, the sequencing, the clocking and the operation of the accumulator.

FIG. 27c illustrates the registers for the high and low bytes for the MTR data that is to be transferred to memory. These are the MTR0DH and MTR0DL registers. They are each one byte wide.

FIG. 27d illustrates a diagram for the baseline data registers, the MTR0BLH and MTR0BLL registers. Again, these are one byte wide. This is for reading data from the DMA.

Referring now to FIG. 27e, there is illustrated a diagram for the MTR threshold register. These are the MTR0THH and MTR0THL registers. These define the threshold value for the compare and SUB modes. They are one byte wide.

Referring now to FIG. 27f, there is illustrated a diagram of the MTR0TSS and MTR0TSE registers. These define the MTR scan start and end values. As noted herein above, the Tx counter will count from an initial value to an end value. This only requires a 6-bit value. These are the start and ending Tx channels. It is important to note that, internal to the chip, the channels are defined in sequence, depending upon the number of pins that are selectable. If, for example, there were defined sixteen Tx channels, then the scan start value could be anywhere from zero through fourteen and the end value could be any value after the start value.

Referring now to FIG. 27g, there is illustrated a diagram of the MTR0TXS register, this being the MTR Tx channel address. This controls the operation of the Tx operation. Bit 7, MTR0TDIS, is operable to determine whether the Tx channels are activated. A “0” will set the channel by the address in the lower 6 bits. A “1” will disconnect all of the Tx channels, this being the default value. If a “0” value is set in bit 7, bits 0-5 will set the MTR Tx channel address. In the single strobe mode, this will be indicated as writing the current Tx channel to this location and, in the panel scan mode, this will be indicated by a Read operation on the current Tx channel. The current Tx channel, of course, is defined by the Tx counter.

Referring now to FIG. 27h, there is illustrated a diagram of the MTR0RXN register, defining the number of Rx channels. This is a four bit wide register that defines whether all channels are active. For example, it might be that sixteen channels are available, since there are sixteen ADCs associated with the operation that all operate in parallel. If, for example, there were only four columns, then only four Rx channels would be required. This will be defined by the value stored in MTR0RXN. The default is sixteen Rx channels. However, initially, all of the Rx channels will be disabled at power up, as a result of the default value for the MTR Rx channel address SFR, MTR0RXS, having the disconnect bits set to “1” by default. When this bit is set to “0” and the MTR0RXN bit is set to “5,” then the receive channels, Rx0-Rx5 are enabled automatically.

Referring now to FIG. 27i, there is illustrated a diagrammatic view of the MTR0RSN register defining the number of Rx sequencer channels. This is a four bit value which defines anywhere from one Rx channel being the number of sequencer channels or sixteen Rx channels as being the number of Rx sequencer channels. This basically defines the length of the Rx sequencer.

Referring now to FIG. 27j, there is illustrated a diagrammatic view of the MTR0RXSQ register, this being the Rx sequencer SFR. This is a four bit value which can have the content of the Rx sequencer written thereto. A four bit value is written into this register and then this loaded into the sequence followed by a second value. If the length of the Rx sequencer were sixteen, then sixteen values could be sequentially written into the sequencer. Again, this is utilized when the sequence is not in any specific order. A Read operation at any time can determine the content of the Rx sequencer. During a Read or Write operation, the addressing counter will automatically increase. By writing a 0XFF to this value, the address counter will be reset. Each Read thereafter will increment through the sequencer. During the Write operation, the opposite will occur.

Referring now to FIG. 27k, there is illustrated a diagrammatic view of the MTR0RXS register, this defining the MTR Rx channel address. Bit 7 defines whether the Rx channels are connected on power up or disconnected. A “0” indicates a specific Rx channel. Bits 0-3 indicate the channel address which, in the SFR mode, requires the current Rx channel to be written thereto for reading and, in the mode associated with the Rx sequencer operation (default) this allows the current Rx channel to be Read. As the Rx sequencer steps though its operation in accordance with the Rx counter, the value will be reflected in the MTR0RXS register at bits 0-3.

Referring now to FIG. 27l, there is illustrated a diagrammatic view of the MTR interrupt register, MTR0INT. It is an 8-bit register wherein bits 4-7 are associated with the MTR interrupt enable operation, MTR0INTEN. The DMA time out, COMP less than, panel scan done flag and single strobe done flags are enabled when they are set to a “0” or a “1.” Similarly, bits 0-3 are associated with the four strobes wherein a “0” clears a flag on a Write operation and a Read of the value in that corresponding bit will determine whether the MTR interrupt flag exists.

Referring now to FIG. 27m, there is illustrated a diagrammatic view of the MTR Tx pin skip operation or register, MTR0TSK. The pin skip operation is an operation wherein any one of the defined pins associated with a Tx channel can be skipped. This is a mapping operation. Consider that there are 32 pins defined as being available for a Tx channel. Internally, these will be set with Tx channels Tx0-Tx31. These would be sequenced through in the particular sequence from Tx0 through Tx31 if all are connected. However, it may that one of these pins is designated for a different function. The sequencer, however, does not recognize this as it merely steps through the sequence of Tx channels. Therefore, there is a decoder provided for skipping this pin such that, for example, if the pin associated physically with the Tx4 channel were designated for a different function on the chip, i.e., a UART function, then the channels available would be Tx0, Tx1, Tx3, Tx5, . . . . This would require the sequencer to associate the channel sequence as being such with the fifth channel being associated with pin output Tx5 rather than Tx4. The decoder operates such that, depending upon the number of pins associated with the particular chip, only certain ones can be skipped, i.e., only those certain ones that can be associated with a different function. These are defined in FIG. 27m.

Referring now to FIGS. 28 and 29 there are illustrated diagrammatic views of the single strobe operation and the panel scanning operation. FIG. 28 illustrates that the single strobe operation is initiated at a point 2802 in response to an initiating signal from the MCU. This results in a conversion operation 2804. Each conversion operation will result in the collection of sixteen charge transfer values which will be converted to a digital value and stored in the latch on the output of the ADC 342. Immediately after this result, the information is stored in the MTR registers 1702 and then the ADC 342 is controlled to begin another conversion operation. At the end of each conversion operation, at a point 2806, the accumulation operation is performed, as represented by a block 2808. This is the operation depicted in FIG. 17. This accumulation operation continues until the last accumulation operation, indicated by block 2810 which results in a “single strobe done” flag 2812 being set. Since the counter for the accumulation operation will define when the last conversion operation will be done, the conversion operation will be terminated at a point 2814. Thereafter, depending upon the selected mode, the DMA may need to be accessed. If so, this access is performed at a block 2816. For example, in the compare mode, it may be required that, after the single strobe done flag is set, a compare operation is to be performed with respect to the baseline value. Thus, the sequence in FIG. 28 illustrates the entire operation for a single strobe, after which the MCU will be pulled out of the idle mode to start the next operation.

With respect to FIG. 29, the panel scanning mode is initiated at a point 2902 by an initiating command from the MCU (or other source as described herein below). This will start a first conversion operation 2904. This will continue in a predetermined sequence for the defined number of counts of the Rx ACC counter. The count value will end at a point 2906. However, in the panel scanning mode, the next conversion for the next row will be selected, i.e., the next strobe. Therefore, the last accumulation operation for a given row will be represented by a block 2908 that will occur after the last conversion operation at the point 2906. The next row will be selected and the first conversion operation for that row will be initiated, represented by block 2910. During the conversion operation 2910, the accumulation operation for the last conversion operation in the previous row will be under way, after which the “single strobe done” flag is set. The time between the end of the accumulation operation and the beginning of the next accumulation operation, i.e., the end of the conversion operation, must be sufficient for the DMA to be accessed for whatever operation is required. If it were just a Read or Write operation, this would take less time but, if it were a Read and Write operation, this could take more time. As such, there will be provided a timeout flag that can be set in the event that the DMA/SFR operation can not complete data logging at the end of a conversion operation.

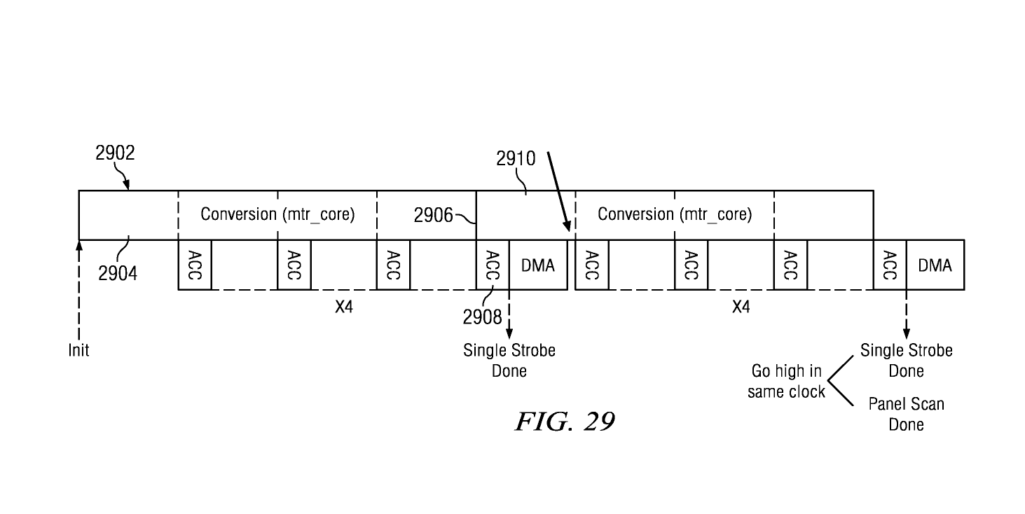

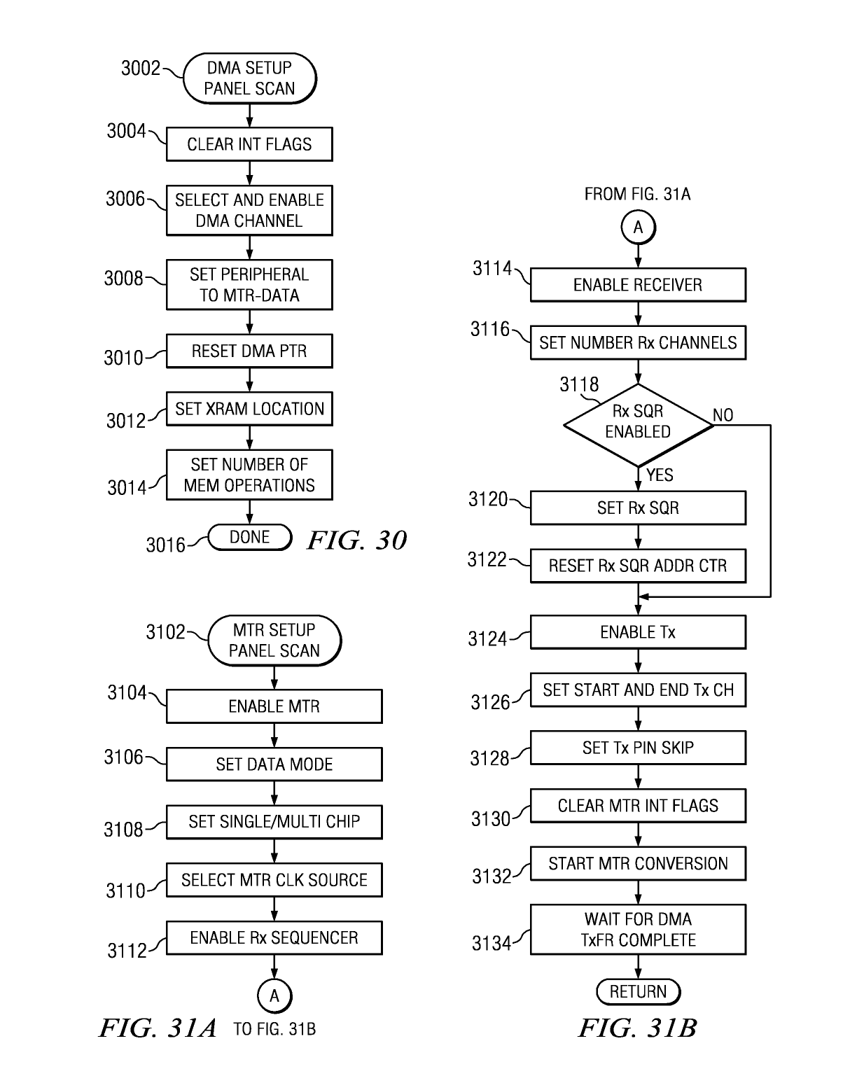

Referring now to FIG. 30, there is illustrated a flow chart for the setup operation for a panel scan. Initially, when going into the panel scan mode, it is necessary to set up the DMA. This is initiated at a block 3002 then it proceeds to a block 3004 to clear all interrupt flags. The DMA channel is then selected and enabled, as indicated by a block 3006 and then the peripheral is set to MTR data, as indicated by a function block 3008. This is due to the fact that a data request has been received for transfer of MTR data. The program then flows to a function block 3010 to reset the DMA pointer and then to a function block 3012 to set the XRAM location. This is the initial XRAM location to which data will be written. As described herein above, after the initial XRAM location is set, the pointer will increment to the next location. The program then flows to a function block 3014 to set the number of memory operations. This is a function of how many receive channels exist for a particular single strobe. The program then flows to a Done block 3016.

Referring now to FIGS. 31a and 31b, the set up sequence for the MTR will be described for the panel scan operation. This is initiated at a block 3102 and then proceeds to a function block 3104 to enable the MTR by writing the correct bit. The program then flows to a function block 3106 to set the data mode, i.e., the data transfer mode to the DMA, it being a DMA transfer mode, a COMP mode or a SUB mode. The program then flows to a function block 3108 to set the single/multi-chip mode as to whether it is in the single-chip mode or the multi-chip mode and whether it is a master or slave in the multi-chip mode. The program then flows to a function block 3110 to select the MTR clock source, it being the MTR clock or the divided SYSCLK. The program then flows to function block 3112 to enable the Rx sequencer. The program then flows to the function block of FIG. 31b.

In FIG. 31b, the program flows to a function block 3114 to enable the receiver and then to a function block 3116 to set the number of receive channels for a given strobe. Again, this could be all of the available channels (it being noted that not all ADCs will be utilized for the entire panel when the number of ADCs exceeds the number of column lines). The number of receive channels could be less than all that are available on the panel, depending upon the setup. The program then flows to a decision block 3118 to determine if the receive sequencer is enabled. If it is enabled, then the Rx sequencer value is written into MTR0RXSQ which basically writes the particular channel content into the receive sequencer. This is indicated by a function block 3120. The sequencer address counter is then reset after the last Rx channel, as indicated by function block 3122. The program then flows to a function block 3124 in order to enable the transmitter (MTR0TXS). If the sequencer was not enabled, the program will flow directly from decision block 3118 to function block 3124. After the transmitter is enabled, the program flows to function block 3126 to set the start and end Tx channels, MTR0TSS and MTR0TSE. The program then flows to function block 3128 to set the Tx pin skip value in MTR0TSK and then to a function block 3130 to reset or clear the MTR interrupt flags in MTR0INT. The program then flows to function block 3132 in order to start the MTR conversion, setting the correct bit MTR0CN for the origination. The program then flows to a function block 3134 to wait for the DMA transfer to be complete, this being a DMA interrupt from a DMAINT register.

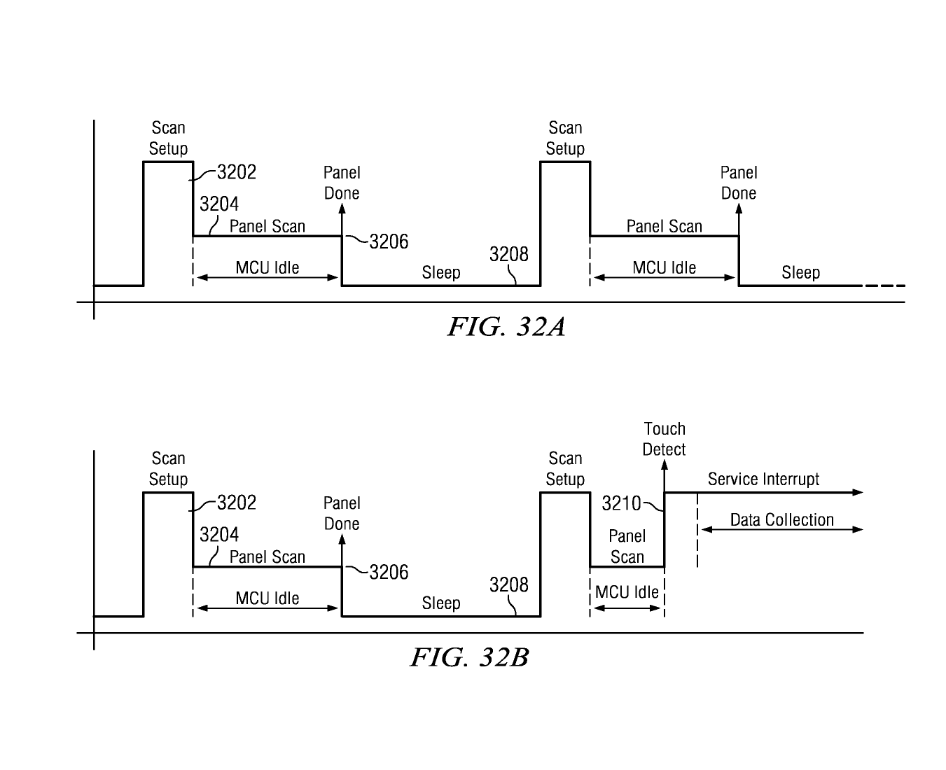

Referring now to FIGS. 32a and 32b, there are illustrated two diagrams illustrating power consumption during the various scan and set up operations. In the diagram of FIG. 32a, there is illustrated a typical operation wherein the mode is set for panel scanning. The system is initiated wherein the MCU will go into active mode at a point 3202 to do a scan set up wherein information is written to the MTR and DMA SFRs. In this mode, the system is fully active. After the scan set up, an initiation signal is sent and the MCU goes into the idle mode for a panel scan, indicated by region 3204. As such, just the necessary analog peripherals will be in the full power mode and the digital circuitry will be placed into an idle mode wherein the operation of the 8051 processing core 302 will be halted, the clocks will be halted, etc. When the panel scan done flag is set, at a point 3206, this indicates that the scan has been completed and the system will then be placed into the sleep mode wherein such things as the I2C block 358 and the RTC clock 386 will operate. The RTC clock will have various timers and the such associated therewith and under the control thereof that will allow the MCU to be woken up and pulled out of sleep mode. This is the lowest power mode wherein the digital portion of the MCU is powered down as well as the MTR module 114. At a point 3208, the MCU is again woken up to set up the scan for the next panel scan and so on. This will continue until some event occurs such as a touch detect. In FIG. 32b, this is illustrated at the second scan (relative to FIG. 32a) wherein a touch detect is determined at a point 3210 prior to a panel scan being complete. At this point, the MCU will change from idle mode to fully active mode to service that interrupt and, for the touch detect operation, the next step would be to possibly go into a data collection mode, at which time the MCU would be maintained in the active mode to process data as it is being collected. At the end of each single strobe done, the MCU would evaluate data stored in the memory during data collection.

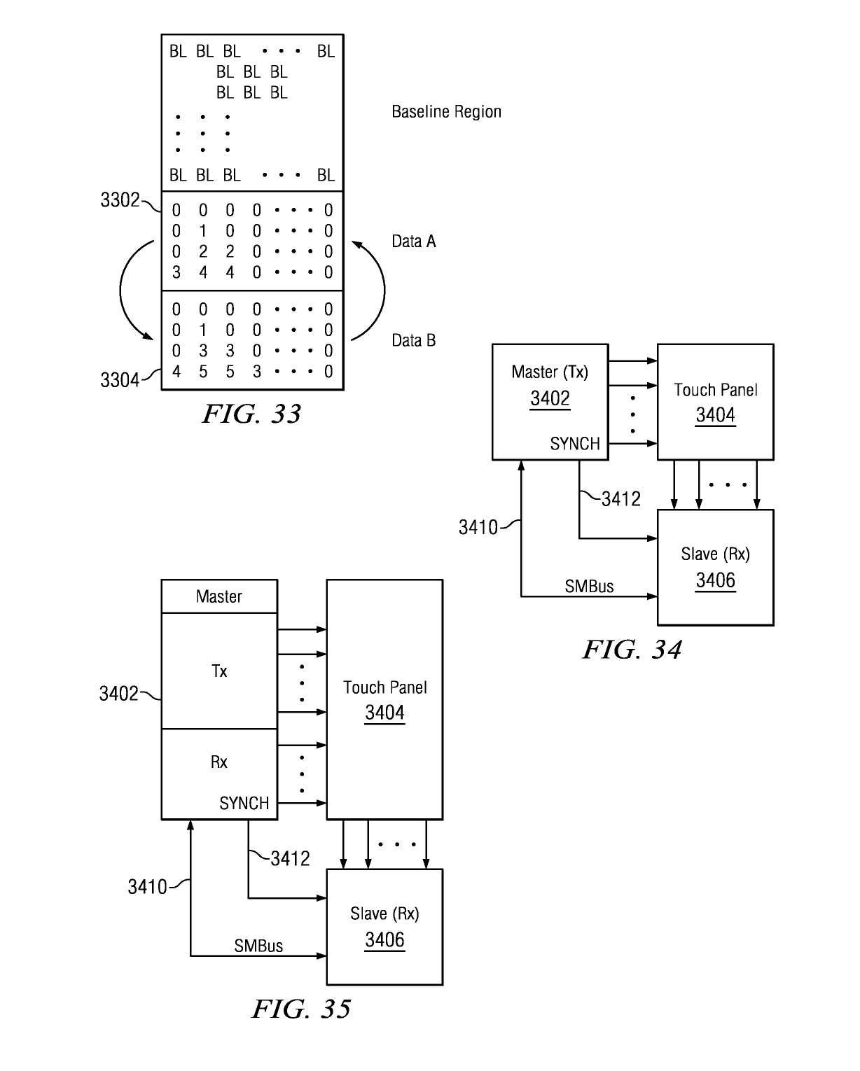

Referring now to FIG. 33, there is illustrated a diagrammatic view of the memory. The memory has a first region which is defined for storing baseline data. This data is stored in the calibration operation. It is utilized for the compare (COMP) and subtract (SUB) modes of operation. Each C_{RCF} will have a baseline value associated therewith. This calibration, as noted herein above, can be redone based upon a user initiated operation, a predetermined event occurring and for temperature changes. The data portion is stored in a second region 3302 which is the region of the memory in which data is stored for processing by the CPU 302. However, it is possible to provide a second region of memory 3304 that can be utilized for storing of data therein as data in the other region is being processed by the CPU 302. This is basically a ping pong memory wherein the DMA can be writing data to the second region of memory 3304 while CPU 302 is processing data in region 3302. This is a mapping function by the DMA and is defined by the initial setup of the DMA wherein a start address in memory is defined for any data transfer operation.

The data stored can either be raw data which is stored therein in the DMA SFR mode or the strength value stored therein in the subtract (SUB) mode. In the subtract mode, this will be stored as a “0” if the difference between the baseline and raw values is above the threshold voltage, i.e., in the no-touch region, and the strength value if the difference between the baseline and raw values is below the threshold. It should be noted that the MCU can control the MTR module 114 to evaluate only certain areas of the array. Since any given row transfer will cause all charge to be transferred from all of the C_{RCF} capacitors to the associated ADCs 342, the savings will be in restricting rows or Tx channels that are activated and the charge transferred therefrom, but processing time will be saved in evaluating less than all Rx channels. With respect to columns, the power savings will be in controlling the MTR module 114 to only write data from a restricted set of columns, this being under the control of the sequencer 1714.

Referring now to FIG. 34, there is illustrated a first embodiment for the multi-chip operation. In the multi-chip operation, it is recognized that a particular chip may not have a sufficient number of pins in order to facilitate all receive operations or all transmit operations. In this mode, a single chip or master IC 3402, which is substantially the integrated circuit 102, can perform the master function. It is set as the master in the multi-chip operation. When in the master mode, the chip can be configured with N Tx channels and M Rx channels, N>0 (only one active at one time) and M>0. The master IC 3402 will interface with a touch panel 3404 to drive the rows with transmit pulses (m=0 for MTR0RxS[7]=1). Note that, although all Rx are disabled, it is necessary in order to drive the Tx counter and generate the “panel scan cony done” flag that the SAR done signal be generated following the falling edge of the SYNC OUT. A slave IC 3406, which is substantially identical to the master IC 3402 (it being understood that these could actually be differently configured integrated circuits) performs the receive function and it is operable to be connected to the columns. When in the slave mode, there will be 0 Tx and M Rx, M>0 with Tx disabled and all Tx channels disconnected. The SAR conversion will follow the falling edge of SYNC_IN. During operation, there will be a global scan operation wherein a transmit pulse will be generated on a particular row and a SYNC pulse output to the slave IC 3406 such that slave IC 3406 has its in conversion operation synchronized to the master operation, i.e., when the output driving any one row goes low, the slave is synchronized as such in order to perform the conversion operation. The SYNC pulse is output on a dedicated one of the pins which is configured for this functionality whereas the slave IC 3406 has one of its pins dedicated to an input SYNC receive function. Thus, the master IC 3402 will synchronize the operation. This is similar to the internal operation of the integrated circuit when the MTR core generates a signal indicating to the State Machine that the MTR operation has been triggered by the voltage on the output going from a high voltage to a low voltage. Thereafter, the slave IC 3406 will receive all of the data, process it and output the data in the appropriate data transfer mode for storage therein. At the end of a particular single strobe scan or panel scan, all the information will be stored in the slave IC 3406. Thereafter, processing can be effected on this data at either the slave IC 3406 or even at the master IC 3402. Data interfaced therebetween is effected via a single wire bus, the SMBus. This is illustrated as a bus line 3410. The SYNC output is delivered from the master IC 3402 to the slave IC 3406 on a line 3412. In the slave mode, writing a “1” to MTR0BSY is still required. The MTR0BSY flag will be read as “1” after writing MTR0BSY. The slave is then ready to receive SYNC_IN which will then enable the MTR, set up the set up the MTR SFR and the DMA SFR, write a “1” to MTR0BSY (slave ready to go) and wait for sar_done following SYNC_IN.

In a second embodiment illustrated in FIG. 35, the touch panel 3404 in interfaced with the master IC 3402 with the exception that the master IC 3402 interfaces with Tx channels and some Rx channels (m≠0). On the master IC 3402, the Rx portion is enabled for substantially all of the channels associated therewith or even a portion of the available sixteen receive channels. The remainder of the channels will be handled by the slave IC 3406. The slave IC 3406 may have less than the total of the available columns associated therewith. All that is necessary is to have a global scan counter that can keep track of the global count value. If, for example, there were twenty columns requiring twenty receive channels, it could be that sixteen of the columns were associated with the receiver on the master IC 3402 and the remaining four handled by the slave IC 3406. The accumulator for each of the receivers would operate in accordance with its own internal operation to accumulate the data and make it ready for the DMA transfer mode. The global scan counter would then control both receive sequencers such that the global scan counter would have a length greater than the depth of the receive sequencer. This would result in the receive sequencer on the master IC 3402 completing its operation prior to the receive sequencer operating within the slave IC 3406. However, alternatively, both the master IC 3402 and the slave IC 3406 could independently collect the data, as all of the data is available on a particular strobe at the same time. It is just necessary to determine when the data acquisition operation has been completed.

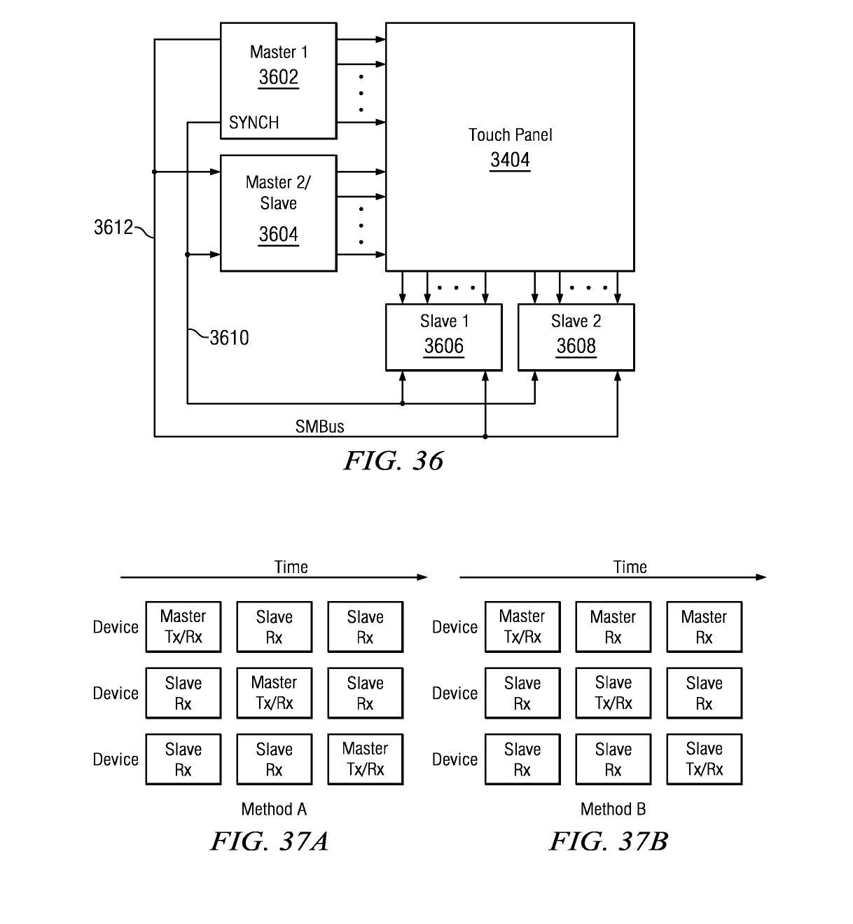

In FIG. 36, there are provided two ICs 3602 and 3604 that share the drive or transmit channel function for those of the touch panel 3404. In this operation, the first IC 3602 would be determined to be the master and would generate the SYNC pulse. The second master would operate as the slave for the time that the first master IC 3602 is sequencing through the transmit channels. At the last channel, the functionality will be changed over such that the slave IC 3604 will become the master or generate the SYNC signal. However, the SYNC could always be generated by the master IC 3602 but it should be understood that the slave IC 3604 could take over the operation and become the master. Each of two slaves is illustrated, slave ICs 3606 and 3608. Each of these is operable to receive a portion of the column lines and process them accordingly. Each of the ICs 3602 is connected to a SYNC line 3610 and an SMBus line 3612. The SYNC pulse is utilized to maintain synchronization for the global scan operation, whereas the SMBus line is utilized to communicate information between the various ICs. This is utilized to switch functionality from one master to the other such that the second can become the master and also to transfer data back and forth or information about the collected data. As such, all of the chips can operate in unison to sequentially scan the rows of the touch panel with a Tx drive signal to strobe each row. The slaves that perform the receive function which are not common to the master functionality or transmit functionality require a SYNC signal in order to synchronize the accumulation and data transfer functionality.

Referring now to FIGS. 37a and 37b, there is illustrated a diagrammatic view of three chips, device A, device B and device C, operating in either a master or a slave mode. When a chip is set up to operate in duplicate as the master (MTR0TSS and MTR0TSE), the slave chip can also generate the “panel scan cony” flag, with the Tx address counter running. However, the counter will not be used to enable/disable the Tx channel. This requires MTR0TXS[7]=“1” and MTR0CF[7.6]=2,610. No “panel scan low done” flag will be generated and MTR0BSY will not be cleared during panel scan mode. With MTR0TXS[7]=0, there will be a “panel scan cony done” flag and MTR0BSY will be cleared after panel scan done.

In method A, illustrated in FIG. 37a, the transmit function is always on the master mode chip. In time, the first sequence is that device A is set as the master, device B set as the slave and device C set as a slave. Both device B and device C constitute receivers. After scanning the Tx channels with device A set as master, the device B is set as the master mode. This, of course, requires some hand shaking via the SMBus. The next step is to switch to a configuration wherein the device C will be then set to the master function to scan Tx channels. This, therefore, requires two configuration changes.

In method B, the global scan operation is illustrated. In this function, the transmit function can exist on a slave chip. Only a certain chip can be defined as the “master mode” chip and this is the one that generates the SYNC function. Each chip maintains a global counter, i.e., it knows when to start its Tx scanning automatically. On the slave, the Tx is always on to avoid turning on in time. Thus, the master will always be device A which, will initially be set as the master transmitter and receiver with device B and device C being set as the slave receivers. The next step, the device B will be set as the slave Tx and receiver with the master Rx being device A which generates the SYNC and device C is still a slave. Then it is reconfigured such that the third chip is a slave Tx/Rx with device A still being the master receiver and generating the sync.

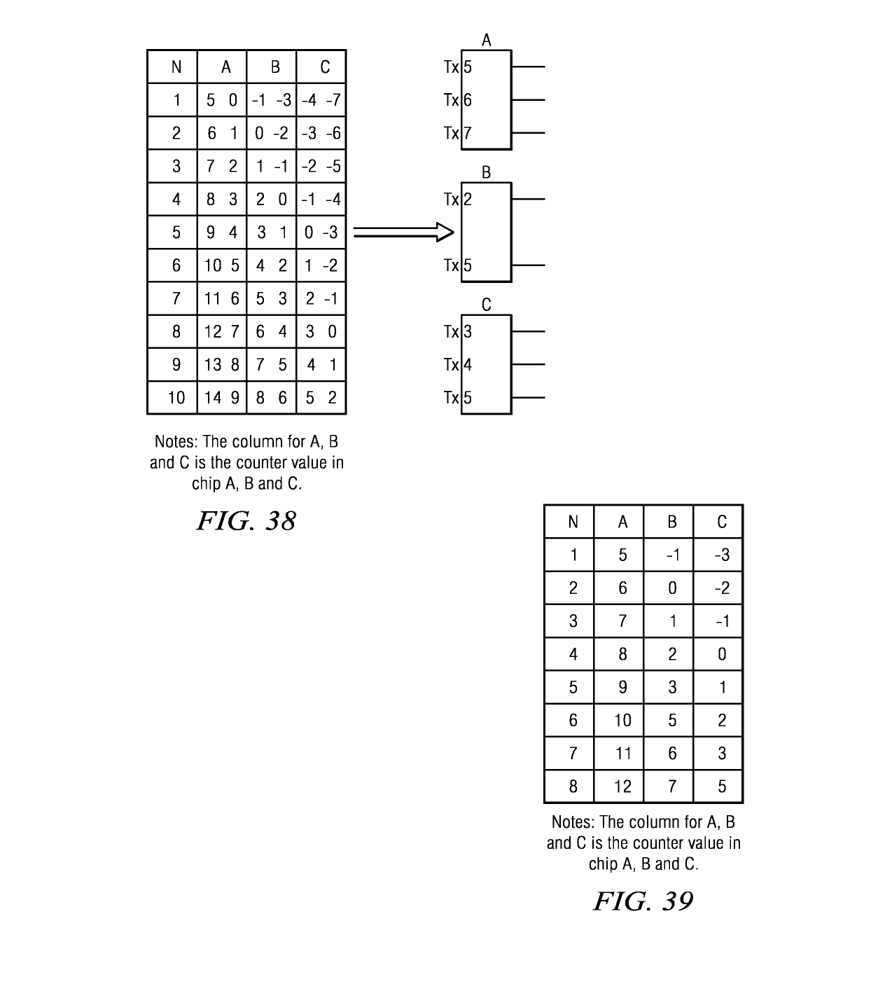

Referring now to FIG. 38, there is illustrated a first situation where global scan is utilized. With the three chips, A, B and C, chip A is set to scan channels Tx5, Tx6 and Tx7. Chip B is set to scan Tx2, Tx3, Tx4 and Tx5 and chip C is set to scan Tx3, Tx4 and Tx5. These transmit channels are on the chips themselves. There are provided N columns which are divided among three chips, there being ten total row lines to be driven. It can be seen that Tx5, Tx6 and Tx7 are associated with the first three rows on chip A, Tx2, Tx3 and Tx5 associated with the next four rows on-chip B and Tx3, Tx4 and Tx5 of chip C associated with the rows 8-10 for the panel. Thus, there are a total of 10 Tx channels. The mtr_tx_cnt value can be a negative value. The SFRs in each of the chips will contain the MTR0TSS and MTR0TSC start and end channels and there will also be an MTR0GSS and an MTR0GSE setting and an MTR0GS SFR for the MTR0 global scan operation. Thus, for chip B, the MTR0GSS register will be set to a −1 value. This is the starting global scan count value. The start transmit channel will be set to a value of “2” such that the output pin Tx2, that channel for that chip, will be driven at that global scan value which will take four global scan counts to get there. The end count will be set to “5” in MTRTSE. Thus, it will only scan 4 channels from Tx2 through Tx5. The global scan end value will be set to “8,” i.e., it will count a full ten global scan counts from −1 through count value 8. Thus, by defining a global scan count value for a particular strobe set to the number of transmit channels, the transmit counter can be incremented on a global basis. All that is required is that a particular chip know when to generate the transmit value in the overall scheme. Again, any of the receivers that are connected will receive and process information in accordance with the SYNC signal. The global counter, of course, is synchronized with the SYNC signal received from the master mode chip.

In a second embodiment illustrated in FIG. 39, there is illustrated a second case with the three chips, A, B and C. Here there are N total counts of eight from one through eight. Chip A is set to scan Tx5, Tx6 and Tx7, chip B is set to scan Tx2, Tx3 and Tx5 (Tx4 is skipped) and chip C is set to scan Tx3 and Tx5 with Tx4 skipped. There are a total of eight transmit channels. Again, the negative value will be implemented in the global scan count value. The global scan count value for chip A will initially be set at 5 whereas chip B will be set to a value of −1 and chip C will be set to a value of −3. This is the MTR0GSS start count. The MTR0TSS value for chip A will be set to 5 and the MTR0TSS value for chip C will be set to 2. Since, on-chip B, Tx4 was skipped, the actual Tx channel output on a count value will be sequenced through 1, 2, 3 and then 5.

It will be appreciated by those skilled in the art having the benefit of this disclosure that this touch screen scanning architecture provides a lower power operation by utilizing hardware scan controllers in combination with an MCU engine. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. An integrated control circuit, comprising:
a central processing unit operating in a normal full system power mode and in a reduced system low power mode;
a memory;
a plurality of peripheral units, at least one of which having:
an input/output for interfacing with at least an external system for receiving information therefrom; and
a process block for processing the received information from the external system and wherein, during the processing of the received information, processed data is stored in the at least one peripheral unit in a storage register when data is to be transferred to the memory or retrieved from the storage register when data to be processed is stored in the memory;
wherein the input/output and process block are fully operable in the full system power mode and the reduced system power mode;
a direct memory access (DMA) for transferring data directly between the at least one peripheral and the memory when such data transfer is required by the peripheral, the DMA operating in a full power DMA mode when data transfer is required and a low power DMA mode when data transfer is not required; and
wherein the central processing unit is operable, in the normal full system power mode, to interface with the memory and with the at least one peripheral unit and the storage register to access data stored by the at least one peripheral unit.

2. The integrated control circuit of claim 1, wherein the central processing unit is operable to configure the operation of the at least one peripheral unit.

3. The integrated circuit of claim 1, further comprising a system clock operating in a system clock domain for generating system clock signals, the central processing unit operating in the system clock domain and wherein the at least one peripheral unit includes an internal clock operating in a peripheral clock domain and wherein the process block operates in the peripheral clock domain and wherein the DMA operates in the system clock domain when in full power DMA mode, and wherein data transfer occurs in the system clock domain, the at least one peripheral unit having a peripheral clock domain to system clock domain interface to interface data transfer therebetween.

4. The integrated circuit of claim 1, wherein at least one of the plurality of peripheral units is operable to interface with an internal system.

5. The integrated circuit of claim 1, wherein the process block within the at least one peripheral unit comprises a state machine.

6. The integrated circuit of claim 1, wherein the at least one peripheral unit and the process block therein is operable to control the external system through the input/output.

7. The integrated circuit of claim 1, wherein the central processing unit in the normal full system power mode is operable to execute instructions and, in the reduced system power mode, is operable to not process instructions.

8. A scanning system for a touch panel, comprising:
an instruction based processor operating in at least a low power mode and a high power mode;
a memory;
a direct memory access (DMA) device, to allow direct interface to the memory from one of a plurality of peripheral devices or from the processor to the memory;
a panel scanning state machine comprising one of the peripheral devices, including:
a scan controller for initiating a scan of internal capacitors in the touch panels,
a capacitance determination device to determine a value corresponding to the value of each of the scanned ones of the internal capacitors,
a data collection device for collecting the determined values as collected data, and
an interface for interfacing collected data with either the DMA or the processor; and
a power controller for controlling the power mode of the processor such that the processor can operate in the low power mode when scanning the display, with at least the scan controller, capacitance determination device and data collection device in the panel scanning state machine and the DMA operating.

9. The scanning system of claim 8, wherein each of the internal capacitors in the touch panel comprise the mutual capacitance at the intersection of intersecting lines in the touch panel, which intersecting lines are rows and columns of the touch panel.

10. The scanning system of claim 9, wherein the scan controller is operable to sequentially select one of the rows or columns and the capacitance determination device is operable to determine a value of the mutual capacitance associated with the intersection of one of the columns or rows of the touch panel and the one of the rows or columns and is operable to sequence through each of the rows or columns.

11. The scanning system of claim 10, wherein the capacitance determination device is operable to determine the value of the mutual capacitance associated with the intersections of a plurality of the columns or rows of the touch panel and the selected one of the rows or columns.

12. The scanning system of claim 11, wherein the scan controller is operable to drive the selected one of the rows or columns with a voltage that can be varied.

13. The scanning system of claim 8, wherein the DMA operates in a low power DMA mode and a high power DMA mode and wherein the panel scanning state machine can operate when the DMA is in the low power DMA mode.

14. The scanning system of claim 13, wherein the interface of the panel scanning state machine is operable to control the power mode of the DMA to change the power mode from the low power DMA mode to the high power DMA mode when data is to be transferred therebetween by the panel scanning state machine.

15. The scanning system of claim 14, wherein the panel scanning state machine includes a processing block for processing the determined values in accordance with one of a plurality of functional modes associated therewith.

16. The scanning system of claim 15, wherein one of the functional modes operable on the panel scanning state machine comprises a baseline scanning mode wherein the scan controller and the processing block operate to collect baseline data corresponding to the values of the internal capacitors when no activity exists with respect to the touch panel and store such values in the memory through the DMA as baseline values.

17. The scanning system of claim 16, wherein one of the functional modes operable on the panel scanning state machine comprises a touch panel mode wherein the scan controller and the processing block operate to compare each value of the baseline data to the current value of a scanned one of the internal capacitors to determine if a change exists above a predetermined level and, if so, the processing block terminating further scanning operations by the scan controller and causing the power controller to change the power mode of the processor to the high power mode.

18. The scanning system of claim 15, wherein the processor is operable to configure the processing block in one of the functional modes

19. The scanning system of claim 18, wherein the operation of the scan controller is initiated by the processor to execute the configured one of the functional modes and, upon the completion of such execution, the processing block causing the power controller to change the power mode of the processor to the high power mode and the processor receiving an indication from the processing block of the completion of the execution of the configured one of the functional modes.

20. The scanning system of claim 8, and further comprising a clock generator for generation a system clock in a system clock domain and the generation of a plurality of derived system clocks derived from the system clock and wherein the processor operate from the derived system clocks in the system clock domain and wherein the panel scanning state machine includes a scan clock operating in a scan clock domain independent of the system clock domain and the interface operates in both the scan clock domain and the system clock domain such that data transferred to the DMA or to the processor occurs in the system clock domain.

21. The scanning system of claim 20, wherein the system clock has a high power clock mode and a low power clock mode such that, when none of the derived system clocks are being utilized, the system clock mode is the low power clock mode and wherein each of the derived clocks are selectively generated when the system clock is in the high power clock mode.

22. The scanning system of claim 21, wherein the DMA operates in a high power DMA mode and a low power DMA mode wherein, data transfer between either the panel scanning state machine or the processor and the memory occurs in the high power mode in the system clock domain and, if the DMA is in the low power DMA mode, the DMA switches to the high power mode in response to a request for data transfer from either the panel scanning state machine or the processor such that the DMA causes the system clock to switch to the high power clock mode if in the low power clock mode and select one of an associated derived system clock to provide a DMA clock to the DMA for the operation thereof, wherein the DMA switches back to the low power mode at the completion of the data transfer.

23. A multi touch scanning system for determining the presence of a touch at specific areas of a touch panel, comprising:
a processor operating in a high power CPU mode and a low power CPU mode;
a system clock operating in the system clock domain;
a memory;
a plurality of peripheral units for interfacing with external systems, one of which is a multi touch resolve (MTR) peripheral for interfacing with the touch panel;
the MTR peripheral including:
a data collection device to collect data relating to specific areas of the touch panel,
a process block to process the collected data in accordance with a plurality of predetermined tasks, only one of which is operating at a given time,
wherein the process block is configured by the processor to execute one of the plurality of tasks, and the operation of the process block and the data collection device is initiated by the processor when in the high power mode and at the end of processing the configured task, the processor causes the processor to operate in the high power mode, and
a memory interface for transfer of data between the MTR peripheral and the memory in accordance with the task being executed.

24. The multi touch scanning system of claim 23, wherein the memory interface comprises a direct memory access device (DMA) for allowing the MTR peripheral to directly access the memory while the processor is in the low power CPU mode.

25. The multi touch scanning system of claim 23, wherein the system clock operates in a high power clock mode and a low power clock mode and the MTR peripheral includes an independent MTR clock that operates in the low power clock mode such that both the processor and the system clock can operate in their respective low power CPU and clock modes.

26. The multi touch scanning system of claim 25, wherein one of the tasks comprises a touch detect wherein a determination by the MTR peripheral can be made as to the presence of a touch on a specific area of the touch panel independent of both the processor and the system clock operating in their respective low power CPU and clock modes.
